SEQUENCE LISTING (12 sequences)

SEQ ID NO: 1 - RNA, 22 nt, synthetic construct
  source 1..22: mol_type = other RNA
tgaggtagtaggttgtatagtt

SEQ ID NO: 2 - RNA, 22 nt, synthetic construct
  source 1..22: mol_type = other RNA
tagcttatcagactgatgttga

SEQ ID NO: 3 - RNA, 23 nt, synthetic construct
  source 1..23: mol_type = other RNA
gtccagttttcccaggaatccct

SEQ ID NO: 4 - RNA, 23 nt, synthetic construct
  source 1..23: mol_type = other RNA
taccctgtagaaccgaatttgtg

SEQ ID NO: 5 - DNA, 22 bp, synthetic construct
  source 1..22: mol_type = other DNA
  misc_feature 1: note = Attachment site of AF594 (Alexa Fluor 594 fluorescent dye)
aactatacaacctactacctca

SEQ ID NO: 6 - DNA, 27 bp, synthetic construct
  source 1..27: mol_type = other DNA
  misc_feature 1: note = Attachment site of AF594 (Alexa Fluor 594 fluorescent dye)
tcaacatcagtctgataagctacagta

SEQ ID NO: 7 - DNA, 33 bp, synthetic construct
  source 1..33: mol_type = other DNA
  misc_feature 1: note = Attachment site of AF594 (Alexa Fluor 594 fluorescent dye)
agggattcctgggaaaactggacactgactgca

SEQ ID NO: 8 - DNA, 38 bp, synthetic construct
  source 1..38: mol_type = other DNA
  misc_feature 1: note = Attachment site of AF594 (Alexa Fluor 594 fluorescent dye)
cacaaattcggttctacagggtaatgatcgcttgtcta

SEQ ID NO: 9 - RNA, 22 nt, synthetic construct
  source 1..22: mol_type = other RNA
tgaggtagtaggttgtgtggtt

SEQ ID NO: 10 - RNA, 22 nt, synthetic construct
  source 1..22: mol_type = other RNA
tgaggtaggaggttgtatagtt

SEQ ID NO: 11 - DNA, 27 bp, synthetic construct
  source 1..27: mol_type = other DNA
  misc_feature 1: note = Attachment site of AF594 (Alexa Fluor 594 fluorescent dye)
aaccacacaacctactacctcacagtt

SEQ ID NO: 12 - DNA, 37 bp, synthetic construct
  source 1..37: mol_type = other DNA
  misc_feature 1: note = Attachment site of AF594 (Alexa Fluor 594 fluorescent dye)
aactatacaacctcctacctcacagttctccagttca

(19) United States
(12) Patent Application Publication
(10) Pub. No.: US 2023/0314370 A1
(43) Pub. Date: Oct. 5, 2023

(54) INLINE ENRICHMENT AND SEPARATION OF BIOMOLECULES IN MICROFLUIDIC DEVICES

(71) Applicant: Wayne State University, Detroit, MI (US)

(72) Inventors: Thomas H. Linz, Livonia, MI (US); Mario A. Cornejo, Detroit, MI (US)

(73) Assignee: Wayne State University, Detroit, MI (US)

(21) Appl. No.: 18/165,890

(22) Filed: Feb. 7, 2023

Related U.S. Application Data
(60) Provisional application No. 63/307,618, filed on Feb. 7, 2022.
(60) Provisional application No. 63/348,376, filed on Jun. 2, 2022.

(51) Int. Cl. G01N 27/447

(52) U.S. Cl. CPC G01N 27/44756

(57) ABSTRACT

Described herein are systems using injectionless gel electrophoresis (GE), such as thermal GE (TGE), to selectively separate, concentrate, quantify, and/or otherwise analyze target analytes. Inline preconcentration and separation are demonstrated to resolve analytes, exemplified by resolving double-stranded miRNA-probe hybrids from excess single-stranded probes and analyzing multiple conformations of a protein. Microfluidic devices having a tapered channel are described, which improve detection sensitivity and separation resolution. The described separation strategy and microfluidic device designs establish injectionless gel electrophoresis as a simple, low-cost analysis method, for instance for analyzing clinical and pharmaceutical samples, including for miRNA, protein, and other biomolecular analyses.

### STATEMENT REGARDING FEDERALLY SPONSORED RESEARCH OR DEVELOPMENT

This invention was made with government support under contract R21GM137278 awarded by the National Institutes of Health, and under contract 2046487 awarded by the National Science Foundation. The government has certain rights in the invention.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD OF THE DISCLOSURE

The present disclosure relates generally to methods and devices for separating molecules, such as biomolecules, based at least in part by interaction with an electric field.

### BACKGROUND OF THE DISCLOSURE

MicroRNAs (miRNAs) are short (18-23 nucleotides) non-coding sequences of RNA that regulate gene expression (Iwakawa & Tomari, Trends Cell Biol., 25:651-665, 2015; Fromm et al., Annu. Rev. Genet., 49(1):213-242, 2015). The hybridization of a miRNA to a segment of messenger RNA prevents the coded protein from being translated, consequently impacting cellular behavior. Precise regulation of miRNAs is required for an organism to maintain proper physiological function, as aberrant expression can cause pathogenesis. Numerous miRNAs have recently emerged as biomarkers for diagnosing pathologies including cancers (Cheng, Adv. Drug Deliver. Rev., 81:75-93, 2015; Ban, J. Chromatogr. A, 1315:195-199, 2013), cardiovascular diseases (Zhu & Fan, Am. J. Cardiovasc. Dis., 1:138-149, 2011; Creemers et al., Circ. Res., 110(3):483-495, 2012), and neurodegenerative disorders (Femminella et al., Front. Physiol., 6, 2015; Sheinerman & Umansky, Front. Cell. Neurosci., 7:150-150, 2013; Du & Pertsemlidis, J. Mol. Cell Biol., 3:176-180, 2011). Development of diagnostic panels to quantify miRNA markers from clinical samples could serve to diagnose diseases at early stages when treatment is more effective and long-term patient prognoses are higher. Additionally, miRNAs have shown promise as therapeutics to treat numerous pathologies (Rupaimoole & Slack, Nat. Rev. Drug Discov., 16(3):203-222, 2017; Hanna et al., Front. Genet., 10(478), 2019). Accurate measurements of miRNAs in pharmaceutical formulations and pharmacokinetics studies are needed to support pharmaceutical development. The high clinical and pharmaceutical potential of miRNAs demonstrates the need for a low-cost analysis capable of detecting multiple low-abundance species, which presents a formidable analytical challenge.

Common techniques to measure miRNAs include next-generation sequencing and reverse transcription quantitative PCR (RT-qPCR) (Balcells et al., BMC Biotechnol., 11(1):70, 2011; Chen et al., BMC Genomics, 10(1):407, 2009). Although these techniques provide high-sensitivity analyses, they suffer from high cost and potential amplification biases (Wang et al., TrAC—Trend. Anal. Chem., 117:242-262, 2019). Direct analyses of miRNAs in inexpensive platforms are needed for routine analyses. Electrochemical sensors have been developed that meet these criteria (Masud et al., Trends Biochem. Sci., 44(5):433-452, 2019; Liu et al., Sensor. Actuat. B-Chem., 208:137-142, 2015), but these methods are typically limited to measuring a single miRNA. To maximize diagnostic accuracy, however, multiple biomarkers must be measured in parallel from a single sample.

Separation techniques are ideal for selectively analyzing multiple species within complex samples. Microchip electrophoresis (MCE) is particularly well-suited as it affords rapid analyte quantitation in miniaturized, low-cost microfluidic devices (Wei etal., Talanta, 189: 437-441, 2018; Yamamura et al., Sensors, 12(6):7576-7586, 2012). However, electrophoresis cannot resolve miRNAs because of the similar size and charge between species. This problem can be overcome, though, by integrating variable “drag tags” into fluorescent detection probes that associate with target miRNAs. Previous studies using capillary electrophoresis incorporated drag tags composed of proteins, peptide nucleic acids, or polymers onto probes to alter analyte mobilities to different degrees and enable their separation (Meagher et al., Anal. Chem., 80(8):2842-2848, 2008; Wegman et al., Anal. Chem., 87(2):1404-1410, 2015; Hu etal., Anal. Chem., 90(24):14610-14615, 2018; Wegman et al., Anal. Chem., 85(13):6518-6523, 2013). The cost and analytical complexity of previous reports are relatively high. Adapting these sensitive miRNA analyses into a less costly, more user-friendly approach would benefit the numerous applications that require amplification-free multiplexed miRNA quantitation.

There remains a need in the art for better systems, methods, and devices for separation of analytes from mixed samples. This need is broader than just in the separation of miRNAs or other analytes of similar (or nearly identical) size.

### SUMMARY OF THE DISCLOSURE

Described herein are methods that preconcentrate biomolecules (analytes) and then spontaneously separate them without user intervention. Analytes are loaded throughout a single microfluidic channel. No sample injection is needed to begin the analysis, unlike standard analytical methods.

Also described is a microfluidic device design that improves both the detection limits and separation resolution of the analysis.

Another embodiment provides use of an innovative asymmetric electric field that helps better confine analytes into low-volume bands.

The methods and devices described herein can be used for automated analysis of biomolecules (such as nucleic acids, polypeptides, carbohydrates, and so forth), exemplified herein with miRNA and proteins. Applications for the herein described methods and devices include separating, detecting, and/or measuring biomarkers (more generally, analytes) for clinical diagnostics and performing quality control analyses of pharmaceutical formulations, and for biological researchers to validate reagent integrity and screen for contamination or degradation.

Described method embodiments provide automatic inline preconcentration and separation of a mixture of two or more analytes, rather than requiring sequential steps. The optional use of an asymmetric electric field better confines analytes to reduce volume and increase concentration.

Provided herein is a method of injectionless gel electrophoresis, exemplified by gel electrophoresis, involving: loading a mixed analyte sample (that is, a sample that contains two or more different analyte species, or two or more isoforms of the same analyte) mixed with a gel solution (or another composition that is capable of holding the mixed analyte preparation in place during operation of the concentration and separation) into a channel of a microfluidic device, the channel having a first end and a second end, the microfluidic device having a first reservoir coupled to the first end of the channel and a second reservoir coupled to the second end of the channel; providing electrolyte solution in the first reservoir and the second reservoir; and applying an electric field (which may optionally be an asymmetric electric field) across the microfluidic device. In some embodiments, the microfluidic device further includes a first electrode arranged in the first reservoir and a second electrode arranged in the second reservoir. As an example, the direction of the electric field is from the second reservoir to the first reservoir. In some embodiments, the electric field may be an asymmetric electric field. In some embodiments, the electric field may be a symmetric electric field.

Another embodiment is a microfluidic device, including a channel, a first reservoir, a second reservoir, a first electrode, and a second electrode. The channel is configured to accommodate a mixed analyte sample (that is, a sample that contains two or more different analytes) mixed with a gel solution. The channel has a first end and a second end. The first reservoir is coupled to the first end of the channel. The first reservoir (also referred to as a cathodic reservoir) is configured to accommodate a trailing electrolyte (TE) solution. The second reservoir (also referred to as an anodic reservoir) is coupled to the second end of the channel. The second reservoir is configured to accommodate a leading electrolyte (LE) solution. The first electrode is arranged in the first reservoir. The second electrode is arranged in the second reservoir. The first electrode and the second electrode, in some embodiments, are configured to apply an asymmetric electric field across the microfluidic device. Alternatively, the first electrode and the second electrode are configured to apply a symmetric electric field across the microfluidic device. As an example, the direction of the electric field is from the second reservoir to the first reservoir.

Yet another embodiment is a computer-readable medium storing computer-readable instructions executable by one or more processors, that when executed by the one or more processors, causes the one or more processors to perform acts involving: loading a mixed analyte sample mixed with a gel solution into a channel of a microfluidic device, the channel having a first end and a second end, the microfluidic device having a first reservoir coupled to the first end of the channel and a second reservoir coupled to the second end of the channel; providing a TE solution in the first reservoir; providing a LE solution in the second reservoir; and applying an electric field across the microfluidic device. As an example, the direction of the electric field is from the second reservoir to the first reservoir. In some embodiments, the electric field is an asymmetric electric field. In some embodiments, the electric field is a symmetric electric field.

Another embodiment is a method of improving analyte separation with electrophoresis, such as thermal gel electrophoresis (TGE), involving applying an asymmetric electric field using an offset electrode position.

Also encompassed in the present disclosure are methods of inline preconcentration and separation of analytes, substantially as disclosed herein.

Another embodiment is a microfluidic device with a tapered channel geometry, substantially as disclosed herein.

Use of a microfluidic device with a tapered channel geometry to separate analytes from a mixture, substantially as disclosed herein, is also provided.

Yet another embodiment is use of probes having variable ssDNA overhang lengths as integrated drag tags in an electrophoresis analysis system, substantially as disclosed herein.

Also described is use of ssDNA overhangs as integrated drag tags for differentiating nucleic acid targets in a mixed sample.

Another embodiment is a set of two or more probes, each with a different ssDNA overhang length, formulated for use as integrated drag tags in an electrophoresis analysis system, substantially as disclosed herein. By way of example, the probes may differ in length by 5 or fewer nucleotides, for instance, by one, two, three, or four nucleotides.

Also provided is an analyte separation strategy based on TGE, substantially as disclosed herein.

Yet another embodiment is a method for separating two or more miRNA species in a mixed sample, the method including TGE substantially as described herein.

### BRIEF DESCRIPTION OF THE DRAWINGS

Several of the drawings and drawing panels illustrating aspects of the disclosure include a symbol for a negative electrode and a symbol for the ground, to illustrate where voltage is applied in a representative embodiment. This illustrated designation of negative electrode and ground applies for analysis of anionic analytes. It will be understood by one of ordinary skill in the relevant art that the disclosure also provides configurations in which the ground is replaced with a positive electrode. Alternatively, the polarity could be reversed from positive to ground or positive to negative, which would be employed for analysis of cationic analytes. In embodiments, the second electrode is not grounded but instead is held at a potential.

FIG. 1A illustrates a schematic top view of an example microfluidic device with a standard channel according to implementations of the present disclosure.

FIG. 1B illustrates a schematic top view of an example microfluidic device with a tapered channel according to implementations of the present disclosure.

FIG. 1C illustrates various positions of the electrode according to implementations of the present disclosure.

FIG. 1D illustrates a top view of the microfluidic device with electrodes placed at parallel (in line with the channel) positions according to implementations of the present disclosure.

FIG. 1E illustrates a top view of the microfluidic device with electrodes placed at offset positions according to implementations of the present disclosure.

FIG. 1F illustrates a perspective view of the microfluidic device with electrodes placed at parallel (in line with the channel) positions according to implementations of the present disclosure.

FIG. 1G illustrates a perspective view and a corresponding schematic diagram of the electrode placed at a 12 o'clock position according to implementations of the present disclosure.

FIG. 1H illustrates a perspective view and a corresponding schematic diagram of the electrode placed at a 9 o'clock position according to implementations of the present disclosure.

FIG. 1I illustrates a schematic top view of an example microfluidic device 100″ with a serpentine shaped channel according to implementations of the present disclosure. Though illustrated with substantially parallel walls, a serpentine channel can also be used with the herein described tapered channel option.

FIG. 2A, FIG. 2B, and FIG. 2C illustrate flowcharts of an example process of injectionless gel electrophoresis according to implementations of the present disclosure.

FIG. 3A illustrates a schematic of a standard channel microfluidic device according to implementations of the present disclosure, and FIG. 3B. illustrates a schematic of a tapered channel microfluidic device according to implementations of the present disclosure, wherein analytes are loaded throughout the channel and migrate from left to right upon voltage application, and arrows indicate the 25 mm and 40 mm detection points in FIG. 3A and 3B, respectively, used to obtain electropherograms.

FIG. 4A illustrates fluorescence images of TGE analysis of 10:10 nM miRNA:probe as the band(s) reached 13 mm and 25 mm distances along the channel.

FIG. 4B shows electropherograms illustrating the separation of the double-stranded miRNA-probe hybrid (Peak 2) from excess single-stranded probe (Peak 1) (numbered from left to right), wherein probe concentration was held at 10 nM while miRNA concentration was either 1 nM or 10 nM.

FIG. 5A illustrates cartoons depicting double-stranded miRNA-probe hybrids (5-8) and single-stranded probes (1-4), wherein probes contained ssDNA overhangs that varied in length from 0-15 nucleotides.

FIG. 5B illustrates a fluorescence image of a TGE analysis of 5:10 nM miRNA:probe at 25 mm, wherein distinct peaks are observed for the four unbound probes (Peaks 1-4) and the four hybrids (Peaks 5-8). With regard to the illustrated diagram, the peaks are denoted as first peak, second peak, third peak etc., moving from left to right.

FIG. 6. illustrates electropherograms where one miRNA was spiked in excess to identify peaks in the separation, wherein arrows indicate the affected probe and hybrid, respectively, from each spike (images were aligned to Peak 5 to improve clarity). With regard to the illustrated diagram, the peaks are denoted as first peak, second peak, third peak etc., moving from left to right.

FIG. 7 illustrates calibration curves generated to quantify the four target miRNAs in standard channel devices, wherein probe concentrations were held at 10 nM, and electropherograms were collected at 25 mm along the channel and processed to obtain peak areas.

FIG. 8A illustrates fluorescence images of 5 nM miRNAs analyzed in tapered channel devices at 40 mm with parallel electrode placements in the first reservoir.

FIG. 8B illustrates fluorescence images of 5 nM miRNAs analyzed in tapered channel devices at 40 mm with offset electrode placements in the first reservoir.

FIG. 8C illustrates an electropherogram of 3 nM miRNAs analyzed with offset electrode placement.

FIG. 8D illustrates calibration curves for the four target miRNAs.

FIG. 9A illustrates non-focusing tracer analyses with the TE electrode placed parallel to the channel (9 o'clock).

FIG. 9B illustrates non-focusing tracer analyses with the TE electrode placed offset to the channel (12 o'clock).

FIG. 10 illustrates TGE analysis of cell extract (top) and cell extract spiked with miRNA standards (bottom). The inset shows higher magnification of the region indicated in red. Traces were aligned at the first peak to improve clarity.

FIG. 11 illustrates a representative embodiment gel electrophoresis separation system and method according to implementations of the present disclosure.

FIG. 12 illustrates the microfluidic device redesign, incorporating the tapered channel and its use to separate analytes.

FIG. 13 illustrates a comparison between gel electrophoresis (exemplified herein in embodiments by thermal gel electrophoresis; TGE) and bidirectional isotachophoresis (ITP). Electrolytes indicted in black text (and rectangular dotted outlines) are similar between the two illustrated techniques; those indicated in grey text (and oval dotted outlines) are unique to one technique.

FIG. 14 illustrates a diagram showing results of a one-TE analysis (0 mM Tricine) and a two-TE analysis (10 mM Tricine) according to Example 3. Separation resolution increases for the higher mobility species when a second TE is added.

FIG. 15 illustrates a diagram showing results of miRNA (the exemplified analyte) selectivity analysis according to Example 4. For each indicated miRNA, data from the probes for let-7a (SEQ ID NO: 1), let-7b (SEQ ID NO: 9), and let-7e (SEQ ID NO: 10) are provided in that order. Arrows indicate the specific miRNA that was spiked in each sample. . Significant off-target binding was observed at 30° C., but high selectivity for only the target miRNA was observed at 50° C.

FIG. 16 illustrates a diagram showing results of adding increasing concentrations of Ca²⁺ to a protein sample (exemplified by calmodulin) according to Example 5. The protein alters its conformation upon binding Ca²⁺, causing Peak 2 to increase and Peak 3 to decrease. With regard to the illustrated diagram, the peaks are denoted as first peak, second peak, third peak etc., moving from left to right.

### REFERENCE TO SEQUENCE LISTING

The nucleic acid and/or amino acid sequences described herein are shown using standard letter abbreviations, as defined in 37 C.F.R. § 1.822. Only one strand of each nucleic acid sequence is shown, but the complementary strand is understood as included in embodiments where it would be appropriate. A computer readable text file, entitled “W063-0086US_SeqList.xml” created on or about Feb. 7, 2023, with a file size of 16 KB, contains the sequence listing for this application and is hereby incorporated by reference in its entirety.

SEQ ID NOs: 1-12 are the nucleotide sequences of the following reagents:

| | | SEQ ID |
|---|---|---|
| Reagent | Sequence (5′-3′) | NO: |
| let-7a miRNA⁽¹⁾ | UGAGGUAGUAGGUUGUAUAGUU | 1 |
| miR-21 | UAGCUUAUCAGACUGAUGUUGA | 2 |
| miR-145 | GUCCAGUUUUCCCAGGAAUCCCU | 3 |
| miR-10b | UACCCUGUAGAACCGAAUUUGUG | 4 |
| let-7a probe⁽²⁾ | AF594-AACTATACAACCTACTACCTCA | 5 |
| miR-21 probe | AF594-TCAACATCAGTCTGATAAGCTA | 6 |
| | CAGTA | |
| miR-145 probe | AF594-AGGGATTCCTGGGAAAACTGGA | 7 |
| | CACTGACTGCA | |
| miR-10b probe | AF594-CACAAATTCGGTTCTACAGGGT | 8 |
| | AATGATCGCTTGTCTA | |
| let-7b miRNA | UGAGGUAGUAGGUUGUGUGGUU | 9 |
| let-7e miRNA | UGAGGUAGGAGGUUGUAUAGUU | 10 |
| let-7b probe | AF594-AACCACACAACCTACTACCTCA | 11 |
| | CAGTT | |
| let-7e probe | AF594-AACTATACAACCTCCTACCTCA | 12 |
| | CAGTTCTCCAGTTCA | |

⁽¹⁾Each uracil (U) in SEQ ID NOs: 1, 2, 3, 4, 9, and 10 is represented in the formal Sequence Listing as thymine (T), though these sequences are correctly indicated as being an RNAs.
⁽²⁾AF594: Alexa Fluor ® 594 fluorescent dye

### DETAILED DESCRIPTION

Described herein is development of a system employing gel electrophoresis to selectively quantify target miRNAs in a low-complexity analysis. Four miRNAs that have been identified as potential biomarkers of breast cancer were selected for an illustrative proof-of-concept study. Fluorescent DNA probes were designed to hybridize with each target miRNA. Probes possessed variable DNA overhang lengths to serve as integrated, low-cost drag tags. Initial gel electrophoresis studies described herein demonstrated an inline preconcentration and separation that resolved double-stranded miRNA-probe hybrid from excess single-stranded probe. This approach was then translated to a four-plex miRNA analyses. Baseline resolution was achieved between the four miRNA-probe hybrids and four probes due to the differing lengths of overhang DNA on each probe.

Also described is development of an innovative microfluidic device that further improves detection sensitivity and separation resolution. A tapered channel was created to confine analytes into bands that progressively migrated into regions of higher electric fields. This novel device design significantly improved limits of detection and separation resolution compared to a standard microfluidic channel (standard, in that the long sides of the channel are substantially parallel). Cell extracts were analyzed with this tapered channel device to demonstrate proof-of-concept detection of endogenous miRNAs. The novel separation strategy and microfluidic device design reported here establish that gel electrophoresis provides a method, in some instances, a simple, low-cost method, for direct miRNA analyses with potential for future applications analyzing clinical and pharmaceutical samples.

Aspects of the current disclosure are now described in additional detail as follows: (I) Definitions; (II) Overview of Injectionless System for Concentration and/or Separation of Analytes; (III) Device Configurations (including overall structure, channel formats, reservoir placement and formats, electrode placement and format, power supply); (IV) Electrolyte Solutions (including constituents, concentrations, variation based on target analyte, placement in device, additional options); (V) Analytes for Analysis (including type of analytes, heterogeneity of analyte mixture, concentration/volume, labels or markers for types of analytes); (VI) Loading Device (including immobilization composition, mixing sample, buffer inclusion, solidification of sample into channel); (VII) Devices in Operation (power source, buffer maintenance, voltage application, timing, temperature); (VIII) System Readout/Detection (camera/detector, computer system, images); (IX) Automated Operation using a Computer System; (X) Kits; (XI) Exemplary Embodiments; (XII) Examples; and (XIII) Closing Paragraphs. Any headings provided herein do not limit the interpretation of the disclosure and are provided for organizational purposes only.

### (I) Definitions

Definitions and explanations used in the present disclosure are meant and intended to be controlling in any future construction when interpreting the scope of claims to avoid unnecessary vagueness or ambiguousness especially when there are more than one meanings for a certain term in different contexts.

“Analyte” refers generally to a substance (molecule, e.g., biomolecule) that is being (or to be) analyzed using a procedure or test, for instance to be identified and/or measured.

“Biomolecules” refer to molecules naturally present in organisms that are involved in one or more typically biological processes, such as cell division, morphogenesis, or development; as well as biologically active molecules (e.g., pharmaceutical drugs) that can be introduced into an organism or biological system to impact one or more biological process(s), including for the treatment of disease.

“Channel” refers to a contained space in a microfluidic device used to confine samples.

“Configured to” refers to things put together in a particular form or configuration, for instance to accomplish an intended purpose.

“Current runaway” refers to an incident where one process triggers other processes, finally resulting in an uncontrollable increase in current.

“Drag tags” are molecules added to detection probes to change their mobility and/or the mobility of the analyte-probe complex (Wegman et al., Anal. Chem., 87(2):1404-1410, 2015; Hu et al., Anal. Chem., 90(24):14610-14615, 2018; Wegman et al., Anal. Chem., 85(13):6518-6523, 2013; Durney et al., Anal. Chem., 85(14):6617-6625, 2013). In embodiments of the current disclosure, “integrated drag tags” is a phrase that refers to probes possessing variable DNA overhang lengths.

“Electrolyte solution” refers to a liquid or gel that contains ions, strong acids, weak acids, strong bases, and/or weak bases. The ionic compounds in an electrolyte solution are referred to as “electrolytes”. In embodiments of the current disclosure, a “Leading electrolyte solution” contains faster migrating ions (Leading electrolyte(s); LEs) than any in the sample with the same charge; while a “Trailing electrolyte solution” contains slower migrating ions (Trailing electrolyte(s); TEs) than any in the sample with the same charge. In methods and systems described in this disclosure, both cationic LEs and anionic LEs are used. In some examples, LE implies that the LE with the charge as that of the analyte (i.e. anionic). However, in some examples, LEs of both charges are needed. The same electrolytes can be used for analysis of either anionic or cationic analytes; however, the placement in reservoirs is reversed for analysis of cationic analytes compared to anionic analytes.

Also provided are electrolyte solutions that contain two or more different electrolytes, for instance for use in the herein-described zonal analysis embodiments. In such embodiments, two or more different electrolytes (each having a different characteristic electrophoretic mobility) are included in at least the anodic reservoir solution, or the cathodic reservoir solution, or both.

“Electroosmotic flow” (EOF) refers to the motion of liquid induced by an applied potential across a porous material, capillary tube, membrane, microchannel, or any other fluid conduit.

“Gel electrophoresis” refers to a process using gel (optionally, thermally-responsive gel) to conduct electrophoresis.

“Heating” refers to a process or operation for increasing the temperature of an item or an environment to be at, below, or above ambient room temperature.

“Injectionless” refers to an aspect of a process in which a sample is loaded (e.g., into a microfluidic device) without requiring injection of the sample (e.g., into an injection port).

“Microfluidics” refers to the behavior, precise control, and manipulation of fluids that are geometrically constrained to a small scale at which surface forces dominate volumetric forces. It is a multidisciplinary field that involves engineering, physics, chemistry, biochemistry, nanotechnology, and biotechnology.

“Mixed analyte” or “mixture of analytes” refers to a composition that that includes more than one analyte species, such as different species of nucleic acids (e.g., miRNAs), or different species of proteins or peptides. Optionally, a mixture on analytes may include different types (classes, categories) of analytes—such as both nucleic acids and proteins/peptides, or proteins/peptides and carbohydrates, and so forth. However, in embodiments described herein the mixed analyte composition only contains (or substantially only contains) one type/class/category of analyte. Alternative terms including “heterogenous analyte” and “heterogenous preparation of analytes”, for instance.

“Resolve” as used herein is a term that refers to separating an analyte mixture into distinct bands or peaks.

“Sieving gel” refers to the gel that functions such that shorter molecules move faster and migrate farther than longer ones because shorter molecules migrate more easily through the gel or through the higher viscosity gel solution.

“Thermal gel” refers to a thermally reversible compound. For example, the thermal gel may be in liquid-phase at a low temperature (e.g., 10° C.) and in solid-phase at a relatively higher temperature (e.g. 30° C.). As another example, the thermal gel may be in liquid-phase at high temperature and solid at cold temperature.

“Thermally responsive” refers to a characteristic of a substance (such as a gel) that undergoes changes in response to external temperature.

### (II) Overview of Injectionless System for Concentration and/or Separation of Analytes

This section provides a general overview of injectionless system for concentration and/or separation of analytes. Various aspect of the system will be discussed, such as the structure and elements of the system, the channel format, the gel, the electrolytes, application of current, source of power, asymmetrical electrical field, types of analytes for analysis, and the like. The system may selectively quantify analytes in a low-complexity analysis.

A microfluidic device as described herein includes a channel, a first reservoir (referred to as a cathodic reservoir or an anodic reservoir, in various embodiments), a second reservoir (referred to as an anodic reservoir or a cathodic reservoir, in various embodiments), a first electrode, and a second electrode. The channel is configured to accommodate a mixed analyte sample (that is, a sample that contains two or more different analytes) mixed with a gel solution. The channel has a first end and a second end. The first reservoir is coupled to the first end of the channel. The first reservoir is configured to accommodate a solution, e.g., a first reservoir solution. The second reservoir is coupled to the second end of the channel. The second reservoir is configured to accommodate a solution, e.g., a second reservoir solution. The first electrode is arranged in the first reservoir. The second electrode is arranged in the second reservoir. The first electrode and the second electrode, in some embodiments, are configured to apply an asymmetric electric field across the microfluidic device. Alternatively, the first electrode and the second electrode are configured to apply a symmetric electric field across the microfluidic device.

In example embodiments, the direction of the migration of analytes is from the first reservoir to the second reservoir. Where the analytes being concentrated and/or separated are anionic analytes, the migration of analytes is from the first reservoir (which is a cathodic reservoir) to the second reservoir (which is an anodic reservoir). Where the analytes being concentrated and/or separated are cationic analytes, the migration of analytes is from the first reservoir (which is an anodic reservoir) to the second reservoir (which is a cathodic reservoir). Additional embodiments are described herein.

### Microfluidic Device on a Microscope Slide or Other Portable Unit:

Microfluidic devices in this demonstration molded channels in polydimethylsiloxane. Individual channels were diced from the mold and then adhered to glass slides to form enclosed channels to contain fluid. Devices can also be created from other materials including, but not limited to, cyclic olefin copolymer, cyclic olefin polymer, acrylic, acrylonitrile butadiene styrene, nylon polyamide, polycarbonate, polyethylene, polyoxymethylene, polypropylene, polystyrene, polyurethane, or glass. Devices can also be created using processes including injection molding, hot embossing, and the like.

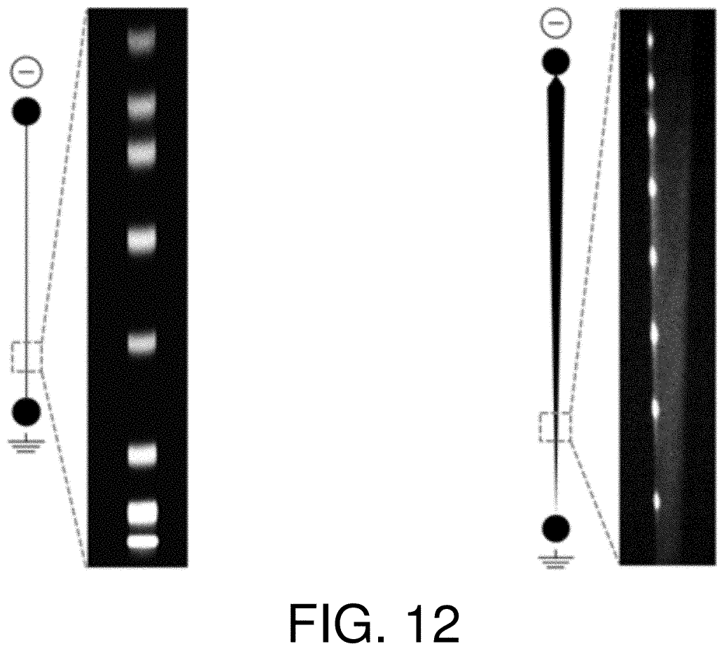

Straight-sided (standard) channels vs. tapered channel: Microfluidic devices may have a straight-sided channel (standard channels) or a tapered channel, as described herein. FIG. 12 illustrates a comparison of detection results between a standard channel microfluidic device and a tapered channel microfluidic device. The tapered channel microfluidic device was designed to further improve detection sensitivity and separation resolution. The tapered channel was created to confine analytes into bands that progressively migrated into regions of higher electric field. This novel device design significantly improved limits of detection and separation resolution compared to a standard channel microfluidic device.

Gels: As described herein, thermal gels can be used during the process of injectionless gel electrophoresis. Example thermal gels include Pluronic F-127 (PF-127; aka Poloxamer 407), Pluronic F-68, dimyristoyl-sn-glycero-3-phosphocholine, 1,2-dihexanoyl-sn-glycero-3-phosphocholine, poly(N-isopropylacrylamide)-g-poly(ethyleneoxide), N,N′-dimethylacrylamide (DMA) and N,N′-diethylacrylamide (DEA), N-ethoxyethylacrylamide (NEEA) and N-methoxyethylacrylamide (NMEA). Other types of gels, such as matrices for capillary gel electrophoresis (Miksik et al., Biomed. Chromatogr. 20:458-465, 2006), polymer sieving matrices (Chung et al., The Royal Society of Chem., 139:5635-5654, 2014), and the like may be used. The present disclosure is not limited thereto.

Electrolyte solutions (Leading and Trailing): Electrolyte solution(s) are used to provide ions that carry a current and to conduct the preconcentration and electrophoresis processes. In representative embodiments described herein, a first reservoir and a second reservoir are configured to accommodate electrolyte solutions. As described herein, the electrolyte solutions include anionic and/or cationic components. In some examples, the electrolyte solution may include a trailing electrolyte (TE) solution and a leading electrolyte (LE) solution. There are four classes of electrolytes: LE+, LE−, TE+, TE−. In some examples, both anionic LE (LE−) and anionic TE (TE−) can be added into the same reservoir. As an example where the first reservoir is a cathodic reservoir, the cathodic reservoir solution is composed of 800 mM glycine (which is TE−), 5 mM tris-HCl (where tris is TE+ and Cl− is LE−), and 1 mM MgCl₂ (where Mg²⁺ is LE+, and Cl− is LE−), and the anodic reservoir solution (contained in the second reservoir, which is an anodic reservoir) is composed of 200 mM ammonium acetate (where ammonium is LE+, and acetate is LE−), 5 mM tris-HCl, and 1 mM MgCl₂. The same electrolytes can be used for analysis of either anionic or cationic analytes; however, the placement in reservoirs is reversed for analysis of cationic analytes compared to anionic analytes.

More generally, exemplary electrolytes include: Glycine (TE−); Tris-HCl (where Tris is TE+ and Cl is LE−); MgCl₂ (where Mg²⁺ is LE+ and Cl−is LE−); Ammonium acetate (where ammonium is LE+ and acetate is LE−); Tricine (TE−); Proline (TE−); Borate (TE−); HEPES (TE−); Bis-tris methane (TE+); Bis-tris propane (TE+); NaCN (where sodium is LE+ and CN is LE−); NaCl (where sodium is LE+ and Cl is LE−); ammonium chloride (where ammonium is LE+ and Cl is LE−); and sodium acetate (where sodium is LE+ and acetate is LE−). Additional feasible electrolytes will be readily identified by those of skill in the art. Further, one of ordinary skill can order the relative mobility of any two (or more) electrolyte species, for instance in order to use two (or more) in a multi-zonal TGE analysis as described herein.

LE and TE compositions described in Example 1 were optimized to maximize analyte enrichment until the band reached approximately half-way to the detection point, followed by an automatic initiation of the separation. The closest analogy of the sought behavior in the literature are reports of bidirectional ITP (Bahga et al., Anal. Chem., 83(16):6154-6162, 2011). However, the arrangement of electrolytes in the herein described systems is distinguishable from and inconsistent with bidirectional ITP. One distinction in particular is that in the herein described systems both anionic LE and TE are combined into the same reservoir. Similarly, cationic LE and TE are combined into the same reservoir.

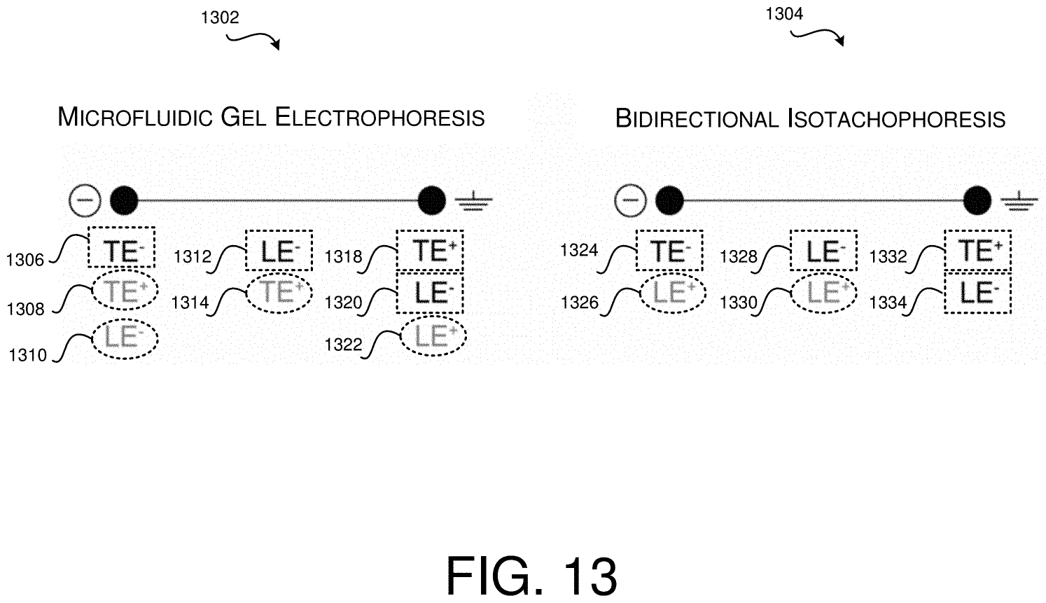

Contrast with bidirectional isotachophoresis: FIG. 13 illustrates a comparison between the gel electrophoresis described herein (which is exemplified in embodiments as thermal gel electrophoresis; TGE) and bidirectional isotachophoresis (ITP) for the analysis of anionic analytes. This figure illustrates the initial positions of electrolytes in a single-channel device, and illustrates contrasts between TGE and bidirectional ITP. The electrolytes employed in embodiments of the herein-provided gel electrophoresis system are glycine (TE−), tris (TE+), chloride (LE−), and ammonium (LE+). The electrolytes employed in bidirectional ITP are reported in Bagha et al. (Anal. Chem., 83:6154-6162, 2011). Electrolyte positions similar between both techniques are shown in dotted rectangles. Electrolyte positions unique to one technique are shown in dotted ellipses. Although both techniques require similar components (i.e. TE−, TE+, LE−, and LE+), the spatial positions in TGE are inconsistent with bidirectional ITP.

Referring to 1302, electrolytes TE− 1306, TE+ 1308, and LE− 1310 are provided (in solution) in the cathodic reservoir of a microfluidic gel electrophoresis device. TE− 1306 is an electrolyte common to both the microfluidic gel electrophoresis method and the bidirectional ITP method, while TE+ 1308 and LE− 1310 are electrolytes unique to the microfluidic gel electrophoresis method. Electrolytes LE− 1312 and TE+ 1314 are provided between the cathodic reservoir and the anodic reservoir of the microfluidic gel electrophoresis device, for instance in the gel matrix in which the sample is loaded into the device. LE− 1312 is an electrolyte common for both the microfluidic gel electrophoresis method and the bidirectional ITP method, while TE+ 1314 is an electrolyte unique to the microfluidic gel electrophoresis method. Electrolytes TE+ 1318, LE− 1320, and LE+ 1322 are provided (in solution) in the anodic reservoir of the microfluidic gel electrophoresis device. TE+ 1318 and LE− 1320 are electrolytes common to both the microfluidic gel electrophoresis method and the bidirectional ITP method, while LE+ 1322 is an electrolyte unique to the microfluidic gel electrophoresis method.

Referring to 1304, electrolytes TE− 1324 and LE+ 1326 are provided (in solution) in the cathodic reservoir of a bidirectional ITP device. TE− 1324 is an electrolyte common in both the microfluidic gel electrophoresis method and the bidirectional ITP method, while LE+ 1326 is unique to the bidirectional ITP device. Electrolytes LE− 1328 and LE+ 1330 are provided between the cathodic reservoir and the anodic reservoir of the bidirectional ITP device. LE− 1328 is an electrolyte common for both the microfluidic gel electrophoresis method and the bidirectional ITP method, while LE+ 1330 is an electrolyte unique to bidirectional ITP method. Electrolytes TE+ 1332 and LE− 1334 are provided (in solution) in the anodic reservoir of the bidirectional ITP device. TE+ 1332 LE− 1334 are electrolytes common to both the microfluidic gel electrophoresis method and the bidirectional ITP method.

Both techniques (the herein described systems of injectionless gel electrophoresis and bidirectional isotachophoresis) are operationally similar in terms of loading the devices and applying the voltage. However, the locations of electrolytes in injectionless gel electrophoresis are distinct from bidirectional ITP. For example, both TE− and LE− are added in the same reservoir (exemplified herein as the cathodic reservoir), and TE+ and LE+ are added in the same reservoir (exemplified herein as the anodic reservoir). Bidirectional ITP does not work with both LE and TE of the same charges together in the same reservoir. Moreover, there are concentration gradients of the same electrolytes between the reservoirs and channel in injectionless gel electrophoresis. Such gradients produce steep electric field gradients at both ends of the channel.

Application of Current: Electrophoresis voltage is applied across the device via the electrodes using a high-voltage power supply. For example, the voltage applied may be ±1 kV for the standard channel device, and ±2 kV for the tapered channel device. Current could be applied across the device instead of voltage to drive the analysis. Embodiments are illustrated using a symbol for a negative electrode and a symbol for the ground, to illustrate where voltage is applied in a representative embodiment. This illustrated designation of negative electrode and ground applies for analysis of anionic analytes. It will be understood by one of ordinary skill in the relevant art that the disclosure also provides configurations in which the ground is replaced with a positive electrode. Alternatively, the polarity could be reversed from positive to ground or positive to negative, which would be employed for analysis of cationic analytes. In embodiments, the second electrode is not grounded but instead is held at a potential.

Source of Power. A four-channel high voltage power supply (Advanced Energy, Ronkonkoma, NY) was used to apply an electric field across the microfluidic channel. Gel electrophoresis as used herein generally operates with simplified hardware requirements (e.g., there is no need for a second power supply nor timing actuator) to reduce cost of the system and increase ease of operation (for instance, in comparison to MCE). As an example, the power may be less than 0.2 Watt.

Asymmetrical Electrical Field: In some embodiments, the first electrode and the second electrode are configured to apply an asymmetric electric field across the microfluidic device. The optional use of an asymmetric electric field better confines analytes to reduce volume and increase concentration. As described herein, the offset electrode positions may deflect analytes to the opposite side of the channel because of the asymmetric electric field and Coulombic repulsion of the anionic nucleic acids from the cathode. In embodiments analyzing cationic analytes, offset electrodes deflect analytes to the opposite channel wall because of repulsion from the anode.

### Types of Analytes for Analysis

Nucleic Acid Analytes: In implementations, the sample may include at least one of nucleic acids, carbohydrates, peptides, or proteins. In implementations, the sample may include two or more nucleic acid species, such as two or more miRNA species. In implementations, the sample may include a set of two or more probes, each with a different ssDNA overhang length, formulated for use as integrated drag tags. In implementations, fluorescent DNA probes may be designed to hybridize with each target miRNA. Single-stranded fluorescent DNA probes may be designed complementary in sequence to at least a portion of their target miRNA(s). Beneficially, selected probe sequences are screened to ensure that they will only bind to their intended target. Additional details of the sample are described throughout the present disclosure.

In a multiplexed miRNA analysis, miR-10b, miR-21, miR-145, and let-7a were selected as model analytes for this study, because of their potential to serve as biomarkers of breast cancer (Chan et al., Clin. Cancer Res., 19(16):4477, 2013; Ibrahim et al., Tumor Biol., 42(10):1010428320963811, 2020). This group has shown that gel electrophoresis provides>100-fold analyte preconcentration and high separation resolution sufficient to resolve protein isoforms—all while requiring only minimal user steps and hardware requirements (Peli Thanthri et al., Anal. Chem., 92(9):6741-6747, 2020).

Label & Drag Tags for Nucleic Acids: In implementations, the sample may include a set of two or more probes, each with a different ssDNA overhang length, formulated for use as integrated drag tags. In implementations, fluorescent DNA probes may be designed to hybridize with each target miRNA. Single-stranded fluorescent DNA probes may be designed complementary in sequence to at least a portion of their target miRNA(s). Beneficially, selected probe sequences are screened to ensure that they will only bind to their intended target. Sequences of example probes are shown in Table 1 (below).

As described in examples herein, results demonstrate that sequentially adding five nucleotide overhangs to each probe sufficiently altered the mobility of both ss- and ds-species as they migrated through the gel. This was attributed to sequentially higher entanglement of longer DNA overhangs with the gel to promote separation. Although the minimum needed overhang length was not empirically determined, this can be varied based on the teachings herein, for instance in future studies seeking to increase peak capacity and include additional biomarkers into a clinical miRNA panel. Regardless, the use of ssDNA overhangs as drag tags afforded a simple means to separate miRNAs. Incorporating additional nucleotides into synthetic DNA probes is trivial for the manufacturer and results in only a minimal price increase, making this a cost-effective approach for multiplexed miRNA analysis.

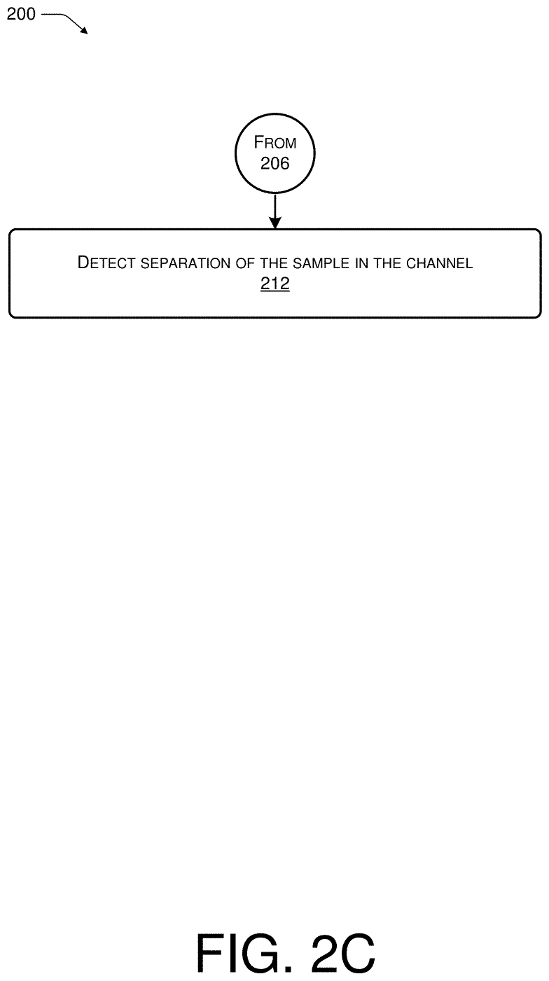

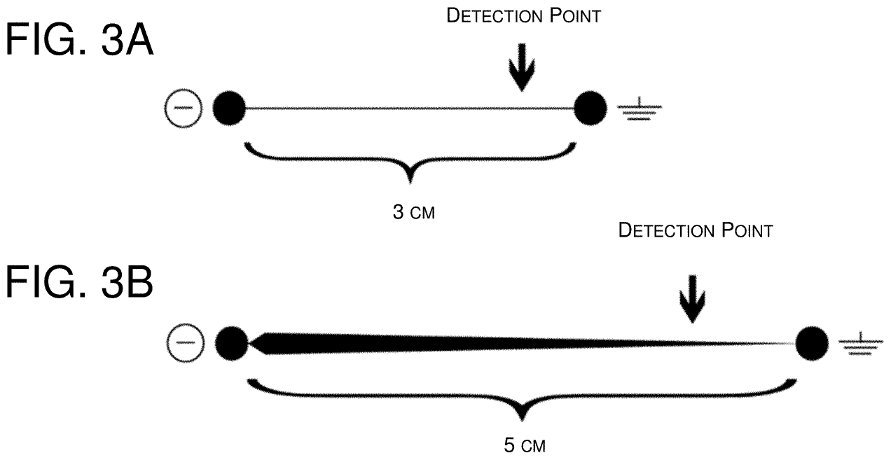

As demonstrated herein, long ss-probe migrates faster than short ds-hybrids (FIG. 4B) in a described system.

Other analytes: As described throughout the present disclosure, the device and the process of injectionless gel electrophoresis can be used to analyze various types of analytes, such as proteins, carbohydrates, peptides, or other biomolecules. Though illustrated extensively herein using nucleic acid analytes, the present disclosure is not limited thereto. Moreover, conditions (such as electrolytes, voltages, dimensions of the microfluidic device, and so on) for conducting analysis may be varied for different analytes. For example, when analyzing proteins or other analytes that will be separated in the provided systems based on their own physical and characteristics, no nucleic acid-based “drag tag” probes are needed. In implementations, inline preconcentration and separation of variants of a single protein may be achieved. This system operates under the same mechanism as miRNA analysis.

Proteins must maintain proper folding conformations and express the correct post-translational modifications (PTMs) to exhibit appropriate biological activity. However, assessing protein folding and PTMs is difficult because routine polyacrylamide gel electrophoresis (PAGE) methods lack the separation resolution necessary to identify variants of a single protein. Additionally, standard PAGE denatures proteins prior to analysis precluding determinations of folding states or PTMs. To overcome these limitations, a microfluidic gel electrophoresis platform was developed to provide high-sensitivity, high-resolution analyses of native protein variants. A thermally reversible gel was utilized as a separation matrix while in its solid state (30° C.). This gel provided sufficient separation resolution to identify three variants of a fluorescently labeled model protein. To increase detection sensitivity, analyte preconcentration was conducted in parallel with the separation. Continuous analyte enrichment afforded detection limits of 500 fg of protein (250 pM) while simultaneous baseline separation resolution was achieved between variants. The effects of temperature on gel electrophoresis were also characterized. The unique temperature dependent outcomes illustrated how method performance can be tuned through a thermal dimension. Ultimately, the high detection sensitivity and separation resolution provided by gel electrophoresis enabled rapid screening of native protein variants. Protein variants can be separated in an analogous method/mechanism as the miRNAs.

In addition, as demonstrated in Example 5, analyte conformation (exemplified by the conformation of the protein Calmodulin, when bound or not bound with Ca2+) can be characterized using the TGE methods, devices, and systems provided herein. This provides a unique system for separation of different forms of biologically important analytes, including for instance active and inactive confirmations of medically or scientifically important molecules. The technology provided herein allows an exquisitely tunable system for separating and characterizing structurally similar analytes/molecules that can be distinguished by their mobility in the provided gels. In embodiments, it is believed that enantiomers can similarly be separated and characterized.

The same power supply can be used as in the miRNAs analysis. Temperature of the stage was controlled using a suitable equipment (e.g., Peltier (TEC1-12730)) and thermoelectric controller (Wavelength Electronics, Bozeman, MT). Real-time temperature feedback was provided by a resistance temperature detector (Omega Engineering, Norwalk, CT) affixed to the Peltier. A custom program written in LabVIEW (National Instruments, Austin, TX) was used to control separation voltage and stage temperature. Images were acquired at 2.4× magnification with 150 ms exposure times at discrete distances along the separation channel. All hardware was controlled using MicroManager. Images were processed using FIJI and field-flattened to correct for nonuniform illumination across the channel. Separation metrics were determined using Chromophoreasy software (Vaz et al., J. Brazil Chem. Soc., 27:1899-1911, 2016).

PAGE separations utilize gels with well-defined regions containing different polymer concentrations and electrolyte compositions to achieve sequential preconcentration and separation. In the studies presented here, gel electrophoresis analyses achieved both stacking and resolving simultaneously using a single set of conditions (30% gels at 30° C.) in a single analysis channel. This mechanism only works with protein. This reduced experimental complexity compared to conventional gels by eliminating the need for separate gel regions. Robust preconcentration enabled low LODs to be achieved, while the high resolution in this viscosity-based separation resolved multiple variants of a single native protein. These results demonstrate the high potential utility of the herein described method to measure the biological purity of protein samples by identifying post-translationally modified or misfolded variants. Further characterizations of thermal gel behavior revealed that analytical performance could be controlled by the user through a thermal dimension. Incorporation of temperature control into the analysis provided an adjustable parameter to govern analytical outcomes in the system. The innovative results reported here demonstrate the great potential of gel electrophoresis to conduct high sensitivity native protein analyses for diverse bioanalytical applications.

Labels for Other Analytes: Analytes such as proteins, carbohydrates, and lipids can be detected labeled with fluorescent dyes via covalent or noncovalent binding. Numerous fluorescent dyes are commercially available with multiple reaction chemistries to enable functional groups on the analyte to be labeled including amines, aldehydes, carboxylic acids, ketones, thiols, azides, etc. Dyes include small molecules (e.g., AlexaFluor® fluorescent dyes, fluorescein), proteins (e.g., green fluorescent protein, phycoerythrin), semiconductor materials (e.g., quantum dots), or other fluorescent species. Nonfluorescent tags can also be used for detection including UV-Vis absorbance chromophores, IR-active probes, Raman-active probes, nanoparticles, and the like. Noncovalent detection involves association of the analyte with a probe to form an observable complex using reagents such as aptamers, SOMAmers, Coomassie blue, etc. Similarly, nucleic acids can also be detected without probes using intercalating dyes (e.g., SYBR Green, ethidium bromide) to form detectable species. In iterations where intrinsic absorbance or mass spectrometric detection is used, analytes would not need an exogenous label and could detected directly.

### (III) Device Configurations

This section provides details of the device configuration including the structure and elements of the device and how it works to perform its function.

Overall structure: a microfluidic device, including a channel, a first reservoir, a second reservoir, a first electrode, and a second electrode. The channel is configured to accommodate a mixed analyte sample (that is, a sample that contains two or more different analytes) mixed with a gel solution. The channel has a first end and a second end. The first reservoir is coupled to the first end of the channel. The first reservoir is configured to accommodate a first reservoir solution. The second reservoir is coupled to the second end of the channel. The second reservoir is configured to accommodate a second reservoir solution. The first electrode is arranged in the first reservoir. The second electrode is arranged in the second reservoir. The first electrode and the second electrode, in some embodiments, are configured to apply an asymmetric electric field across the microfluidic device.

Channel formats: different channel formats can be used here, such as straight-sided (standard) channel, tapered channel, serpentine channel, or any combination thereof. This disclosure is not limited thereto, and other shapes or formats of the channel can be used as long as it can perform the injectionless gel electrophoresis process.

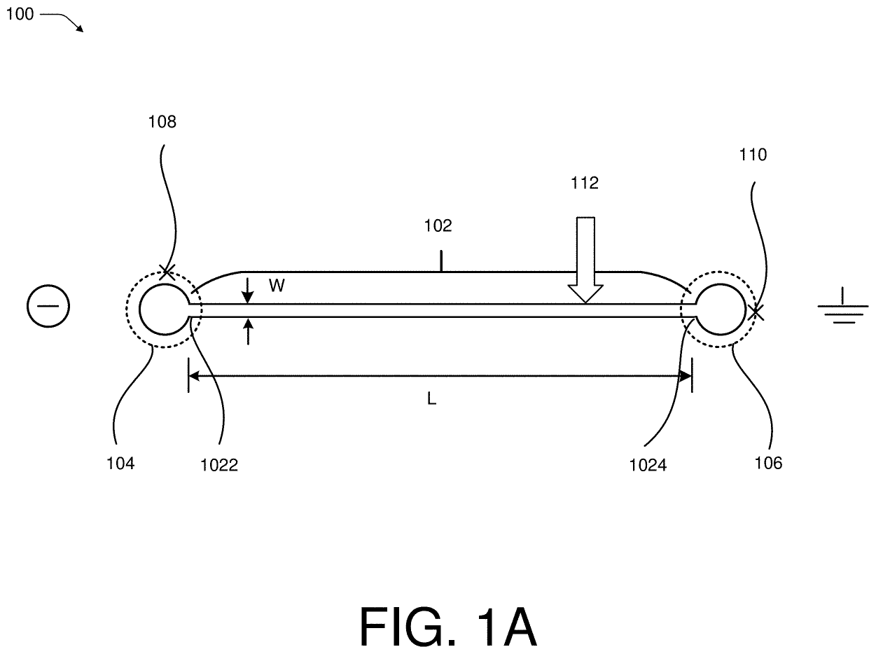

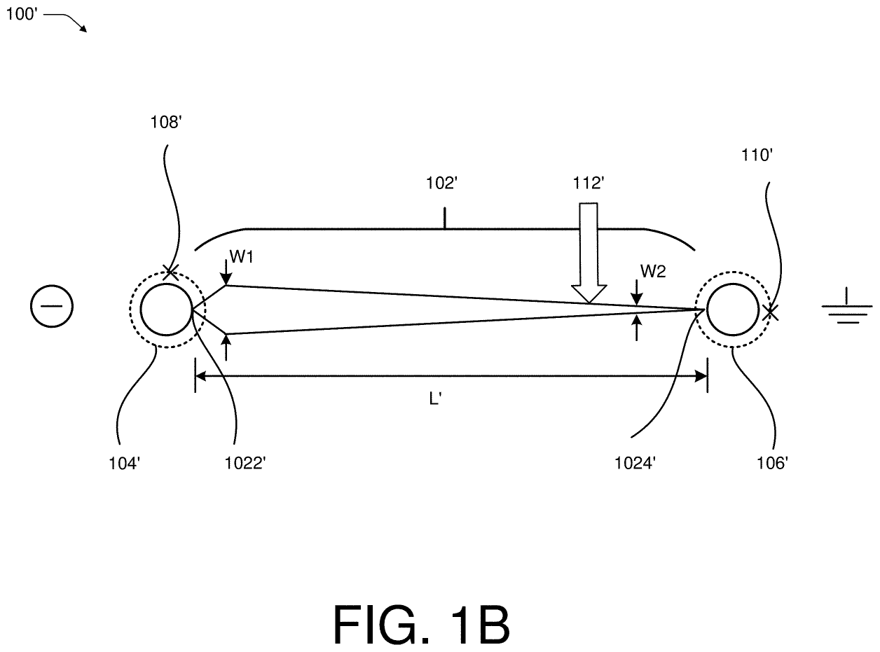

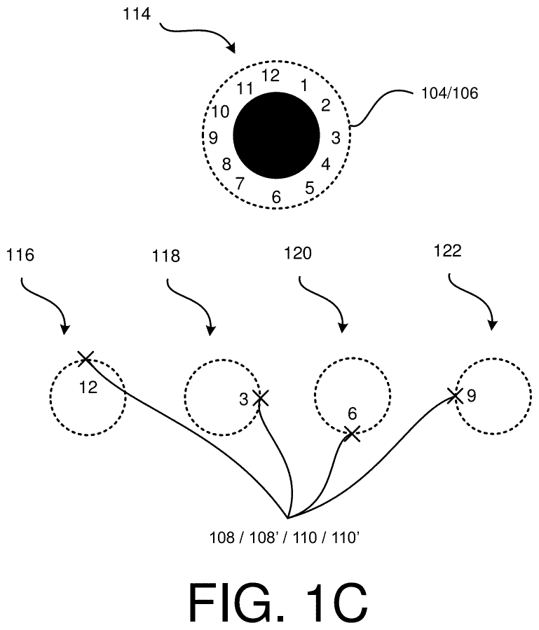

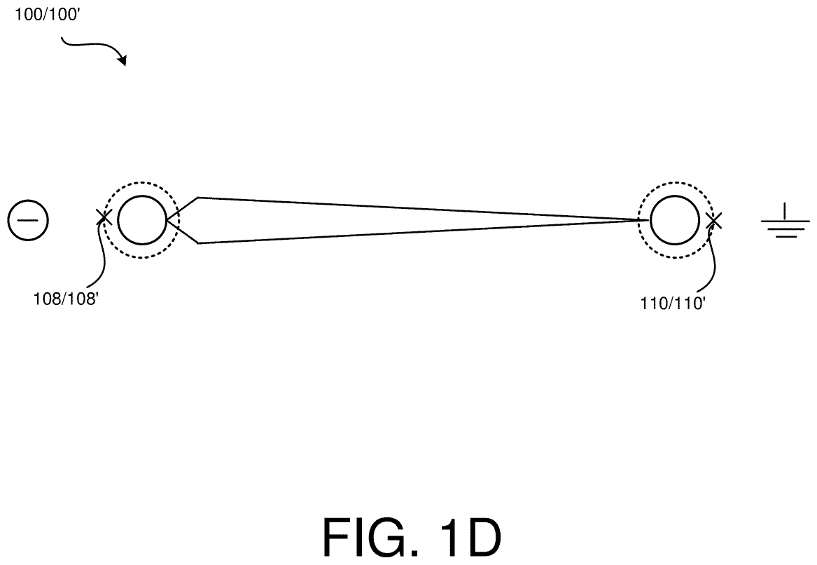

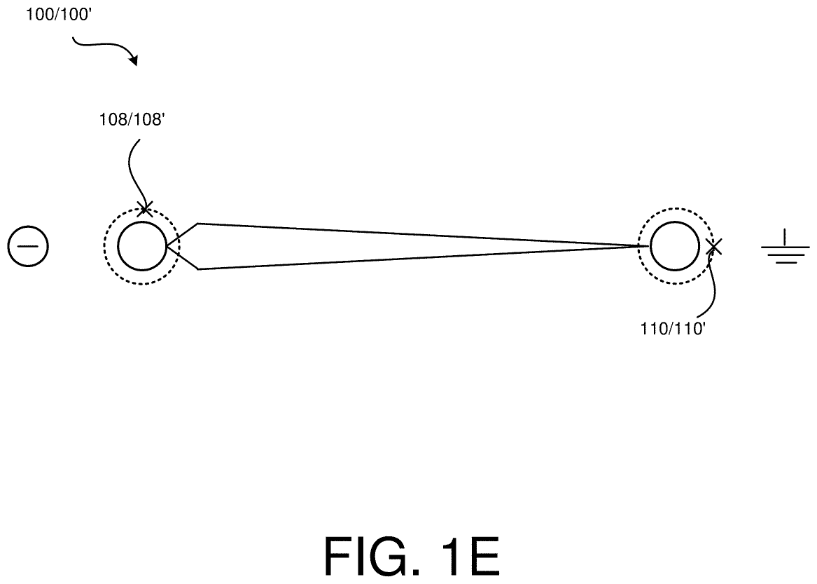

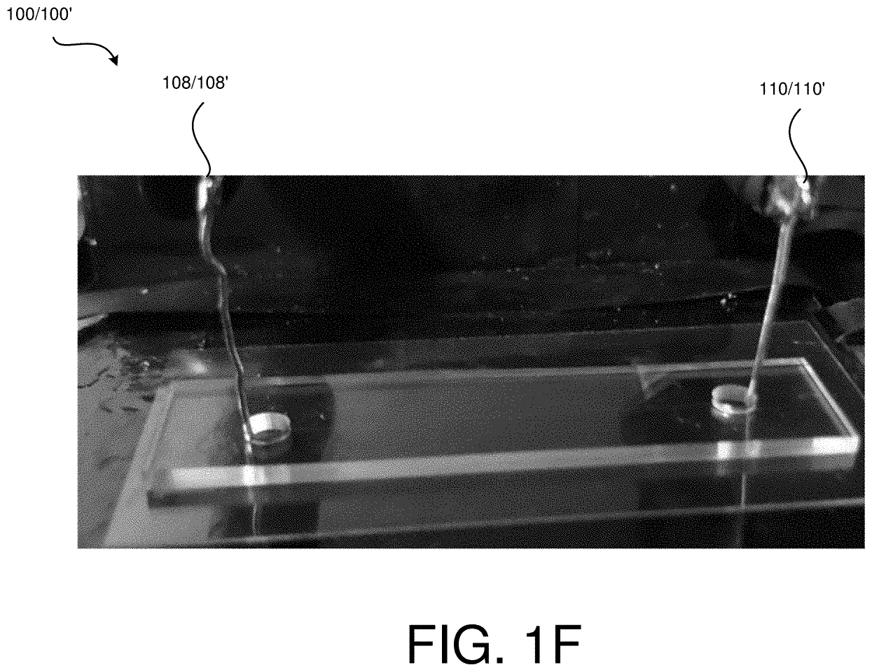

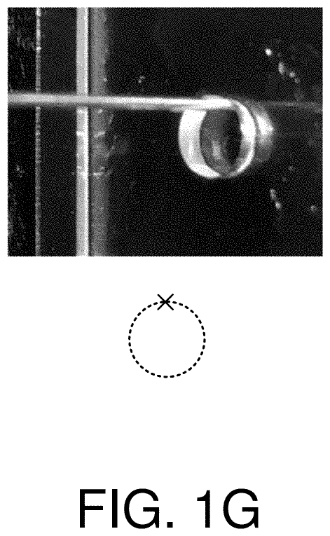

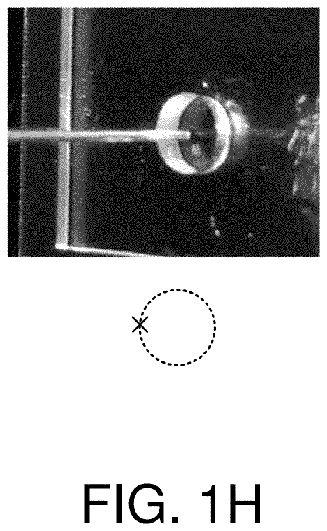

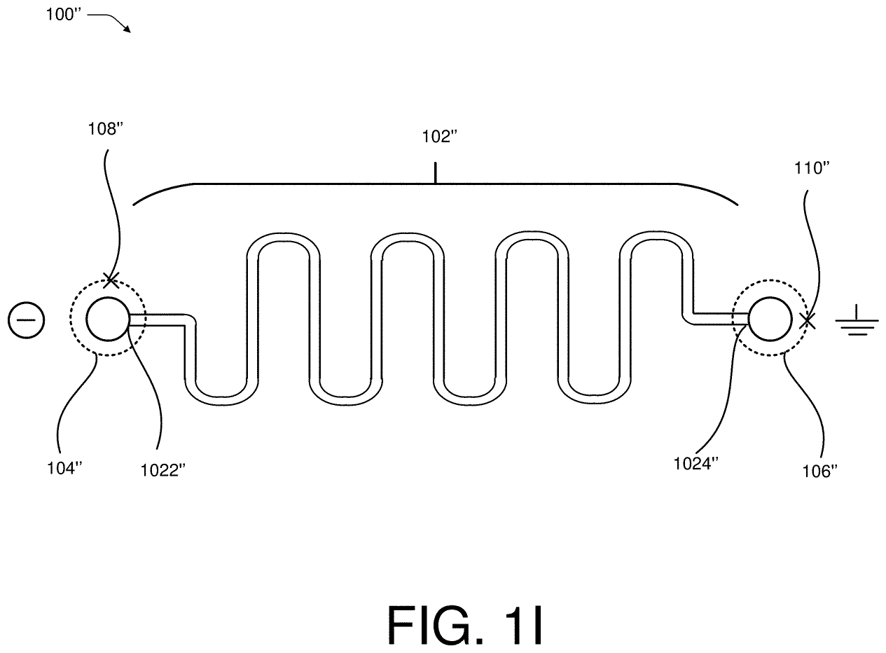

Reservoir placement and formats: the reservoirs are placed at two ends of the channel of the microfluidic device. As an example, the first reservoir (cathodic reservoir) and the second reservoir (anodic reservoir) are configured to accommodate the electrolyte solutions. In some examples, the electrolyte solution may include the cathodic reservoir solution and the anodic reservoir solution. The positions of the reservoirs relative to the channel affect the analysis, especially in the application of an asymmetric electric field. Analyte preconcentration and separation are improved by shifting the first reservoir (FIG. 1B, 104′) away from the channel opening, i.e. towards the 9 o'clock position.

Electrode placement and format: The first electrode is arranged in the first reservoir. The second electrode is arranged in the second reservoir. In some embodiments, the first and second electrodes are configured to apply an asymmetric electric field using offset electrode positions. As described herein, the offset electrode positions may deflect analytes to the opposite side of the channel because of the asymmetric electric field and Coulombic repulsion of the anionic nucleic acids from the cathode. In embodiments analyzing cationic analytes, offset electrodes deflect analytes to the opposite channel wall because of repulsion from the anode. Alternatively, the first electrode and the second electrode are configured to apply a symmetric electric field across the microfluidic device.

In some embodiments, the method involves anionic analytes migrating from the first reservoir to the second reservoir, and the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.

In some embodiments, the method comprises cationic analytes migrating from the first reservoir to the second reservoir, and the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.

Several of the drawings and drawing panels illustrating aspects of the disclosure include a symbol for a negative electrode and a symbol for the ground, to illustrate where voltage is applied in a representative embodiment. This illustrated designation of negative electrode and ground applies for analysis of anionic analytes. It will be understood by one of ordinary skill in the relevant art that the disclosure also provides configurations in which the ground is replaced with a positive electrode. Alternatively, the polarity could be reversed from positive to ground or positive to negative, which would be employed for analysis of cationic analytes. In embodiments, the second electrode is not grounded but instead is held at a potential.

Power supply: different types of power supply can be used here. As an example, a four-channel high voltage power supply (Advanced Energy, Ronkonkoma, NY) was used to apply an electric field across the microfluidic channel. This disclosure is not limited thereto, and other types of power supply can be used as long as it can perform the injectionless gel electrophoresis process.

Details of an example microfluidic device 100 is described hereinafter.

FIG. 1A illustrates a schematic top view of an example microfluidic device 100 with a standard channel 102 according to implementations of the present disclosure. Referring to FIG. 1A, the microfluidic device 100 includes a channel 102, a first reservoir 104, a second reservoir 106, a first electrode 108, and a second electrode 110. The channel 102 has a width w and a length L, and a height H. The channel 102 has a first end 1022 and a second end 1024. The first reservoir 104 is coupled to the first end 1022 of the channel 102. The second reservoir 106 is coupled to the second end 1024 of the channel 102.

The channel 102 has a uniform width W. The length L of the channel 102 may be between 5 mm to several tens cm. For example, the length L of the channel 102 may be 3 cm. It should be understood that, the width W and the length L of the channel 102 may be designed based on actual needs, and the present disclosure is not limited thereto. Though FIG. 1A shows that the channel 102 has a linear geometry, the channel 102 may have a serpentine style shape to make the channel 102 longer.

The first reservoir 104 and the second reservoir 106 are configured to accommodate an electrolyte solution. In some examples, the electrolyte solution may include a cathodic reservoir solution and/or an anodic reservoir solution (recognizing that both solutions are used when the device is in operation, with one solution in each reservoir). In implementations, the first reservoir 104 is a cathodic reservoir, and the second reservoir 106 is an anodic reservoir. In other implementations, the first reservoir 104 is an anodic reservoir, and the second reservoir 106 is a cathodic reservoir. The same electrolytes can be used for analysis of either anionic or cationic analytes; however, the placement in first and second reservoirs is reversed for analysis of cationic analytes compared to anionic analytes.

The first electrode 108 is arranged in the first reservoir 104. The second electrode 110 is arranged in the second reservoir 106. In some embodiments, the first electrode 108 and the second electrode 110 are configured to apply an asymmetric electric field across the microfluidic device 100. In some embodiments, the first electrode 108 and the second electrode 110 are configured to apply a symmetric electric field across the microfluidic device 100. Electrophoresis voltage is applied across the device 100 via the first electrode 108 and the second electrode 110 using a high-voltage power supply. For example, the voltage applied may be ±1 kV, and the power may be less than 0.2 Watt. In implementations, the voltage applied may be related to the length L of the channel 102.

FIG. 1B illustrates a schematic top view of an example microfluidic device 100′ with a tapered channel 102′ according to implementations of the present disclosure. Referring to FIG. 1B, the microfluidic device 100′ includes a channel 102′, a first reservoir 104′, a second reservoir 106′, a first electrode 108′, and a second electrode 110′. The channel 102′ has a first end 1022′ and a second end 1024′. The first reservoir 104′ is coupled to the first end 1022′ of the channel 102′. The second reservoir 106′ is coupled to the second end 1024′ of the channel 102′.

In implementations, the channel 102′ has a tapered geometry. The length L′ of the channel 102′ may be between 5 mm to several tens of cm. For example, the length L′ of the channel 102′ may be 5 cm. The channel 102′ may be designed with a wide entrance to enable more analyte molecules to be loaded into the device 100′, and then tapered into a narrow detection region, to confine separated analyte bands within a low volume. As an example, proximate the first end 1022′, the channel 102′ expands to a first width W1 (e.g., 1.9 mm) over a 1.5 mm distance and then narrowed back down to a second width W2 (e.g., 100 μm) over the remaining 48.5 mm. It should be understood that, the first width W1, the second width W2, and the length L′ of the channel 102′ may be designed based on actual needs, and the present disclosure is not limited thereto.

Additionally, the channel 102′ may have a curved or serpentine style shape, which can be used to make the channel 102′ longer. Additionally, the channel 102′ may have a tapered shape and a serpentine style shape at the same time.

In implementations, an opening may be arranged between the first reservoir 104′ and the channel 102′. For example, the width of the opening may be designed based on actual needs, such as 100 μm and so on. The opening from the first reservoir 104′ into the channel 102′ is included in the microfluidic design to force the electric field to enter the fluidic device 100′ through a well-defined constriction. It should be understood that there may be no opening between the first reservoir 104′ and the channel 102′.

The first reservoir 104′ and the second reservoir 106′ are configured to accommodate electrolyte solution. In some examples, the electrolyte solution may include a cathodic reservoir solution and/or an anodic reservoir solution (recognizing that both solutions are used when the device is in operation, with one solution in each reservoir). In implementations, the first reservoir 104′ is a cathodic reservoir, and the second reservoir 106′ is an anodic reservoir. In alternative implementations, the first reservoir 104′ is an anodic reservoir, and the second reservoir 106′ is a cathodic reservoir.

The first electrode 108′ is arranged in the first reservoir 104′. The second electrode 110′ is arranged in the second reservoir 106′. In some embodiments, the first electrode 108′ and the second electrode 110′ are configured to apply an asymmetric electric field across the microfluidic device 100′. In some embodiments, the first electrode 108′ and the second electrode 110′ are configured to apply a symmetric electric field across the microfluidic device 100′. Electrophoresis voltage is applied across the device 100′ via the first electrode 108′ and the second electrode 110′ using a high-voltage power supply. For example, the voltage applied may be ±2 kV. In implementations, the voltage applied may be related to the length L of the channel 102′.

With regard to FIG. 1A and FIG. 1B, channels 102 and 102′ are configured to accommodate a mixed analyte sample (that is, a sample that contains two or more different analytes) mixed with a gel solution. In implementations, the sample may include biomolecules. In implementations, the sample may include at least one of nucleic acids, carbohydrates, peptides, or proteins. In implementations, the sample may include two or more nucleic acid species, such as two or more miRNA species. In implementations, the sample may include a set of two or more probes, each with a different ssDNA overhang length, formulated for use as integrated drag tags. In implementations, fluorescent DNA probes may be designed to hybridize with each target miRNA. Single-stranded fluorescent DNA probes may be designed complementary in sequence to at least a portion of their target miRNA(s). Beneficially, selected probe sequences are screened to ensure that they will only bind to their intended target. Additional details of the sample are described throughout the present disclosure.

In implementations, the gel is configured to suppress an electroosmotic flow (EOF) in the channels 102 and 102′. EOF refers to the bulk transport of liquid from one end to the other in the channels 102 and 102′. In implementations, the gel is a sieving gel for resolving analytes in the sample. In implementations, the gel is configured to suppress a current runaway in the channels 102 and 102′. In implementations, the gel is thermally responsive. As described herein the gel served multiple beneficial roles in the analysis including suppression of EOF and reduction of separation current, which enabled higher voltages to be applied to increase separation efficiencies. The gel matrix also promoted high-resolution separations by entangling with the extended overhangs of the probes. However, it should be understood that it is not essential for the gel to be thermally responsive, and the gel can be any type of gel as long as the gel can keep the analytes in place and function as the sieving medium. Other types of gels, such as matrices for capillary gel electrophoresis (Miksík et al., Biomed. Chromatogr. 20:458-465, 2006), polymer sieving matrices (Chung et al., The Royal Society of Chem., 139:5635-5654, 2014), and the like may be used. The present disclosure is not limited thereto.

In implementations, the cathodic reservoir solution includes glycine, tris-HCl, and/or MgCl₂. In implementations, the anodic reservoir solution includes ammonium acetate, tris-HCl, and/or MgCl₂. Notably, the same electrolytes can be used for analysis of either anionic or cationic analytes; however, their placement in reservoirs is reversed for analysis of cationic analytes compared to anionic analytes. Additional details of the electrolytes are described throughout the present disclosure.

In implementations, the microfluidic devices 100 and 100′ are configured to conduct injectionless gel electrophoresis. The sample mixed with the gel solution is loaded throughout the channels 102 and 102′. In the example as shown in FIG. 1, the gel is then solidified by warming the devices (e.g. 25° C.) 100 and 100′ to immobilize the sample and electrolytes in place and to provide a sieving matrix. No sample injection is needed to begin the analysis, unlike conventional analytical methods. In the example as shown in FIG. 1, anionic analyte(s) in the sample migrates from left to right upon voltage application where an inline preconcentration and separation occur without requiring user intervention. In implementations, electropherograms can be obtained at detection points 112 and 112′. Positions of detection points can be anywhere along channels 102 and 102′, and the present disclosure is not limited thereto. As an example, the detection points for standard and tapered channels may be 25 mm and 40 mm, respectively.

Additionally, tapering the channel 102′ may improve separation resolution in parallel with increasing detection sensitivity. The local electric field may progressively increase down the channel 102′ due to the progressively increasing channel resistance. The tapered channel 102′ is configured to confine analytes into bands that progressively migrated into regions of higher electric field. This novel device design with tapered channel 102′ significantly improved limits of detection and separation resolution, compared to the standard microfluidic channel 102. Additional details of the tapered channel are described throughout the present disclosure.

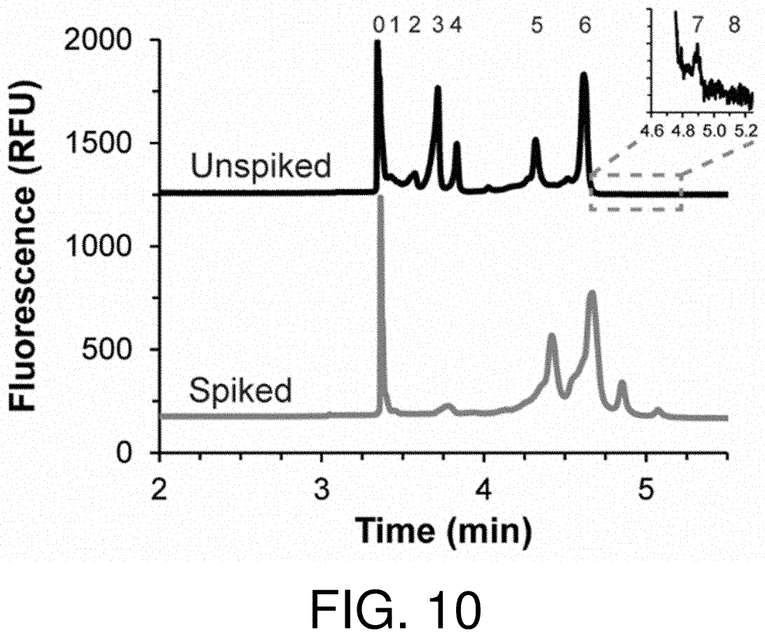

FIG. 10 illustrates various positions of the electrode (108, 110, 108′, 110′) according to implementations of the present disclosure. FIG. 10, shows an imaginary clock face 114 on top of the reservoir (such as 104 and 106). The clock face 114 may be used to denote different positions of the electrode with regard to the reservoir, e.g., 1 o'clock position, 2 o'clock position, 3 o'clock position, 4 o'clock position, 5 o'clock position, 6 o'clock position, 7 o'clock position, 8 o'clock position, 9 o'clock position, 10 o'clock position, 11 o'clock position, and 12 o'clock position. It should be understood that these positions are examples, and there may be other positions.

116 shows that the electrode (such as 108, 110, 108′, and 110′) is placed at the 12 o'clock position with regard to the reservoir (such as 104 and 106). 118 shows that the electrode (such as 108, 110, 108′, and 110′) is placed at the 3 o'clock position with regard to the reservoir (such as 104 and 106). 120 shows that the electrode (such as 108, 110, 108′, and 110′) is placed at the 6 o'clock position with regard to the reservoir (such as 104 and 106). 122 shows that the electrode (such as 108, 110, 108′, and 110′) is placed at the 9 o'clock position with regard to the reservoir (such as 104 and 106). It should be understood that using the clock positions to describe relative positions of the electrode is exemplary rather than limiting, and there may be other ways to describe the placement of the electrode, such as angles, coordinates, and the like.

FIG. 1D illustrates a top view of the microfluidic device 100/100′ with electrodes placed at parallel (in line with the channel) positions according to implementations of the present disclosure. Referring to FIG. 1D, the first electrode 108/108′ is placed at the 9 o'clock position, while the second electrode 110/110′ is placed at the 3 o'clock position.

FIG. 1E illustrates a top view of the microfluidic device 100/100′ with electrodes placed at offset positions according to implementations of the present disclosure. Referring to FIG. 1E, the first electrode 108/108′ is placed at the 12 o'clock position, while the second electrode 110/110′ is placed at the 3 o'clock position.

FIG. 1F illustrates a perspective view of the microfluidic device 100/100′ with electrodes placed at parallel (in line with the channel) positions according to implementations of the present disclosure. Referring to FIG. 1F, the first electrode 108/108′ is placed at the 9 o'clock position, while the second electrode 110/110′ is placed at the 3 o'clock position.

FIG. 1G illustrates a perspective view and a corresponding schematic diagram of the electrode (108, 110, 108′, 110′) placed at a 12 o'clock position according to implementations of the present disclosure. Referring to FIG. 1G, the electrode (108, 110, 108′, 110′) is placed at the 12 o'clock position.

FIG. 1H illustrates a perspective view and a corresponding schematic diagram of the electrode (108, 110, 108′, 110′) placed at a 9 o'clock position according to implementations of the present disclosure. Referring to FIG. 1H, the electrode (108, 110, 108′, 110′) is placed at the 9 o'clock position.

FIG. 1I illustrates a schematic top view of an example microfluidic device 100″ with a serpentine shaped channel according to implementations of the present disclosure. In implementations, the channel 102″ may have a serpentine style shape to make the channel longer.

Referring to FIG. 1I, the microfluidic device 100″ includes a channel 102″, a first reservoir 104″, a second reservoir 106″, a first electrode 108″, and a second electrode 110″. The channel 102″ has a first end 1022″ and a second end 1024″. The first reservoir 104″ is coupled to the first end 1022″ of the channel 102″. The second reservoir 106″ is coupled to the second 1024″ of the channel 102″.

The first reservoir 104″ and the second reservoir 106″ are configured to accommodate electrolyte solution. In some examples, the electrolyte solution may include cathodic reservoir solution and/or anodic reservoir solution (recognizing that both solutions are used for analysis, with one solution in each reservoir). In implementations, the first reservoir 104″ is a cathodic reservoir, and the second reservoir 106″ is an anodic reservoir. In other implementations, the first reservoir 104″ is an anodic reservoir, and the second reservoir 106″ is a cathodic reservoir.

The first electrode 108″ is arranged in the first reservoir 104″. The second electrode 110″ is arranged in the second reservoir 106″. In some embodiments, the first electrode 108″ and the second electrode 110″ are configured to apply an asymmetric electric field across the microfluidic device 100″. In some embodiments, the first electrode 108″ and the second electrode 110″ are configured to apply a symmetric electric field across the microfluidic device 100″. Electrophoresis voltage is applied across the device 100″ via the first electrode 108″ and the second electrode 110″ using a high-voltage power supply. For example, the voltage applied may be ±0.25 kV, ±0.50 kV ±1 kV, ±2 kV, and the like (though considerably higher absolute voltages can be used, such as ±10 kV, particularly when a serpentine path is employed), and the power may be less than 0.2 Watt. Though FIG. 1I shows that the channel 102″ has a uniform width, it should be understood that, the channel 102″ can have a tapered width.

As illustrated in FIG. 1A-FIG. 1E, the electrode (108, 110, 108′, 110′) is placed perpendicular to the top surface of the channel 102/102′. Because electric field is a vector quantity, offsetting the electrode relative to the channel 102/102′ may introduce a vertical (y-axis) component to the electric field in addition to the typical horizontal (x-axis) component that drives electrophoresis. Microfluidic devices operated with an offset electrode placement (e.g., 12 o'clock) produces analyte “bands” that are confined against the opposite wall of the channel (e.g., 6 o'clock). The same effect is generated when the electrode is placed at 6 o'clock except that the analytes migrated along the 12 o'clock channel wall. The offset electrode position deflected analytes to the opposite side of the channel 102/102′ because of the asymmetric electric field and Coulombic repulsion of the anionic nucleic acids from the cathode. In embodiments analyzing cationic analytes, offset electrodes deflect analytes to the opposite channel wall because of repulsion from the anode. Additional details of the offset positions of the electrode are described throughout the present disclosure.

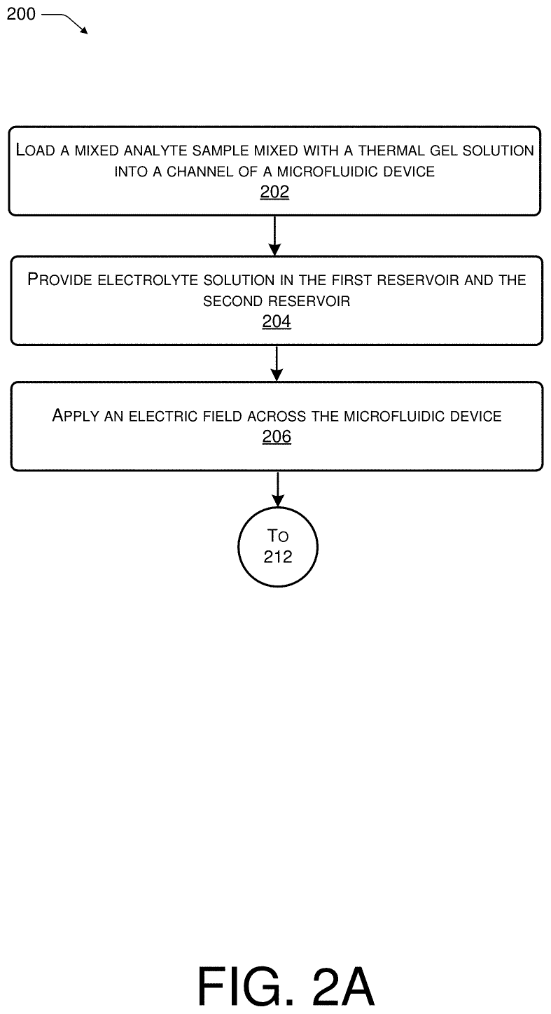

FIG. 2A, FIG. 2B, and FIG. 2C illustrate flowcharts of an example process 200 of injectionless gel electrophoresis according to implementations of the present disclosure. Referring to FIG. 2A, the process 200 includes the following operations.

At 202, operations include loading a mixed analyte sample mixed with a gel solution into a channel of a microfluidic device. No sample injection is needed to begin the analysis, unlike conventional analytical methods. The channel has a first end and a second end. The microfluidic device has a first reservoir coupled to the first end of the channel and a second reservoir coupled to the second end of the channel. The microfluidic device further includes a first electrode arranged in the first reservoir and a second electrode arranged in the second reservoir. In implementations, the channel has a linear geometry. Additionally or alternatively, the channel has a tapered geometry. Additionally or alternatively, the channel may have a serpentine style shape to make the channel longer.

In example embodiments, the direction of the migration of analytes is from the first reservoir to the second reservoir. Where the analytes being concentrated and/or separated are anionic analytes, the migration of analytes is from the first reservoir (which is a cathodic reservoir) to the second reservoir (which is an anodic reservoir). Where the analytes being concentrated and/or separated are cationic analytes, the migration of analytes is from the first reservoir (which is an anodic reservoir) to the second reservoir (which is a cathodic reservoir).

In implementations, an opening may be arranged between the first reservoir and the channel. For example, the width of the opening may be designed based on actual needs, such as 100 μm and so on. The opening from the first reservoir into the channel is included in the microfluidic design to force the electric field to enter the fluidic device through a well-defined constriction. It should be understood that there may be no opening between the first reservoir and the channel.

In implementations, the gel is configured to suppress an electroosmotic flow (EOF) in the channel. EOF refers to the bulk transport of liquid from one end to the other in the channel. In implementations, the gel is a sieving gel for resolving the sample. In implementations, the gel is configured to suppress a current runaway in the channel. In implementations, the gel is thermally responsive. It should be understood that it is not essential for the gel to be thermally responsive, and the gel can be any type of gel as long as the gel can keep the analytes in place and function as the sieving medium. Additional details of the gel are described throughout the present disclosure.

At 204, operations include providing (different) electrolyte solution in the first reservoir and the second reservoir. In some examples, the electrolyte solution may include the cathodic reservoir solution and the anodic reservoir solution. In implementations, the cathodic reservoir solution includes glycine, tris-HCl, and/or MgCl₂. For example, Glycine is a TE−; CI is a LE−; and Tris is a TE+. In implementations, the anodic reservoir solution includes ammonium acetate, tris-HCl, and/or MgCl₂. Additional details of the cathodic reservoir solution and anodic reservoir solution are described throughout the present disclosure. Notably, the same electrolytes can be used for analysis of either anionic or cationic analytes; however, their placement in reservoirs is reversed for analysis of cationic analytes compared to anionic analytes.

At 206, operations include applying an electric field across the microfluidic device. In some examples, the electric field may be an asymmetric electric field. Alternatively, the electric field may be a symmetric electric field. In implementations, applying the asymmetric electric field across the microfluidic device includes applying the asymmetric electric field with the first electrode arranged at an offset position.

In implementations, the electrode is placed perpendicular to the top surface of the channel. Because electric field is a vector quantity, offsetting the electrode relative to the channel may introduce a y-axis component to the electric field in addition to the typical x-axis component that drives electrophoresis. Microfluidic devices operated with an offset electrode placement (e.g., 12 o'clock) produces analyte “bands” that are confined against the opposite wall of the channel (e.g., 6 o'clock). The same effect may be generated when the electrode is placed at 6 o'clock except that the analytes migrated along the 12 o'clock channel wall. The offset electrode position deflected analytes to the opposite side of the channel because of the asymmetric electric field and Coulombic repulsion of the anionic nucleic acids from the cathode. In embodiments analyzing cationic analytes, offset electrodes deflect analytes to the opposite channel wall because of repulsion from the anode. Additional details of the offset positions of the electrode are described throughout the present disclosure.

Referring to FIG. 2B, the process 200 further includes the following operations. At 208, operations include dissolving the gel into buffer. In implementations, the buffer serves to stabilize pH, deliver the necessary LEs and TEs for the analysis, provide an environment compatible with biological molecules, and/or tune the gelation temperature at which the thermal gel transitions between liquid and solid.

At 210, operations include heating the channel to solidify the gel solution. For example, the gel is solidified by warming the microfluidic devices (e.g. 25° C.) to immobilize the sample and electrolytes in place and to provide a sieving matrix.

Referring to FIG. 2C, the process 200 further includes the following operations. At 212, operations include detecting the separation of the sample in the channel. In implementations, electropherograms can be obtained at detection points of the channel. Positions of detection points can be anywhere along the channel, and the present disclosure is not limited thereto. As an example, the detection points for standard and tapered channels may be 25 mm and 40 mm, respectively. In implementations, detector(s) are used to detect separation of the sample in the channel. For example, a camera is used in described examples to track bands (of analyte) as they migrate or at one or more time points during migration of analytes through the device. Optionally, a high sensitivity detector (e.g., photomultiplier tube) can be used to enable or improve detection of lower concentration analytes.

Additionally, those having ordinary skills in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

Those of ordinary skill in the art will recognize in light of the present disclosure that many changes can be made to the specific embodiments disclosed herein and still obtain a like or similar result without departing from the spirit and scope of the disclosure.

### (IV) Electrolyte Solutions

Electrolyte solutions are used to provide ions that carry a current and to conduct the electrophoresis process. These solutions have abundant ions in them, which is necessary for the passage of electricity through them. As described herein, the first reservoir and the second reservoir are configured to accommodate the electrolyte solutions. In some examples, the electrolyte solution may include the cathodic reservoir solution and anodic reservoir solution. As described herein, the placement of a cathodic reservoir solution or an anodic reservoir solution in the first or second reservoir is influenced by the type(s) of analytes being concentrated and/or separated. For instance, where analytes being concentrated and/or separated are anionic analytes, the migration of analytes is from the first reservoir (which is then a cathodic reservoir) to the second reservoir (which is then an anodic reservoir). Alternatively, where the analytes being concentrated and/or separated are cationic analytes, the migration of analytes is from the first reservoir (which is then an anodic reservoir) to the second reservoir (which is then a cathodic reservoir).

The same electrolytes can be used for analysis of either anionic or cationic analytes; however, their placement in reservoirs is reversed for analysis of cationic analytes compared to anionic analytes. Exemplary electrolytes include: Glycine (TE−); Tris-HCl (where Tris is TE+ and Cl is LE−); MgCl₂ (where Mg₂₊ is LE+ and Cl− is LE−); Ammonium acetate (where ammonium is LE+ and acetate is LE−); Tricine (TE−); Proline (TE−); Borate (TE−); HEPES (TE−); Bis-tris methane (TE+); Bis-tris propane (TE+); NaCN (where sodium is LE+ and CN is LE−); NaCl (where sodium is LE+ and Cl is LE−); ammonium chloride (where ammonium is LE+ and Cl is LE−); and sodium acetate (where sodium is LE+ and acetate is LE−). Additional feasible electrolytes will be readily identified by those of skill in the art. Further, one of ordinary skill can order the relative mobility of any two (or more) electrolyte species, for instance in order to use two (or more) in a multi-zonal TGE analysis as described herein.

Though example specific electrolytes, and combinations of electrolytes, are described, one of ordinary skill in electrophoresis and related systems will understand that additional electrolytes can be used in the described systems and methods, and will understand how to select an electrolyte or combination of different electrolyte species based on their mobility characteristics in order to facilitate analyte separation based on the teachings herein.

Concentrations: As an example, the cathodic reservoir solution is composed of 800 mM glycine, 5 mM tris-HCl, and 1 mM MgCl₂, and the anodic reservoir solution is composed of 200 mM ammonium acetate, 5 mM tris-HCl, and 1 mM MgCl₂.

Variation based on target analyte: In implementation, the selection and concentrations of electrolyte(s) may differ based on target analyte(s) to be separated/analyzed. For example, miRNA analyses use 800 mM glycine, and protein analyses use 100 mM glycine. Embodiments of miRNA analyses use 200 mM ammonium acetate, and embodiments of protein analyses use 10 mM ammonium acetate. Additional examples are provided herein, and can be selected by those of skill in the art.

Placement in device: LE and TE compositions may be optimized to maximize analyte enrichment, for instance until the band reaches approximately half-way to the detection point followed by an automatic initiation of the separation. The closest analogy of the sought behavior in the literature are reports of bidirectional ITP (Bahga et al., Anal. Chem., 83(16):6154-6162, 2011). Although the arrangement of electrolytes in the herein described injectionless gel electrophoresis system is inconsistent with bidirectional ITP, similar components are employed.

Additional options: Any anionic electrolytes that meet the following condition can be used:

μ_{TE}−<μ_{Analyte}<μ_{LE}−

where μ is mobility. This essentially means that the analyte would have an intermediate mobility between the LE and TE. Other examples of TE− that can be used include tricine, borate, HEPES, proline, and the like. Other examples of LE− that can be used include acetate and the like.

A high mobility electrolyte (LE+, e.g. ammonium) and a low mobility electrolyte (TE+, e.g. tris) are used to initiate the separation.

Variations in order to Provide Multiple Zones: As demonstrated in Example 3 (Two Anionic TEs . . . ), the electrophoretic systems described herein can be operated in a “zonal” mode, or a multi-zonal mode (given that typical operation may be considered a “single zone” mode) that enables separation of more analytes or analytes with otherwise “too crowded” migration characteristics. In the multi-zonal mode, the electrolyte solution used in the anodic reservoir, or in the cathodic reservoir, or both, includes more than one electrolyte with different mobility characteristics. The plurality of electrolytes is selected to allow formation of zones of separation through the analysis process; these zones are formed where the following conditions are met for the mobility of each member of the system: Analyte₁>TE−₁>Analyte₂>TE−₂ (for an exemplary two-zone anionic electrolyte system).

For instance, Examples 3 and 5 demonstrate that separation resolution increases in analyte separation (for instance, samples in which miRNA and/or proteins are being analyzed) when a second anionic TE is added into the cathodic reservoir. This second TE forms an additional zone in which analytes can separate after undergoing preconcentration. This two-TE approach (which is an example of a multi-zonal electrophoretic system) increases flexibility of the analysis by enabling high separation resolution between both higher mobility analytes and lower mobility analytes in a single analysis. This approach can be extended further by incorporating more electrolytes (e.g., tricine, proline, or the like) into the analysis, which further increases the flexibility of TGE to analyze samples of even higher complexity.

Proline can serve as a low-mobility anionic TE in the analysis of large proteins. Glycine can be used along with proline to resolve proteins of moderate mobility from proteins of low mobility in separate zones. In principle, a third anionic TE of higher mobility (e.g., tricine) can be added into the cathodic reservoir solution to form a third separation zone. Using three anionic TEs is expected to enhance resolution between analytes of high mobility, moderate mobility, and low mobility using the same TGE format as in previous examples. This approach can also extend to greater numbers of electrolytes, and is not limited to one or two anionic TEs.

TGE enables analyses to be readily customized based on the analytes in a sample mixture. Multiple TEs can be combined to accentuate resolution between sets of analytes that differ in mobilities. The number of separation zones needed for analyzing a given sample may be influenced the number of different analyte species present and their relative mobility differences.

In principle, similar customization can be attained by using additional cationic electrolytes in the anodic reservoir. Distinct cationic electrolyte zones will migrate counter to the direction of the analytes, which influences the separation resolution and preconcentration efficiency. Having the flexibility to adjust the electrolyte composition in one or both reservoirs and obtain superior analytical performance further expands the utility of TGE for biomolecular analyses.

### (V) Analytes for Analysis

Methods and systems described here may be used for preconcentrating and/or separating various types of analytes in a low-complexity analysis.

Type of analytes: Analytes for analysis include biomolecules. In implementations, the sample may include at least one of nucleic acids, carbohydrates, peptides, or proteins. In implementations, the sample may include two or more nucleic acid species, such as two or more miRNA species. In implementations, the sample may include a set of two or more probes, each with a different ssDNA overhang length, formulated for use as integrated drag tags. In implementations, fluorescent DNA probes may be designed to hybridize with each target miRNA. Single-stranded fluorescent DNA probes may be designed complementary in sequence to at least a portion of their target miRNA(s). Beneficially, selected probe sequences are screened to ensure that they will only bind to their intended target. Additional details of the sample are described throughout the present disclosure.

Another way to divide types of analytes is whether they are anionic (that is, having a negative net charge in the system) or cationic (having a positive net charge in the system). This is relevant in part because the configuration of the microfluidic device may be customized for analysis based on analyte charge. Where the analytes being concentrated and/or separated are anionic analytes, the migration of analytes is from the first reservoir (which is then a cathodic reservoir) to the second reservoir (which is then an anodic reservoir). Where the analytes being concentrated and/or separated are cationic analytes, the migration of analytes is from the first reservoir (which is then an anodic reservoir) to the second reservoir (which is then a cathodic reservoir).

Heterogeneity of Analyte Mixture: In implementations, the analyte mixture may include different types of molecules. In some embodiments, the analyte mixture may be from medical samples, environmental samples, laboratory samples, samples from human patients, animal subjects, etc. In some embodiments, the analyte mixture may contain a heterogenous collection of different analytes—that differ by size, shape, pH, or are made to differ in a characteristic that can be distinguished because of the addition of a label/drag tag.

In analyzing heterogenous analyte mixtures, it may be beneficial to operate the provided TGE systems using more than one zone of separation. Employing multiple zones (e.g., as described in Example 3) enables separation of target analytes with divergent mobility in the system, or mixtures that have mobilities that are overlapping when separated without using multi-zonal separation.

Concentration/volume: As an example, the sample-probe mixture was cast into thermal gel at a 1:9 ratio. As an example, the final samples contained 30% (w/v) PF-127 and 1 mM MgCl2 in 20 mM tris-HCl, with variable concentrations of miRNAs and 10 nM probes.

Labels or markers for types of analytes: In implementations, the sample may include a set of two or more probes, each with a different ssDNA overhang length, formulated for use as integrated drag tags. In implementations, fluorescent DNA probes may be designed to hybridize with each target miRNA. Single-stranded fluorescent DNA probes may be designed complementary in sequence to at least a portion of their target miRNA(s). Beneficially, selected probe sequences are screened to ensure that they will only bind to their intended target. Sequences of example probes are shown in Table 1 (below).

In some examples, the analyte may include carbohydrates, peptides, or proteins. For the analyte that includes carbohydrates, peptides, or proteins, probes may not be needed.

### (VI) Loading of Microfluidic Device

It is a benefit of provided embodiments that the microfluidic device does not require any specialized type of loading system (such as injection), and instead the analyte-containing sample is simply loaded throughout a single microfluidic channel the microfluidic device. No sample injection is needed to begin the analysis, unlike standard analytical methods.

Immobilization composition (Thermal gel and other types of immobilizer): In some examples, a thermal gel is used that is liquid at cool temperatures. The microfluidic device is placed in a cold environment (e.g., on an ice bath, in a cold room) to keep the gel liquid. A drop of gel is placed in the first reservoir. The gel is loaded into the channel by applying vacuum at the second reservoir, applying pressure at the first reservoir, allowing capillary action to transport the gel from the reservoir into the channel, or some combination of two or more thereof. Once the channel is filled, excess gel is removed from the reservoirs. The device is then removed from the cold environment, which causes the gel to solidify. The analytes and electrolytes are now immobilized in the solid gel throughout the entirety of the channel. Cathodic and anodic reservoir solutions are then added to the first and the second reservoirs, respectively. Then, the device is ready to be operated (i.e., apply voltage, detect analytes, etc.).

As described herein, thermal gels can be used during the process of injectionless TGE. Thermal gels have been previously reported to help filter miRNAs from other nucleic acids (Schoch et al., Lab Chip, 9(15):2145-2152, 2009; Han et al., Lab Chip, 19(16):2741-2749, 2019). Example thermal gels include Pluronic F-127 (aka Poloxamer 407), Pluronic F-68, dimyristoyl-sn-glycero-3-phosphocholine, 1,2-dihexanoyl-sn-glycero-3-phosphocholine, poly(N-isopropylacrylamide)-g-poly(ethyleneoxide), N,N′-dimethylacrylamide (DMA) and N,N′-diethylacrylamide (DEA), N-ethoxyethylacrylamide (NEEA) and N-methoxyethylacrylamide (NMEA). The present disclosure is not limited thereto. Other gels, such as matrices for capillary gel electrophoresis (Miksík et al., Biomed. Chromatogr. 20:458-465, 2006), polymer sieving matrices (Chung et al., The Royal Society of Chem., 139:5635-5654, 2014), and the like may be used.

Mixing sample: In some embodiments, the stock sample was prepared containing mixtures of the miRNAs and probes. Sample was directly cast into gel and non-selectively loaded throughout the entirety of a single-channel microfluidic device, which increased user-friendliness. As an example, the sample-probe mixture was cast into gel at a 1:9 ratio. As an example, the final samples contained 30% (w/v) PF-127 and 1 mM MgCl₂ in 20 mM tris-HCl, with variable concentrations of miRNAs and 10 nM probes.

Buffer inclusion: Buffers in gel electrophoresis are used to provide ions that carry a current and to maintain the pH at a relatively constant value. Buffer can be included in the gel. In an example, the buffer is tris-HCl.

Solidification of sample into channel: In embodiments in which a thermal gel that is liquid at cool temperatures is used, all solutions are prepared and stored on ice prior to analysis. After loading the analyte-containing composition into the microfluidic device, the gel is then solidified in place by warming the device (e.g. 25° C.). This effectively immobilizes the sample analytes and electrolytes in place, and may provide a sieving matrix.

### (VII) Devices in Operation

Devices as described herein can operate to conduct the injectionless gel electrophoresis, to analyze various types of analytes. The following provides representative description of various aspects of devices in operation.

Power source: Gel electrophoresis as used herein generally operates with simplified hardware requirements (e.g., there is no need for a second power supply nor timing actuator) to reduce cost of the system and increase ease of operation (for instance, in comparison to MCE). As an example, the power may be 0.2 Watt. In exemplary embodiments, a four-channel high voltage power supply (Advanced Energy, Ronkonkoma, NY) was used to apply an electric field across the microfluidic channel.

Buffer maintenance: Buffers in gel electrophoresis are used to provide ions that carry a current and to maintain the pH at a relatively constant value. Buffer can be included in the gel.

Voltage application: Electrophoresis voltage is applied across the device via the electrodes using a high-voltage power supply. For example, the voltage applied may be ±1 kV for the standard channel device, and ±2 kV for the tapered channel device. In embodiments, −1 kV was applied for instance for analysis of anionic analytes. In embodiments analyzing cationic analytes, a positive voltage (e.g., +1 kV) is used. As an example, the power may be less than 0.2 Watt.

Timing: As described herein, TGE operates with simplified hardware requirements (e.g. no second power supply nor timing actuator) to reduce cost of the system and increase ease of operation versus MCE.

Temperatures: As described herein, miRNAs and probes (Table 1) were reconstituted in 1× IDTE and stored at −20° C. Thermal gel stock solution was prepared by dissolving 33.3% (w/v) Pluronic F-127 in 20 mM tris-HCl at 4° C. to maintain the gel in a liquid state. TGE employs a thermally responsive polymer that changes viscosity in response to temperature (Durney et al., Anal. Chem., 85(14):6617-6625, 2013). Sample is cast directly into liquid-phase thermal gel (e.g. 10° C.) for facile loading into microfluidic channels (Burton et al., Anal. Methods, 11(37):4733-4740, 2019). The gel is then solidified by warming the device (e.g. 25° C.) to immobilize the sample and electrolytes in place and to provide a sieving matrix. Filled devices were placed on an AZ100 epifluorescent microscope (Nikon Instruments Inc., Melville, NY) and allowed to equilibrate at 25° C. for 2 min on a temperature-controlled stage.

In embodiments, the sample analysis is carried out at a temperature between 5° C. and 65° C., for instance at 5° C., 10° C., 15° C., 20° C., 25° C., 30° C., 35° C., 40° C., 45° C., 50° C., 55° C., 60° C., 65° C., or higher; or at any individual temperature in the range of 5° C. to 65° C. In general, a system can be said to be operated at “high” temperature when it is operated at 45° C. or higher, such as is exemplified in Example 4.

### (VIII) System Readout/Detection

The system may have readouts and detection results for different purpose such as clinical and pharmaceutical purpose.

Camera/detector: In some embodiments, images are acquired during analysis, for instance using an ORCA Fusion sCMOS camera (Hamamatsu Corp., Bridgewater, NJ) with 150 ms exposure times. Excitation light was produced in exemplary embodiments using by a SOLA Light Engine (Lumencor, Beaverton, OR) with a Texas Red filter cube (560/630 nm) at an intensity of 5 mW/mm², though other systems may be used and the appropriate filter(s) selected based on the label(s) being detected. A movable stage (exemplified by those available from Prior Scientific, Rockland, MA) may be used to track analyte migration. μManager software or equivalent is used to control all hardware and trigger image acquisition (Edelstein et al., Curr. Protoc. Mol. Biol., 92(1):14.20.1-14.20.17., 2010).

Computer system: Methods and processes described herein may be implemented by a computer system. Computer-executable instructions stored on one or more computer-readable storage media, when executed by the computer system, cause the computer system to perform the recited operations. Generally, computer-executable instructions include routines, programs, objects, components, data structures, and the like that perform particular functions or implement particular abstract data types. Those having ordinary skills in the art will readily recognize that certain steps or operations illustrated in the figures above may be eliminated, combined, or performed in an alternate order. Any steps or operations may be performed serially or in parallel (unless the context requires one or the other). Furthermore, the order in which the operations are described is not intended to be construed as a limitation.

Images: A magnification of 4.8× was used to track bands in standard channel devices, while 0.9× magnification was used for tapered channel devices. These zoomed out images allowed all analyte bands to be visualized in a single frame. Electropherograms were generated for both device designs using a zoomed in 9.6× magnification. The detection points for standard and tapered devices were 25 mm and 40 mm, respectively. Fluorescence was integrated across the entire channel width in standard channel devices. Fluorescence was only integrated across the bottom quarter of the channel in tapered channel devices to only include the area where analyte nodules migrated. Peak areas and separation resolutions were calculated from electropherograms using Chromophoreasy software (Vaz et al., J. Brazil Chem. Soc., 27:1899-1911, 2016). Error bars presented in all figures represent ±1 standard deviation from n=4 replicate analyses.

### (IX) Automated Operation using a Computer System

As described herein, the inline enrichment and separation afforded by TGE eliminated the need for sample injections. Sample was directly cast into the gel and non-selectively loaded throughout the entirety of a single-channel microfluidic device, which increased user-friendliness. High detection sensitivity and separation resolution were achieved automatically without requiring user intervention to switch between enrichment and separation modes.

In some embodiments, results demonstrate that TGE provides a simple, inexpensive means of conducting multiplexed miRNA measurements with the potential for automation to facilitate future clinical and pharmaceutical analyses.

The methods and devices described herein can be used for automated analysis of biomolecules, exemplified herein with miRNA. Applications for the herein described methods and devices include separating, detecting, and/or measuring biomarkers (more generally, analytes) for clinical diagnostics and performing quality control analyses of pharmaceutical formulations.

Further, the processes discussed herein may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skills in the art will readily recognize that certain steps or operations illustrated in the figures above may be eliminated, combined, or performed in an alternate order. Any steps or operations may be performed serially or in parallel (unless the context requires one or the other). Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic devices) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program can be configured to access, including signals transferred by one or more networks. For example, the transitory machine-readable signal may include the transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skills in the art.

### (X) Kits

The systems and methods disclosed herein can be employed using kits. Disclosed kits include materials and reagents necessary to assay a sample obtained from a subject for diagnosis and/or detection of biomarkers for diagnosing pathologies including cancers (Cheng, Adv. Drug Deliver. Rev., 81:75-93, 2015; Ban, J. Chromatogr. A, 1315:195-199, 2013), cardiovascular diseases (Zhu & Fan, Am. J. Cardiovasc. Dis., 1:138-149, 2011; Creemers et al., Circ. Res., 110(3):483-495, 2012), and neurodegenerative disorders (Femminella et al., Front. Physiol., 6, 2015; Sheinerman & Umansky, Front. Cell. Neurosci., 7:150-150, 2013; Du & Pertsemlidis, J. Mol. Cell Biol., 3:176-180, 2011), quality control for pharmaceuticals, validating biological research samples, etc. In particular embodiments, the kit includes at least one of: (1) one or more probes, such as (fluorescent) detection probes for target analyte(s) (e.g., probes that hybridize to target miRNAs); (2) a gel or mixture of gels, such as Pluronic F-127 (aka Poloxamer 407), Pluronic F-68, dimyristoyl-sn-glycero-3-phosphocholine, 1,2-dihexanoyl-sn-glycero-3-phosphocholine, poly(N-isopropylacrylamide)-g-poly(ethylene-oxide), N,N′-dimethylacrylamide (DMA) and N,N′-diethylacrylamide (DEA), N-ethoxyethylacrylamide (NEEA) and N-methoxyethylacrylamide (NMEA), matrices for capillary gel electrophoresis (Miksík et al., Biomed. Chromatogr. 20:458-465, 2006), polymer sieving matrices (Chung et al., The Royal Society of Chem., 139:5635-5654, 2014), and the like; (3) microfluidic device(s) such as straight-sided channels (standard channels) devices and tapered channel devices as described herein; (4) one or more cathodic reservoir electrolytes (such as glycine, tris-HCl, and/or MgCl₂, or other electrolytes as provided herein, for the analysis of anionic analytes), optionally in solution; (5) one or more anodic reservoir electrolytes (such as ammonium acetate, tris-HCl, and/or MgCl₂, or other electrolytes as provided herein, for the analysis of anionic analytes), optionally in solution; and/or (6) buffers, e.g., IDTE buffer (10 mM Tris, 0.1 mM ethylenediaminetetraacetic acid, pH 7.5). The same electrolytes can be used for analysis of either anionic or cationic analytes; however, the placement in reservoirs is reversed for analysis of cationic analytes. One of ordinary skill in electrophoresis and related systems will understand that additional electrolytes can be used in the described systems and methods, and will understand how to select an electrolyte or combination of different electrolyte species based on their mobility characteristics in order to facilitate analyte separation based on the teachings herein.

Components of the kits can be packaged in aqueous media or in lyophilized form. The container means of the kits can include at least one vial, test tube, flask, bottle, syringe or other container means, into which a component may be placed, and preferably, suitably aliquoted. Where there is more than one component in the kit, the kit can include a second, third or other additional container into which the additional components may be separately placed. The kits may also include a second container means for containing a sterile, pharmaceutically acceptable buffer and/or other diluent. In particular embodiments, various combinations of components may be included in a vial.

The kit may include instructions for employing the kit components as well the use of any other reagent not included in the kit. Instructions may include variations that can be implemented.

The Exemplary Embodiments and Example(s) below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### (XI) Exemplary Embodiments

In the first set of exemplary embodiments:
1. A method of injectionless gel electrophoresis, including: loading a mixed analyte sample mixed with a gel solution into a channel of a microfluidic device, the channel having a first end and a second end, the microfluidic device having a first reservoir coupled to the first end of the channel and a second reservoir coupled to the second end of the channel; providing a first reservoir solution in the first reservoir; providing a second reservoir solution in the second reservoir; and applying an electric field across the microfluidic device.
2. The method of embodiment 1, or any of the other embodiments, wherein the microfluidic device further includes a first electrode arranged in the first reservoir and a second electrode arranged in the second reservoir.
3. The method of embodiment 2, or any of the other embodiments, wherein method includes anionic analytes migrating from the first reservoir to the second reservoir, and: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
4. The method of embodiment 2, or any of the other embodiments, wherein method includes cationic analytes migrating from the first reservoir to the second reservoir, and: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.
5. The method of any one of embodiments 1-4, or any of the other embodiments, wherein the sample includes biomolecules.
6. The method of any one of embodiments 1-4, or any of the other embodiments, wherein the sample includes at least one of nucleic acids, carbohydrates, peptides, or proteins.
7. The method of any one of embodiments 1-4, wherein the sample includes two or more miRNA species.
8. The method of any one of embodiments 1-4, wherein the mixed analyte sample includes at least two different nucleic acid molecule analytes, the sample further including a set of two or more probes, each probe including a different ssDNA overhang length, formulated for use as integrated drag tags.
9. The method of any one of embodiments 1-4, or any of the other embodiments, further including solidifying the gel solution.
10. The method of any one of embodiments 1-4, or any of the other embodiments, wherein the gel is configured to suppress an electroosmotic flow (EOF) in the channel.
11. The method of any one of embodiments 1-4, or any of the other embodiments, wherein the gel is a sieving gel for resolving the sample.
12. The method of any one of embodiments 1-4, or any of the other embodiments, wherein the gel is configured to suppress a current runaway in the channel.
13. The method of any one of embodiments 1-4, or any of the other embodiments, wherein the gel is thermally responsive.
14. The method of any one of embodiments 1-4, or any of the other embodiments, further involving including buffer in the gel solution and/or the mixed analyte sample.
15. The method of any one of embodiments 1-4, or any of the other embodiments, further including detecting separation of analytes of the mixed analyte sample in the channel.
16. The method of any one of embodiments 1-4, or any of the other embodiments, including applying the electric field across the microfluidic device as an asymmetric electric field.
17. The method of embodiment 16, or any of the other embodiments, wherein applying the asymmetric electric field across the microfluidic device includes applying the asymmetric electric field with the first electrode and/or second electrode arranged at an offset position relative to the first reservoir and/or the second reservoir.
18. The method of any one of embodiments 1-4, or any of the other embodiments, wherein the channel has a tapered geometry.
19. The method of any one of embodiments 1-4, or any of the other embodiments, wherein an opening is arranged at the first end of the channel.
10. The method of any one of embodiments 1-4, or any of the other embodiments, wherein the cathodic reservoir solution includes glycine, tris-HCl, and/or MgCl₂.
21. The method of any one of embodiments 1-4, or any of the other embodiments, wherein the anodic reservoir solution includes ammonium acetate, tris-HCl, and/or MgCl₂.
22. A microfluidic device, including: a channel, configured to accommodate a mixed analyte sample mixed with a gel solution, the channel having a first end and a second end; a first reservoir coupled to the first end of the channel, the first reservoir being configured to accommodate a first reservoir solution; a second reservoir coupled to the second of the channel, the second reservoir being configured to accommodate a second reservoir solution; a first electrode arranged in the first reservoir; and a second electrode arranged in the second reservoir; wherein the first electrode and the second electrode are configured to apply an electric field across the microfluidic device.
23. The device of embodiment 22, or any of the other embodiments, wherein device is configured for anionic analytes to migrate from the first reservoir to the second reservoir, and: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
24. The device of embodiment 22, or any of the other embodiments, wherein the device is configured for cationic analytes to migrate from the first reservoir to the second reservoir, and: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.
25. The device of any one of embodiments 22-24, or any of the other embodiments, wherein the sample includes at least one of nucleic acids, carbohydrates, peptides, or proteins.
26. The device of any one of embodiments 22-24, or any of the other embodiments, wherein the sample includes two or more miRNA species.
27. The device of any one of embodiments 22-24, or any of the other embodiments, wherein the mixed analyte sample includes at least two different nucleic acid molecule analytes, the sample further including a set of two or more probes, each probe including a different ssDNA overhang length, formulated for use as integrated drag tags.
28. The device of any one of embodiments 22-24, or any of the other embodiments wherein the first electrode is arranged at an offset position.
29. The device of any one of embodiments 22-24, or any of the other embodiments, wherein the gel is configured to suppress an electroosmotic flow (EOF) in the channel.
30. The device of any one of embodiments 22-24, or any of the other embodiments, wherein the gel is a sieving gel for resolving the sample.
31. The device of any one of embodiments 22-24, or any of the other embodiments, wherein the gel is configured to suppress a current runaway in the channel.
32. The device of any one of embodiments 22-24, or any of the other embodiments, wherein the gel is thermally responsive.
33. The device of any one of embodiments 22-24, or any of the other embodiments, wherein the channel has a tapered geometry.
34. The device of any one of embodiments 22-24, or any of the other embodiments, wherein an opening is arranged between the first reservoir and the channel.
35. The device of any one of embodiments 22-24, or any of the other embodiments, wherein the cathodic reservoir solution includes glycine, tris-HCl, and/or MgCl₂.
36. The device of any one of embodiments 22-24, or any of the other embodiments, wherein the anodic reservoir solution includes ammonium acetate, tris-HCl, and/or MgCl₂.
37. The device of any one of embodiments 22-24, or any of the other embodiments, wherein the electric field across the microfluidic device is an asymmetric electric field.
38. A computer-readable medium storing computer-readable instructions executable by one or more processors, that when executed by the one or more processors, causes the one or more processors to perform acts including: loading a mixed analyte sample mixed with a gel solution into a channel of a microfluidic device, the channel having a first end and a second end, the microfluidic device having a first reservoir coupled to the first end of the channel and a second reservoir coupled to the second end of the channel; providing a first reservoir solution in the first reservoir; providing a second reservoir solution in the second reservoir; and applying an electric field across the microfluidic device.
39. The computer-readable medium of embodiment 38, or any of the other embodiments, wherein: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
40. The computer-readable medium of embodiment 38, or any of the other embodiments, wherein: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.
41. A method of improving analyte separation in a gel electrophoresis, including applying an asymmetric electric field using an offset electrode position.
42. A method of inline preconcentration and separation of analytes, substantially as disclosed herein.
43. A microfluidic device with a tapered channel geometry, substantially as disclosed herein.
44. Use of a microfluidic device with a tapered channel geometry to separate analytes from a mixture, substantially as disclosed herein.
45. Use of probes having variable ssDNA overhang lengths as integrated drag tags in an electrophoresis analysis system, substantially as disclosed herein.
46. Use of ssDNA overhangs as integrated drag tags for differentiating nucleic acid targets in a mixed sample.
47. A set of two or more probes, each with a different ssDNA overhang length, formulated for use as integrated drag tags in an electrophoresis analysis system, substantially as disclosed herein.
48. An analyte separation strategy based on gel electrophoresis, substantially as disclosed herein.
49. A method for separating two or more miRNA species in a mixed sample, the method including injectionless gel electrophoresis substantially as described herein.

In the second set of exemplary embodiments:
1. A method of injectionless gel electrophoresis, including: loading a mixed analyte sample mixed with a gel solution into a channel of a microfluidic device, the channel having a first end and a second end, the microfluidic device having a first reservoir coupled to the first end of the channel and a second reservoir coupled to the second end of the channel; providing a first reservoir solution in the first reservoir; providing a second reservoir solution in the second reservoir; and applying an electric field across the microfluidic device.
2. The method of embodiment 1, or any other method embodiment, wherein the first reservoir solution includes a first electrolyte and the second reservoir solution includes a second electrolyte
3. The method of embodiment 1, or any other method embodiment, wherein the microfluidic device further includes a first electrode arranged in the first reservoir and a second electrode arranged in the second reservoir.
4. The method of embodiment 3, or any other method embodiment, wherein method includes anionic analytes migrating from the first reservoir to the second reservoir, and: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
5. The method of embodiment 3, or any other method embodiment, wherein method includes cationic analytes migrating from the first reservoir to the second reservoir, and: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.
6. The method of embodiment 1, or any other method embodiment, wherein the sample includes biomolecules.
7. The method of embodiment 1, or any other method embodiment, wherein the sample includes at least one of nucleic acids, carbohydrates, peptides, or proteins.
8. The method of embodiment 1, or any other method embodiment, wherein the sample includes two or more miRNA species.
9. The method of embodiment 1, or any other method embodiment, wherein the mixed analyte sample includes at least two different nucleic acid molecule analytes, the sample further including a set of two or more probes, each probe including a different ssDNA overhang length, formulated for use as integrated drag tags.
10. The method of embodiment 1, or any other method embodiment, further including solidifying the gel solution.
11. The method of embodiment 1, or any other method embodiment, wherein the gel is configured to suppress an electroosmotic flow (EOF) in the channel.
12. The method of embodiment 1, or any other method embodiment, wherein the gel is a sieving gel for resolving the sample.
13. The method of embodiment 1, or any other method embodiment, wherein the gel is configured to suppress a current runaway in the channel.
14. The method of embodiment 1, or any other method embodiment, wherein the gel is thermally responsive.
15. The method of embodiment 1, or any other method embodiment, further involving including buffer in the gel solution and/or the mixed analyte sample.
16. The method of embodiment 1, or any other method embodiment, further including detecting separation of analytes of the mixed analyte sample in the channel.
17. The method of embodiment 1, or any other method embodiment, including applying the electric field across the microfluidic device as an asymmetric electric field.
18. The method of embodiment 17, or any other method embodiment, wherein applying the asymmetric electric field across the microfluidic device includes applying the asymmetric electric field with the first electrode and/or second electrode arranged at an offset position relative to the first reservoir and/or the second reservoir.
19. The method of embodiment 1, or any other method embodiment, wherein the channel has a tapered geometry.
20. The method of embodiment 1, or any other method embodiment, wherein an opening is arranged at the first end of the channel.
21. The method of embodiment 2, or any other method embodiment, wherein at least the first electrolyte or at least the second electrolyte is glycine, tricine, proline, borate, HEPES, Tris-HCl, MgCl₂, ammonium acetate, ammonium chloride, sodium acetate, NaCN, NaCl, Bis-tris methane, or Bis-tris propane.
22. The method of embodiment 3 or embodiment 4, or any other method embodiment, wherein the cathodic reservoir solution includes at least one of glycine, ammonium acetate, Tris-HCl, MgCl₂, ammonium chloride, sodium acetate, NaCN, and/or NaCl.
23. The method of embodiment 3 or embodiment 4, or any other method embodiment, wherein the anodic reservoir solution includes at least one of tricine, proline, borate, ammonium acetate, Tris-HCl, MgCl₂, ammonium chloride, sodium acetate, NaCN, and/or NaCl.
24. The method of embodiment 2, or any other method embodiment, wherein the first reservoir solution includes at least two different electrolyte species, the second reservoir solution includes at least two different electrolyte species, or both the first reservoir solution and the second reservoir solution include at least two different electrolyte species.
25. The method of embodiment 24, or any other method embodiment, wherein the at least two different electrolyte species include glycine and tricine, glycine and borate, or glycine and proline.
26. The method of embodiment 1, or any other method embodiment, wherein applying the electric field across the microfluidic device includes applying the electric field across the microfluidic device at a voltage of: −10 kV to +10 kV; −8 kV to +8 kV; −5 kV to +5 kV; −3 kV to +3 kV; −2 kV to +2 kV; −1.5 kV to +1.5 kV; −1.0 kV to +1.0 kV; −0.5 kV to −0.5 kV; −0.25 kV to −0.25 kV; 1 kV to 2 kV; 1.5 kV to 2 kV; 0.5 kV to 1.5 kV; 0.5 kV to 2 kV; 0.5 kV to 1 kV; −1 kV to −2 kV; −1.5 kV to −2 kV; −0.5 kV to −1.5 kV; −0.5 to −2 kV; or −0.5 kV to −1 kV.
27. The method of embodiment 1, or any other method embodiment, wherein applying the electric field across the microfluidic device occurs at a temperature of between 5° C. and 60 ° C.
28. The method of embodiment 27, wherein the microfluidic device is maintained at a temperature of between 45° C. and 60° C.
29. The method of embodiment 6, or any other method embodiment, wherein the sample includes at least one biomolecule that occurs in two or more different conformations each of which has a different electrophoretic mobility.
30. The method of embodiment 29, or any other method embodiment, wherein the method separates two or more different conformational forms of a protein.
31. A microfluidic device, including: a channel, configured to accommodate a mixed analyte sample mixed with a gel solution, the channel having a first end and a second end; a first reservoir coupled to the first end of the channel, the first reservoir being configured to accommodate a first reservoir solution; a second reservoir coupled to the second of the channel, the second reservoir being configured to accommodate a second reservoir solution; a first electrode arranged in the first reservoir; and a second electrode arranged in the second reservoir; wherein the first electrode and the second electrode are configured to apply an electric field across the microfluidic device.
32. The device of embodiment 31, or any other device embodiment, wherein device is configured for anionic analytes to migrate from the first reservoir to the second reservoir, and: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
33. The device of embodiment 31, wherein the device is configured for cationic analytes to migrate from the first reservoir to the second reservoir, and: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.
34. The device of embodiment 31, or any other device embodiment, wherein the sample includes at least one of nucleic acids, carbohydrates, peptides, or proteins.
35. The device of embodiment 31, or any other device embodiment, wherein the sample includes two or more miRNA species.
36. The device of embodiment 31, or any other device embodiment, wherein the mixed analyte sample includes at least two different nucleic acid molecule analytes, the sample further including a set of two or more probes, each probe including a different ssDNA overhang length, formulated for use as integrated drag tags.
37. The device of embodiment 31, or any other device embodiment, wherein the first electrode is arranged at an offset position.
38. The device of embodiment 31, or any other device embodiment, wherein the gel is configured to suppress an electroosmotic flow (EOF) in the channel.
39. The device of embodiment 31, or any other device embodiment, wherein the gel is a sieving gel for resolving the sample.
40. The device of embodiment 31, or any other device embodiment, wherein the gel is configured to suppress a current runaway in the channel.
41. The device of embodiment 31, or any other device embodiment, wherein the gel is thermally responsive.
42. The device of embodiment 31, or any other device embodiment, or any other device embodiment, wherein the channel has a tapered geometry.
43. The device of embodiment 31, or any other device embodiment, wherein an opening is arranged between the first reservoir and the channel.
44. The device of embodiment 31, or any other device embodiment, wherein the cathodic reservoir solution includes glycine, tris-HCl, and/or MgCl₂.
45. The device of embodiment 31, or any other device embodiment, wherein the anodic reservoir solution includes ammonium acetate, tris-HCl, and/or MgCl₂.
46. The device of embodiment 31, or any other device embodiment, wherein the electric field across the microfluidic device is an asymmetric electric field.
47. A computer-readable medium storing computer-readable instructions executable by one or more processors, that when executed by the one or more processors, causes the one or more processors to perform acts including: loading a mixed analyte sample mixed with a gel solution into a channel of a microfluidic device, the channel having a first end and a second end, the microfluidic device having a first reservoir coupled to the first end of the channel and a second reservoir coupled to the second end of the channel; providing a first reservoir solution in the first reservoir; providing a second reservoir solution in the second reservoir; and applying an electric field across the microfluidic device.
48. The computer-readable medium of embodiment 47, wherein: the first electrode is a cathodic electrode; the first reservoir solution is a cathodic reservoir solution; the first reservoir is a cathodic reservoir; the second electrode is an anodic electrode; the second reservoir solution is an anodic reservoir solution; and the second reservoir is an anodic reservoir.
49. The computer-readable medium of embodiment 47 or 48, wherein: the first electrode is an anodic electrode; the first reservoir solution is an anodic reservoir solution; the first reservoir is an anodic reservoir; the second electrode is a cathodic electrode; the second reservoir solution is a cathodic reservoir solution; and the second reservoir is a cathodic reservoir.

While the example embodiments above are described with respect to particular implementations, it will be understood that, in the context of this document, the content of the example embodiments may also be implemented via a method, device, system, computer-readable medium, and/or another implementation. Additionally, any of embodiments 1-49 (in either the first or the second set) may be implemented alone or in combination with any other one or more of the embodiments 1-49 (in either the first or the second set).

### (XII) Examples

### Example 1: Multiplexed miRNA Quantitation Using Injectionless Microfluidic Thermal Gel Electrophoresis

MicroRNAs (miRNAs) are a class of biomolecules that have high clinical and pharmaceutical significance because of their ability to regulate protein expression. Better methods are needed to quantify target miRNAs, but their similar sequence lengths (˜22 nt) and low concentrations in biomedical samples impede analysis. This example describes development of a simple, rapid method to directly quantify multiple miRNAs using microfluidic thermal gel electrophoresis (TGE).

Fluorescent probes were designed complementary in sequence to four target miRNAs that also contained variable DNA overhangs to alter their electrophoretic mobilities. Samples and probes were directly added into thermal gel and loaded throughout a microchannel. Applying voltage resulted in an inline preconcentration and separation of the miRNAs that did not require a sample injection nor user intervention to switch between modes. Baseline resolution was achieved between four double-stranded miRNA-probe hybrids and four excess single-stranded probes.

Analytical performance was then improved by designing an innovative microfluidic device with a tapered channel geometry. This device exhibited superior detection limits and separation resolution than standard channel devices, without increasing the complexity of microfabrication or device operation.

A proof-of-concept demonstration was then performed showing that target miRNAs could be detected from cell extracts. These results demonstrate that TGE provides a simple, inexpensive means of conducting multiplexed miRNA measurements with the potential for automation to facilitate future clinical and pharmaceutical analyses.

At least some of the information described in this Example was published online on Mar. 29, 2022, as Cornejo & Linz, Analytical Chemistry, 19(14):5674-5681, 2022.

### INTRODUCTION

MicroRNAs (miRNAs) are short (18-23 nucleotides) non-coding sequences of RNA that regulate gene expression (Iwakawa & Tomari, Trends Cell Biol., 25:651-665, 2015; Fromm et al., Annu. Rev. Genet., 49(1):213-242, 2015). The hybridization of a miRNA to a segment of messenger RNA prevents the coded protein from being translated, consequently impacting cellular behavior. Precise regulation of miRNAs is required for an organism to maintain proper physiological function, as aberrant expression can cause pathogenesis. Numerous miRNAs have recently emerged as biomarkers for diagnosing pathologies including cancers (Cheng, Adv. Drug Deliver. Rev., 81:75-93, 2015; Ban, J. Chromatogr. A, 1315:195-199, 2013), cardiovascular diseases (Zhu & Fan, Am. J. Cardiovasc. Dis., 1:138-149, 2011; Creemers et al., Circ. Res., 110(3):483-495, 2012), and neurodegenerative disorders (Femminella et al., Front. Physiol., 6, 2015; Sheinerman & Umansky, Front. Cell. Neurosci., 7:150-150, 2013; Du & Pertsemlidis, J. Mol. Cell Biol., 3:176-180, 2011). Development of diagnostic panels to quantify miRNA markers from clinical samples could serve to diagnose diseases at early stages when treatment is more effective and long-term patient prognoses are higher. Additionally, miRNAs have shown promise as therapeutics to treat numerous pathologies (Rupaimoole & Slack, Nat. Rev. Drug Discov., 16(3):203-222, 2017; Hanna et al., Front. Genet., 10(478), 2019). Accurate measurements of miRNAs in pharmaceutical formulations and pharmacokinetics studies are needed to support pharmaceutical development. The high clinical and pharmaceutical potential of miRNAs demonstrates the need for a low-cost analysis capable of detecting multiple low-abundance species, which presents a formidable analytical challenge.

Common techniques to measure miRNAs include next-generation sequencing and reverse transcription quantitative PCR (RT-qPCR) (Balcells et al., BMC Biotechnol., 11(1):70, 2011; Chen et al., BMC Genomics, 10(1):407, 2009). Although these techniques provide high-sensitivity analyses, they suffer from high cost and potential amplification biases (Wang et al., TrAC—Trend. Anal. Chem., 117:242-262, 2019). Direct analyses of miRNAs in inexpensive platforms are needed for routine analyses. Electrochemical sensors have been developed that meet these criteria (Masud et al., Trends Biochem. Sci., 44(5):433-452, 2019; Liu et al., Sensor. Actuat. B-Chem., 208:137-142, 2015), but these methods are typically limited to measuring a single miRNA. To maximize diagnostic accuracy, however, multiple biomarkers must be measured in parallel from a single sample.

Separation techniques are ideal for selectively analyzing multiple species within complex samples. Microchip electrophoresis (MCE) is particularly well-suited as it affords rapid analyte quantitation in miniaturized, low-cost microfluidic devices (Wei et al., Talanta, 189: 437-441, 2018; Yamamura et al., Sensors, 12(6):7576-7586, 2012). However, electrophoresis cannot resolve miRNAs because of the similar size and charge between species. This problem can be overcome, though, by integrating variable “drag tags” into fluorescent detection probes that hybridize to target miRNAs. Previous studies using capillary electrophoresis incorporated drag tags composed of proteins, peptide nucleic acids, or polymers onto probes to alter analyte mobilities to different degrees and enable their separation (Meagher et al., Anal. Chem., 80(8):2842-2848, 2008; Wegman et al., Anal. Chem., 87(2):1404-1410, 2015; Hu et al., Anal. Chem., 90(24):14610-14615, 2018; Wegman et al., Anal. Chem., 85(13):6518-6523, 2013). Although the cost and analytical complexity of previous reports are relatively high, adapting these sensitive miRNA analyses into a less costly, more user-friendly approach would benefit the numerous applications that require amplification-free multiplexed miRNA quantitation.

Microfluidic thermal gel electrophoresis (TGE) has the potential to efficiently analyze miRNAs in a simplistic manner. Unlike MCE—which requires directing multiple fluid streams with multiple high voltage power supplies and precise timing to actuate reproducible sample injections—TGE affords a simplified setup. TGE employs a thermally responsive polymer that changes viscosity in response to temperature (Durney et al., Anal. Chem., 85(14):6617-6625, 2013). Sample is cast directly into liquid-phase thermal gel (e.g. 10° C.) for facile loading into microfluidic channels (Burton et al., Anal. Methods, 11(37):4733-4740, 2019). The gel is then solidified by warming the device (e.g. 25° C.) to lock the sample and electrolytes in place and to provide a sieving matrix. Voltage is then applied where an inline preconcentration and separation occur without requiring user intervention.

This group has shown that TGE provides>100-fold analyte preconcentration and high separation resolution sufficient to resolve protein isoforms—all while requiring only minimal user steps and hardware requirements (Peli Thanthri et al., Anal. Chem., 92(9):6741-6747, 2020). The hybrid isotachophoresis (ITP) and electrophoresis capabilities of TGE can be adapted for a user-friendly analysis of miRNAs. Thermal gels have been previously reported to help filter miRNAs from other nucleic acids (Schoch et al., Lab Chip, 9(15):2145-2152, 2009; Han et al., Lab Chip, 19(16):2741-2749, 2019). The methods and devices described herein significantly expand upon this capability to enrich and separate distinct miRNA targets within solidified thermal gel.

This Example reports the development of TGE to selectively quantify target miRNAs in a low-complexity analysis. Four miRNAs were selected for this proof-of-concept study that has been identified as potential biomarkers of breast cancer. Fluorescent DNA probes were designed to hybridize with each target miRNA. Probes possessed variable DNA overhang lengths to serve as integrated, low-cost drag tags. Initial TGE studies demonstrated an inline preconcentration and separation that resolved double-stranded miRNA-probe hybrid from excess single-stranded probe. This approach was then translated to a four-plex miRNA analyses. Baseline resolution was achieved between the four miRNA-probe hybrids and four probes due to the differing lengths of overhang DNA on each probe.

An innovative microfluidic device was then designed to further improve detection sensitivity and separation resolution. A tapered channel was created to confine analytes into bands that progressively migrated into regions of higher electric fields. This novel device design significantly improved limits of detection and separation resolution, compared to a standard microfluidic channel. Cell extracts were then analyzed with this tapered device to demonstrate proof-of-concept detection of endogenous miRNAs.

The novel separation strategy and microfluidic device design reported here establish that TGE provides a simple, low-cost method for direct miRNA analyses with potential for future applications analyzing clinical and pharmaceutical samples.

### MATERIALS AND METHODS

Reagents miRNAs, DNA probes labeled with AlexaFluor 594, and IDTE buffer (10 mM Tris, 0.1 mM ethylenediaminetetraacetic acid, pH 7.5) were purchased from Integrated DNA Technologies (Coralville, IA). miRNAs and probes (Table 1) were reconstituted in 1×IDTE and stored at −20° C. Pluronic F-127 (PF-127), magnesium chloride, ammonium acetate, and rhodamine 6G were obtained from Millipore Sigma (Burlington, MA). Tris-HCl and glycine were purchased from Fisher Scientific (Pittsburgh, PA). All solutions were prepared with 18.2 MΩ·cm ultrapure water from an ELGA LabWater Purelab Classic (High Wycombe, UK).

TABLE 1
Sequences of miRNAs and probes used in this
Example. Probes were conjugated with Alexa Fluor ®
594 fluorescent dye (AF594).

| | | SEQ |
|---|---|---|
| | | ID |
| Reagent | Sequence (5′-3′) | NO: |
| let-7a | UGAGGUAGUAGGUUGUAUAGUU | 1 |
| miR-21 | UAGCUUAUCAGACUGAUGUUGA | 2 |
| miR-145 | GUCCAGUUUUCCCAGGAAUCCCU | 3 |
| miR-10b | UACCCUGUAGAACCGAAUUUGUG | 4 |
| let-7a probe | AF594-AACTATACAACCTACTACCTCA | 5 |
| miR-21 probe | AF594-TCAACATCAGTCTGATAAGCTA | 6 |
| | CAGTA | |
| miR-145 probe | AF594-AGGGATTCCTGGGAAAACTGGA | 7 |
| | CACTGACTGCA | |
| miR-10b probe | AF594-CACAAATTCGGTTCTACAGGGT | 8 |
| | AATGATCGCTTGTCTA | |

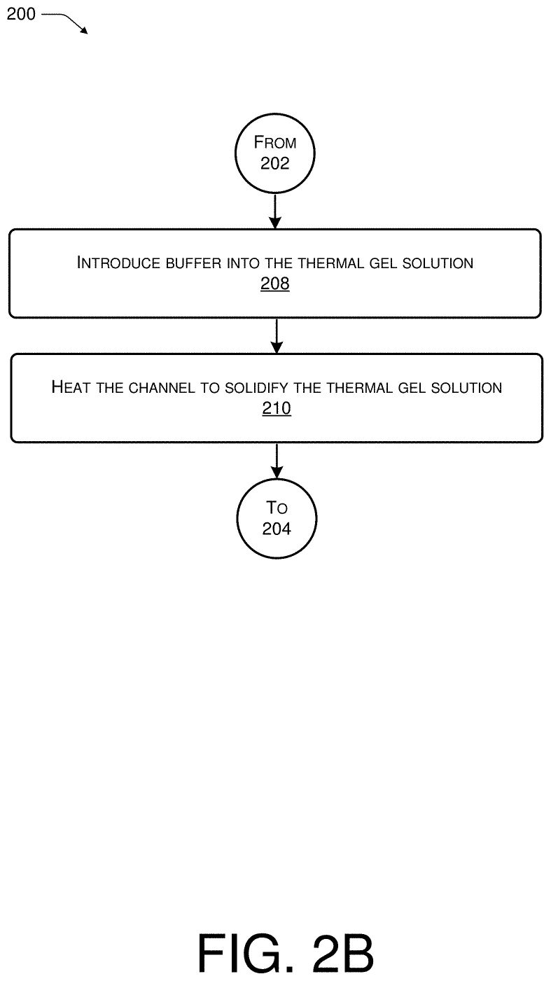

Microchip Fabrication Microfluidic devices were prepared from polydimethylsiloxane (PDMS) using standard photolithography procedures. Briefly, HMDS X-20 (Transene Company, Danvers, MA) was used to prime 4-inch silicon wafers (University Wafer, South Boston, MA). SU-8 2015 negative photoresist (Kayaku Advanced Materials, Westborough, MA) was then spin-coated onto the wafers at a thickness of 20 μm. Two custom photomasks were purchased to create master molds (Great Lakes Engineering, Maple Grove, MN). The first mask produced standard channel devices 3-cm long and 100 μm in width (FIG. 3A). The second mask produced tapered channel devices 5-cm long and 100 μm in width at both ends. On one end, the channel expanded to a 1.9 mm width over a 1.5 mm distance and then narrowed back down to a 100 μm width over the remaining 48.5 mm (FIG. 3B). Each channel design was photopatterned onto a separate master wafer and developed using SU-8 developer (Kayaku Advanced Materials). After the fabrication of the masters, devices were created from PDMS. PDMS elastomer base and curing agent (Ellsworth Adhesives, Germantown, WI) were mixed 7:1, degassed, and poured onto a master wafer. The PDMS was cured at 70° C. for 2 h. The wafer was then diced and reservoirs made with a 3 mm biopsy punch (Ted Pella, Redding, CA). Individual PDMS devices were then reversibly sealed on glass microscope slides (AmScope, Irving, CA).

Assay Operation and Data Processing: Single-stranded fluorescent DNA probes were designed complementary in sequence to their target miRNAs and screened with NIH BLAST to ensure they would only bind to their intended target. Probes and miRNAs were incubated on ice for 10 min enabling the species to spontaneously hybridize to form double-stranded products. Thermal gel stock solution was prepared by dissolving 33.3% (w/v) Pluronic F-127 in 20 mM tris-HCl at 4° C. to maintain the gel in a liquid state. The sample-probe mixture was cast into thermal gel at a 1:9 ratio. The final samples contained 30% (w/v) PF-127 and 1 mM MgCl₂ in 20 mM tris-HCl, with variable concentrations of miRNAs and 10 nM probes. All solutions were prepared and stored on ice prior to analysis. Microfluidic devices were filled with sample-containing gel on ice using vacuum. Excess gel was removed from the reservoirs which were then filled with electrolyte solutions for analysis. The cathodic reservoir contained a cathodic reservoir solution (also referred to in some instances as a trailing electrolyte (TE) solution) containing 800 mM glycine, 5 mM tris-HCl, and 1 mM MgCl₂. The anodic reservoir contained an anodic reservoir solution (also referred to in some instances as a leading electrolyte (LE) solution) containing 200 mM ammonium acetate, 5 mM tris-HCl, and 1 mM MgCl₂.

Filled devices were placed on an AZ100 epifluorescent microscope (Nikon Instruments Inc., Melville, NY) and allowed to equilibrate at 25° C. for 2 min on a temperature-controlled stage. Electrophoresis voltage was applied across devices using a high-voltage power supply (Ultravolt Inc., Ronkonkoma, NY) controlled by a custom LabVIEW program (National Instruments, Austin, TX). Standard channel and tapered channel devices used −1 kV and −2 kV, respectively, to account for their different channel lengths. Images were acquired during analysis using an ORCA Fusion sCMOS camera (Hamamatsu Corp., Bridgewater, NJ) with 150 ms exposure times. Excitation light was produced by a SOLA Light Engine (Lumencor, Beaverton, OR) with a Texas Red filter cube (560/630 nm) at an intensity of 5 mW/mm². A movable stage (Prior Scientific, Rockland, MA) was used to track analyte migration. μManager software controlled all hardware and triggered image acquisition (Edelstein et al., Curr. Protoc. Mol. Biol., 92(1):14.20.1-14.20.17., 2010).

A magnification of 4.8× was used to track bands in standard channel devices, while 0.9× magnification was used for tapered channel devices. These zoomed out images allowed all analyte bands to be visualized in a single frame. Electropherograms were generated for both device designs using a zoomed in 9.6× magnification. The detection points for standard and tapered devices were 25 mm and 40 mm, respectively. Fluorescence was integrated across the entire channel width in standard channel devices. Fluorescence was only integrated across the bottom quarter of the channel in tapered channel devices to only include the area where analyte nodules migrated. Peak areas and separation resolutions were calculated from electropherograms using Chromophoreasy software (Vaz et al., J. Brazil Chem. Soc., 27:1899-1911, 2016). Error bars presented in all figures represent ±1 standard deviation from n=4 replicate analyses.

TGE analysis of 5 nM miRNAs in a tapered channel device with offset electrode placement showed that, over time, all species focus into a single band and then separate into distinct nodules along the channel wall. Baseline resolution was observed between four single-stranded probes and four double-stranded hybrids.

Cellular miRNA Extraction and Analysis HeLa CCL-2 cells (ATCC®, American Type Culture Collection, Manassas, VA) were cultured in DMEM growth medium (Millipore Sigma). Cells were pelleted via centrifugation (250 g, 5 min) and reconstituted at 3.6×10⁶ cells/mL. miRNA was extracted from cells using a PureLink miRNA Isolation Kit following manufacture specifications (Thermo Fisher Scientific, Waltham, MA). Eluent from the isolation kit was lyophilized and then reconstituted in a 50 μL solution containing 10 nM probes, 20 mM Tris HCl, and 1 mM MgCl₂. PF-127 was added to this solution at 30% (w/v) to produce sample-containing thermal gel. The sample gel was centrifuged (13000 g, 5 min) at 5° C. to pellet any cell debris and loaded into tapered channel devices. TGE was conducted by applying −1.5 kV and collecting images under identical conditions as described above. Peaks in the cell samples were identified by spiking miRNA standards into thermal gel sample at final concentrations of 10 nM.

### RESULTS AND DISCUSSION

### Determining Suitability of TGE for miRNA Analysis

Previous TGE studies from this group demonstrated an inline preconcentration and separation of protein variants. Building on this, a system was developed to analyze miRNAs. Studies were first performed to determine whether a double-stranded (ds) miRNA-probe hybrid could be separated from excess single-stranded (ss) probe, given that their sequence lengths are identical. Let-7a was selected as the model analyte and incubated with its fluorescently labeled probe. This mixture was then added to a thermal gel solution and loaded into a standard channel microfluidic device (FIG. 3A). LE and TE compositions were optimized to maximize analyte enrichment until the band reached approximately half-way to the detection point (i.e. 13 mm down the channel) followed by an automatic initiation of the separation. The closest analogy of the sought behavior in the literature are reports of bidirectional ITP (Bahga et al., Anal. Chem., 83(16):6154-6162, 2011). Although the arrangement of electrolytes in the herein described system is inconsistent with bidirectional ITP, similar components are required suggesting that TGE might follow a similar yet distinct mechanism.

TGE analysis of the model miRNA system showed a single fluorescent band that formed in the channel upon voltage application, which then separated into two well-resolved bands as they migrated towards the LE reservoir (FIG. 4A). The ability of thermal gel to reduce separation current enabled a relatively high voltage to be applied to enhance separation efficiencies while minimizing the detrimental effects of Joule heating (Cornejo & Linz, Electrophoresis, 42(11):1238-1246, 2021). The only fluorescent species in the system capable of producing bands were the ds-hybrid and unbound ss-probe. Because ss-species were expected to migrate faster than ds-species due to their lower rigidity, the first band was tentatively assigned as unbound probe while the second band was assigned as the hybridized miRNA.

To confirm the band migration order, miRNA concentrations were varied to identify each peak. Initial analysis used equimolar ratios of miRNA and probe (i.e. 10 nM each). Under these conditions, the ds-hybrid was expected to be the dominant species present because all probe should be hybridized to the miRNA. The data shows an intense second band, suggesting it is the ds-hybrid (FIG. 4B, 10:10). The dim first band present arises from incomplete hybridization between the probe and target that resulted in a low concentration of unbound ss-probe. miRNA concentrations were then reduced to 1 nM to reduce the amount of ds-hybrid that could form and create an excess of ss-probe. Under these conditions, the second band decreased in intensity while the first band increased (FIG. 4B, 1:10). This result is consistent with the ds-hybrid migrating second. These data confirm the expected migration order and demonstrate that ss- and ds-species are well-resolved within single-channel devices.

Results from this study demonstrate that TGE achieved an inline preconcentration and separation of miRNA without requiring user intervention to switch from enrichment mode to separation mode. This injectionless separation scheme enabled the entire channel to be quickly filled with sample and a single voltage be applied to facilitate a user-friendly analysis using low-cost devices.

### Multiplexed miRNA Analysis

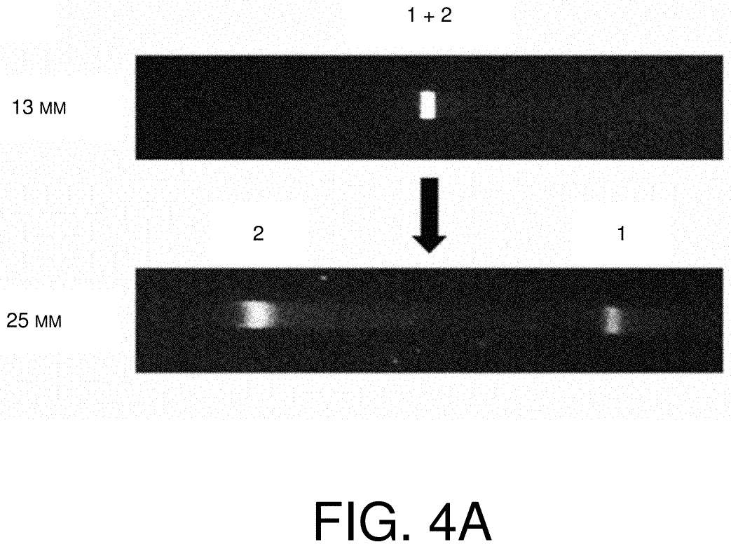

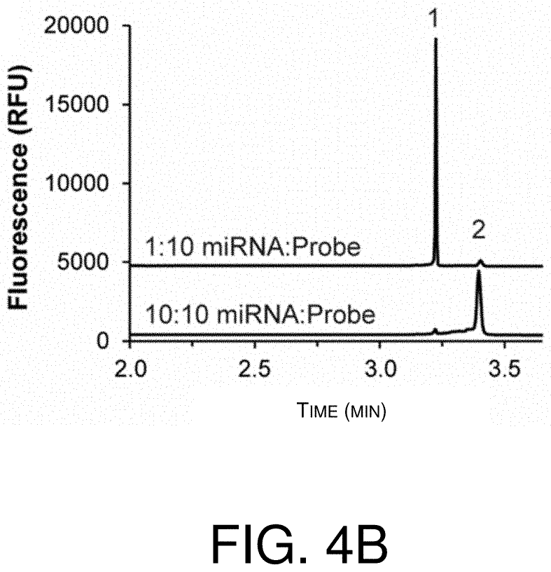

After demonstrating that ss- and ds-species could be resolved, whether multiple miRNA-probe hybrids could be separated by including an overhang region on the probes was analyzed. miR-10b, miR-21, miR-145, and let-7a were selected as model analytes for this study, because of their potential to serve as biomarkers of breast cancer (Chan et al., Clin. Cancer Res., 19(16):4477, 2013; Ibrahim et al., Tumor Biol., 42(10):1010428320963811, 2020). Fluorescent DNA probes were designed complementary in sequence to the four target miRNAs but with non-complementary DNA overhang lengths of 0, 5, 10, and 15 nucleotides (FIG. 5A). Probes were incubated with the miRNAs and analyzed using TGE. Robust analyte preconcentration and separation was observed with high resolution between each band (FIG. 5B). These results demonstrate that sequentially adding five nucleotide overhangs to each probe sufficiently altered the mobility of both ss- and ds-species as they migrated through the gel. This was attributed to sequentially higher entanglement of longer DNA overhangs with the thermal gel to promote separation. The good resolution between bands also suggests that fewer nucleotides (e.g., 4, 3, 2, or even 1) could be used in the overhang region to provide sufficient drag to adequately resolve the ds-hybrids to baseline. Although the minimum needed overhang length was not empirically determined, this can be varied based on the teachings herein, for instance in future studies seeking to increase peak capacity and include additional biomarkers into a clinical miRNA panel. Regardless, the use of ssDNA overhangs as drag tags afforded a simple means to separate miRNAs. Incorporating additional nucleotides into synthetic DNA probes is trivial for the manufacturer and results in only a minimal price increase, making this a cost-effective approach for multiplexed miRNA analysis.

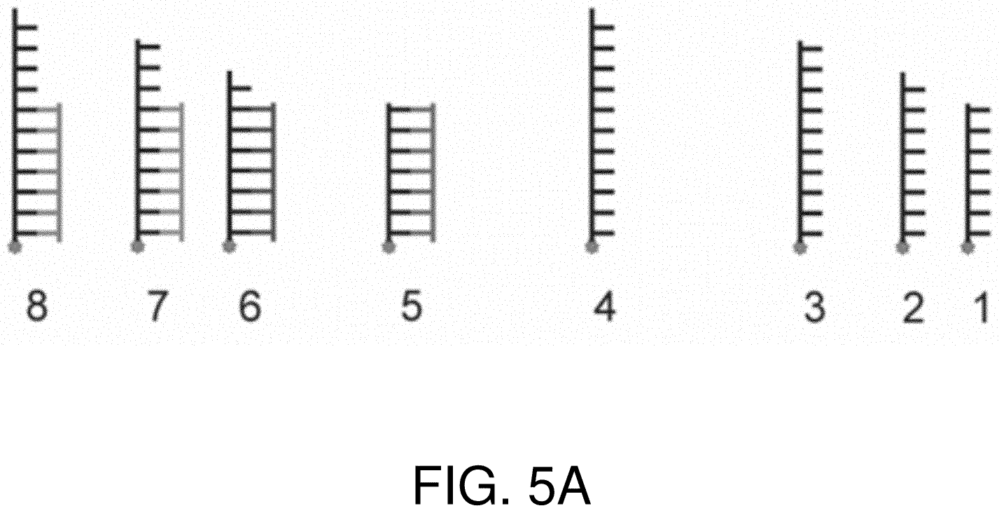

Although high-resolution separations were demonstrated using TGE, the analyte migration order could not be conclusively determined from this data alone. Longer sequences were expected to migrate slower than shorter ones, but it was unclear whether a shorter ds-hybrid would migrate faster or slower than a longer ss-probe. Thus, studies were performed to definitively determine the peak migration order. A stock sample was prepared containing 5 nM mixtures of the four miRNAs and 10 nM probes. This stock was then divided into aliquots into which individual miRNA targets were spiked at 3-fold excess concentration. Two clear trends were observed from this experiment series. First, spiking in one miRNA increased the signal from a single hybrid peak (FIG. 6, arrows 602). The more intense peak correlated with the expected miRNA based on the series of increasing probe overhang lengths. Second, the spiked miRNA decreased the signal from one single excess probe peak (FIG. 6, arrows 604). The less intense peak stems from increased hybridization with the miRNA leaving less unbound probe available. This again matched the expected migration order based on probe overhang length. These results demonstrate that all ss-probes migrate earlier than all ds-hybrids despite significant differences in the sequences lengths. Additionally, a highly mobile species was observed that was well-resolved from the analytes (FIG. 6, Peak 0), which was attributed to hydrolysis of fluorophore from the probes.

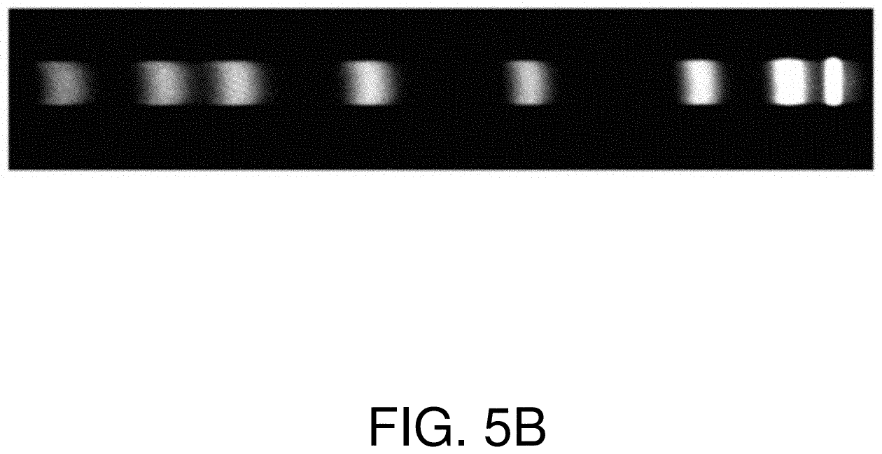

Having now identified all analyte bands in the analysis, calibration curves were generated for each target miRNA to assess the quantitative performance of TGE. Linear responses were observed over a concentration range from 0.3 to 10 nM (FIG. 7). Detection limits were determined to be approximately 100 pM for each target miRNA.

Although the observed dynamic range and limits of detection (LODs) are good compared to typical MCE analyses in PDMS devices—and may be sufficient for certain applications—it was unclear whether miRNA could be quantified from biomedical samples. Absolute miRNA concentrations are difficult to deduce from biomedical literature, because RT-qPCR is typically used for analysis and only fold-changes in biomarker concentrations are reported versus a reference marker. The few publications specifying absolute miRNA concentrations in blood samples reported values on the order of 10 pM to 10 nM (Max et al., Proc. Natl. Acad. Sci. USA, 115(23):E5334, 2018; Correa-Gallego et al., PloS One, 11(9):e0163699-e0163699, 2016). This large range makes it difficult to predict clinical concentrations for selected target biomarkers. However, given that LODs in standard channel devices may be insufficient to quantify these clinically relevant concentrations, improved method performance was sought.

### Tapered Channels to Improve Analytical Performance

Improving sensitivity for the target miRNAs without increasing complexity of the analytical system poses a substantial challenge. It was hypothesized that performance could be improved while preserving the low-cost and user-friendliness of TGE by redesigning the microfluidic channel geometry.

New tapered channel devices (FIG. 3B) were fabricated to contain larger volume than the standard channel devices (FIG. 3A). Channels were designed with a wide entrance (1.9 mm) to enable more analyte molecules to be loaded into the device. The channel then tapered into a narrow detection region (100 μm), to confine separated analyte bands within a low volume. Focusing more analyte molecules into a small detection zone was expected to provide higher detection sensitivity without increasing microfabrication complexity. Thermal gel was used to prevent the widened channel from collapsing, to suppress the EOF, and to stabilize channel flow (Wu et al., Electrophoresis, 19(2):231-241, 1998; Ward et al., Electrophoresis, 41(9):691-696, 2020), which eliminated the need to engineer micropillars into the device (van Kooten et al., Sci. Rep., 7(1):10467, 2017). Additionally, it was hypothesized that tapering the channel would improve separation resolution in parallel with increasing detection sensitivity. The local electric field was predicted to progressively increase down the channel due to the progressively increasing channel resistance. This rationale is supported by previous studies showing higher electric fields in regions where channels are constricted (Hu et al., Phys. Rev., 79(4):041911, 2009). With this design, higher-mobility analytes were expected to enter higher-field regions sooner and accelerate away from lower-mobility analytes, compounding the separation resolution.

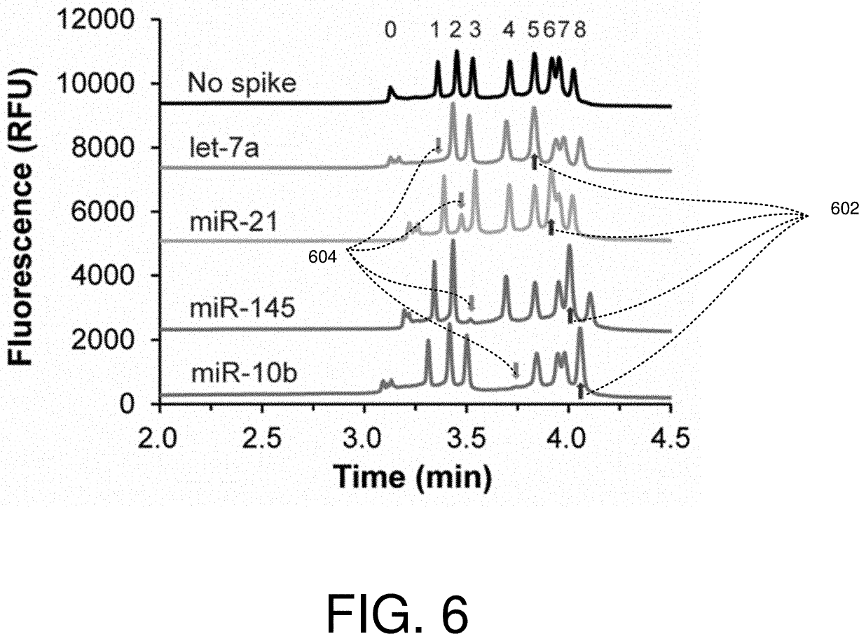

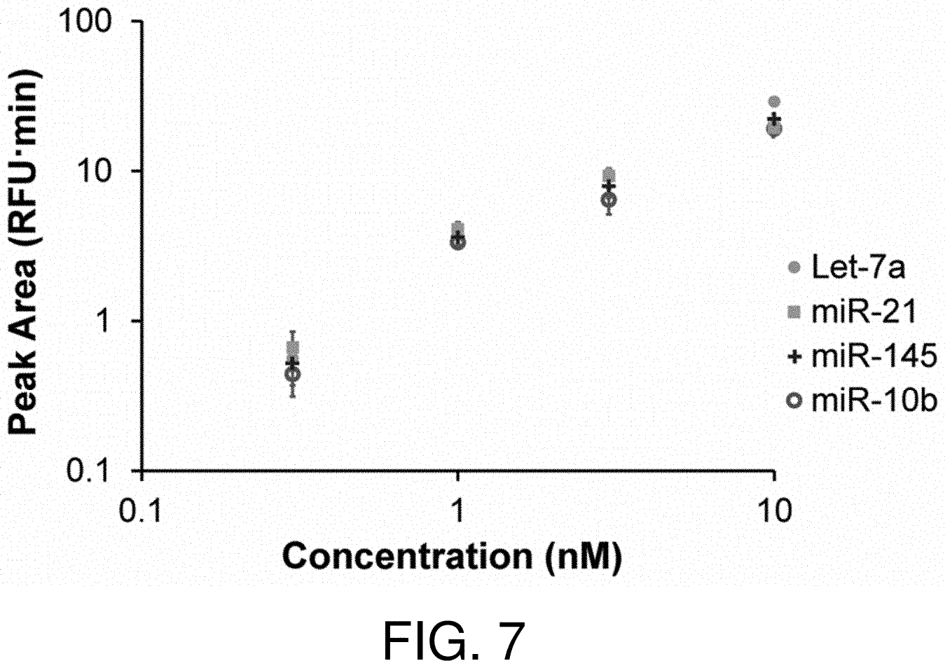

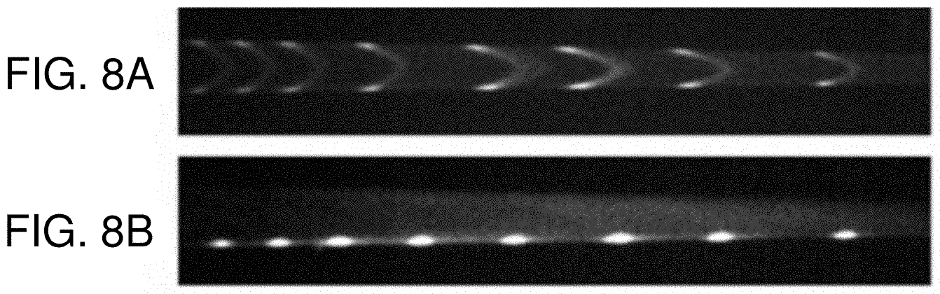

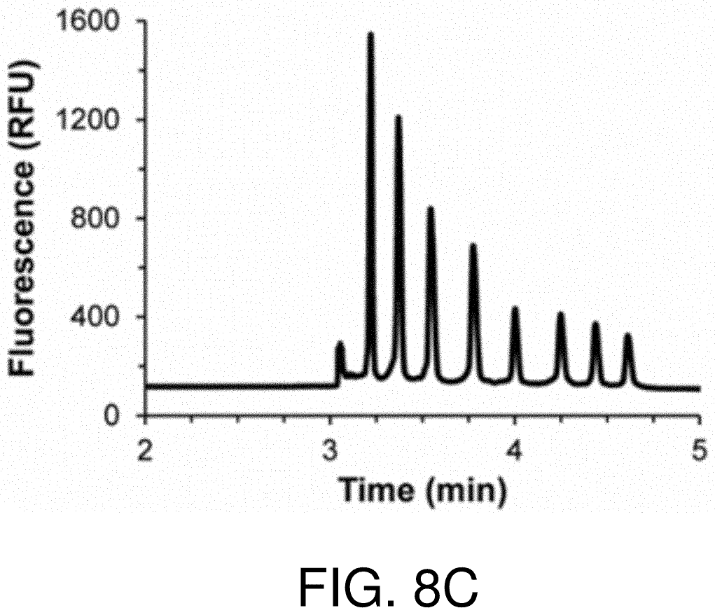

To test these hypotheses, four-plex miRNA analyses were conducted to evaluate performance of the new tapered channel devices using the same electrolyte system as in the previous sections. Results showed that a single bright band enriched down the channel during the enrichment phase of the analysis, akin to outcomes in the standard channel. An inline separation then spontaneously occurred where the four miRNA-probe hybrids resolved from each other and from the four excess probes. Under lower electric field strengths (i.e. 100 V/cm), bands were reasonably well separated; however, analysis times were long (˜15 min) and therefore deemed unacceptable because of the high sample throughput needed for future clinical and pharmaceutical applications. At higher field strengths (i.e. 400 V/cm), run times decreased to ˜5 min, but the quality of the separation also diminished because of the U-shaped bands that formed (FIG. 8A). Analyte molecules were distributed over a relatively large area rather than remaining in compact low-volume bands. Thus, the LODs achieved under these conditions were similar to the standard channel devices, which were insufficient to meet the performance goals.

The observed U-ing effect stems from the lower resistance in the middle of the channel than against the walls, causing the centers of each band to run ahead of the edges. To correct this peak distortion, it was hypothesized that applying an asymmetric electric field would direct all analyte bands against one channel wall rather than letting them span across the channel symmetrically. A 100 μm opening from the reservoir into the channel was included in the microfluidic design (FIG. 3B) to force the electric field to enter the device through a well-defined constriction. The TE electrode was then positioned perpendicular to the channel (i.e. 12 o'clock position in the reservoir) rather than in line with the channel (i.e. 9 o'clock position in the reservoir) as is typically done in MCE. (The LE electrode was fixed in line at 3 o'clock for all analyses.) Because electric field is a vector quantity, offsetting the electrode relative to the channel opening was expected to introduce a vertical component to the electric field in addition to the typical horizontal component that drives electrophoresis. Devices operated with an offset electrode placement (12 o'clock) produced analyte “bands” that were confined against the opposite wall of the channel (6 o'clock) (FIG. 8B). The same effect was observed when the electrode was placed at 6 o'clock except the analytes migrated along the 12 o'clock channel wall. These observations demonstrate that the offset electrode position deflected analytes to the opposite side of the channel because of the asymmetric electric field and Coulombic repulsion of the anionic nucleic acids from the cathode. Bands for the excess ss-probes and the ds-hybrids were well-resolved using this unique electrode configuration in tapered channel devices (FIG. 8C). Interestingly, offsetting the electrode in standard channel devices did not affect the analysis, which suggests that a critical channel width is required for the asymmetric field to impact analyte migration.

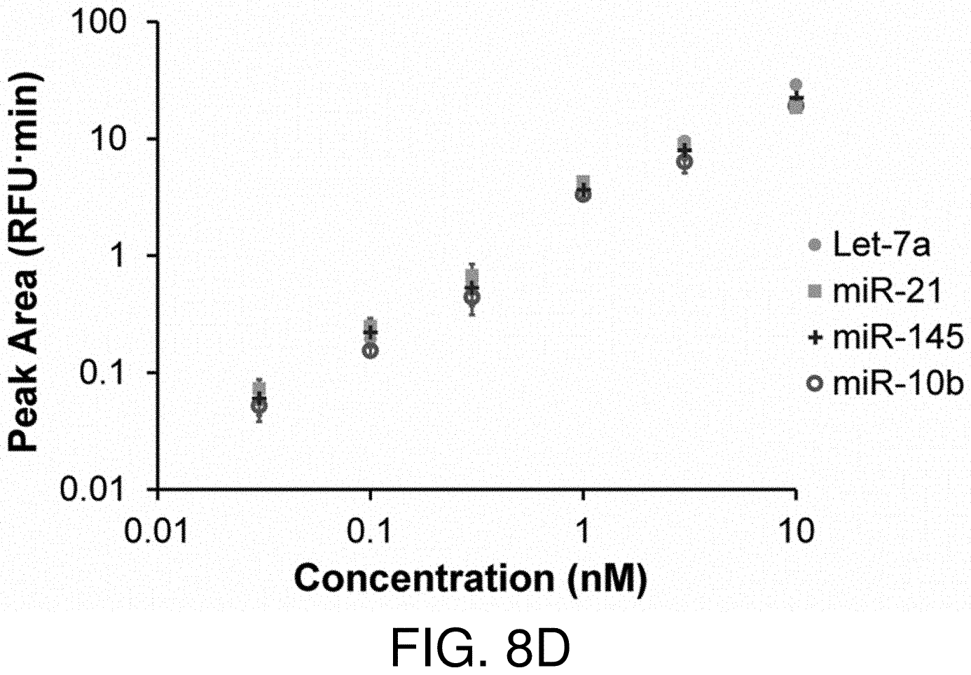

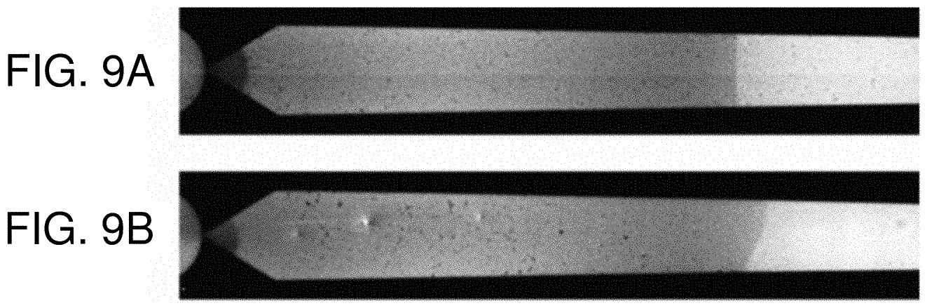

FIG. 9A illustrates non-focusing tracer analyses with the TE electrode placed parallel to the channel (9 o'clock). FIG. 9B. illustrates non-focusing tracer analyses with the TE electrode placed offset to the channel (12 o'clock). Images are shown when the ITP front reached 13 mm, which is the distance the miRNA separation would initiate.

To verify that an asymmetric electric field was responsible for the observed behavior, a non-focusing tracer was used to visualize the electric field profile (Chambers et al., Anal. Chem., 81(8):3022-3028, 2009). Rhodamine 6G was used as a tracer whose fluorescence intensity is inversely proportional to the local electric field (Han et al., Lab Chip, 19(16):2741-2749, 2019). A clear distinction was observed in the tracer profiles from devices with different electrode placements. Having the electrode parallel to the channel (9 o'clock) produced a flat electric field profile (FIG. 9A). Offsetting the electrode to the channel entrance (12 o'clock) produced an angled electric field (FIG. 9B). In both cases, the LE zone had relatively low field whereas the TE zone had relatively high field, which is consistent with isotachophoretic enrichment. However, the asymmetric field profile has not been observed in previous ITP or electrophoresis reports to the best of our knowledge. This facile experimental strategy enabled achieving the desired performance criteria of high-resolution, high-sensitivity analyses without increasing complexity of the microfluidic devices or system operation.

Upon optimizing operation of tapered channel devices, calibration curves were generated for each miRNA target (FIG. 8D). Good linearity was observed over a 333-fold concentration range. LODs for each target miRNA were approximately 12 pM (Table 2), which equates to 5 amol of miRNA initially collected in the preconcentrated band. Comparing performance between tapered and standard channels showed that LODs were on average 9-fold better in the tapered devices. This improved performance was deemed satisfactory to initiate biological analyses, as the LOD extended to the lower end of the reported clinical miRNA concentration range. Separation resolution was also over 2-fold larger in the tapered devices (Table 2), suggesting that higher orders of multiplexing could be attained in future studies while maintaining baseline resolution between analytes.

TABLE 2
TGE performance was compared between standard channel
and tapered channel devices. Separation resolution was
calculated between hybrid bands from 1 nM standards.

| | LOD (pM) | | Separation Resolution | |
|---|---|---|---|---|
| Analyte | Standard | Tapered | Standard | Tapered |
| Let-7a | 90 ± 30 | 11 ± 2 | 2.3 ± 0.1 | 5.12 ± 0.04 |
| miR-21 | 110 ± 70 | 10 ± 3 | 1.32 ± 0.07 | 3.8 ± 0.1 |
| miR-145 | 110 ± 60 | 12 ± 4 | 1.9 ± 0.1 | 3.5 ± 0.1 |
| miR-10b | 100 ± 30 | 14 ± 4 | — | — |

### Cellular miRNA Analysis

Upon validating performance of the analytical method, cells were analyzed to determine whether TGE could detect endogenous miRNAs. miRNA was extracted from cells using a commercial isolation kit and incubated with probes in thermal gel. TGE analyses of cell extracts exhibited peaks for both free probes and miRNA-probe hybrids (FIG. 10). Tentative peak identities were assigned by comparing cell extracts to extracts spiked with miRNA standards. The intensities of peaks from excess probes (Peaks 1-4) were reduced after spiking due to their hybridization with the exogenous miRNAs. Correspondingly, spiking increased the intensities of three hybrid peaks (Peaks 5-7) and caused one new peak to appear (Peak 8). These results suggest that endogenous let-7a, miR-21, and miR-145 can be detected from cells but that miR-10b was below the LOD.

Although the detection of cellular miRNAs is highly encouraging, the composition of cell samples was found to hinder definitive peak assignments and analyte quantitation. In addition, analysis of cell extracts required a reduction in the applied voltage because of the higher sample conductivity. This change in analysis conditions precludes direct comparisons with miRNA standards. Cell samples also showed a significant increase in the intensity of an early-migrating band (Peak 0). Although this band was also observed in miRNA standards (FIG. 8C)—attributed to hydrolyzed fluorophore from the probes—its intensity was higher in cell samples. It is unlikely that exposure to cell extract would have increased probe hydrolysis. The origin of this increased signal remains unclear. Separation resolution between this free dye and the first probe (Peaks 0 and 1) was also reduced in the higher conductivity cell samples. Interestingly, though, resolutions were similar between each probe (Peaks 1-4) and hybrid (Peaks 5-8), and higher resolution was even attained between the ss- and ds-species. Although peak areas could have been measured from cell extracts, quantitative determinations were inappropriate given the discrepancies between cell samples and calibration standards. The analyte nodules formed during TGE were not as compact in cell extracts, especially for miR-145 and miR-10b. The higher sample conductivity likely exhibited a different electric field profile that disrupted analyte accumulation against the channel wall, which reduced analyte signal. Performance in high-salt environments can be improved to minimize impact on TGE analyses and enable accurate analyte quantitation. However, the initial results described herein are quite encouraging as they demonstrate proof of concept that endogenous miRNAs can be detected from cells in a simple microfluidic platform.

### CONCLUSIONS

This report demonstrates that TGE provides a simple, low-cost technique to directly analyze miRNAs. Multiple miRNA targets were quantified with LODs of ˜10 pM and analysis times of ˜5 min. The inline enrichment and separation afforded by TGE eliminated the need for sample injections. Sample was directly cast into thermal gel and non-selectively loaded throughout the entirety of a single-channel microfluidic device, which increased user-friendliness. High detection sensitivity and separation resolution were achieved automatically without requiring user intervention to switch between enrichment and separation modes. TGE also operated with simplified hardware requirements (e.g., no second power supply nor timing actuator) to reduce cost of the system and increase ease of operation versus MCE. The thermal gel served multiple beneficial roles in the analysis including suppression of EOF and reduction of separation current, which enabled higher voltages to be applied to increase separation efficiencies. The thermal gel matrix also promoted high-resolution separations by entangling with the extended overhangs of the probes. The use of DNA overhangs provided simple drag tags that are inexpensively incorporated onto probes during their synthesis. In summary, the multiplexed quantitative analysis of miRNAs demonstrated here lays the foundation for translation into clinical and pharmaceutical applications.

### Example 2: Injectionless Gel Electrophoresis

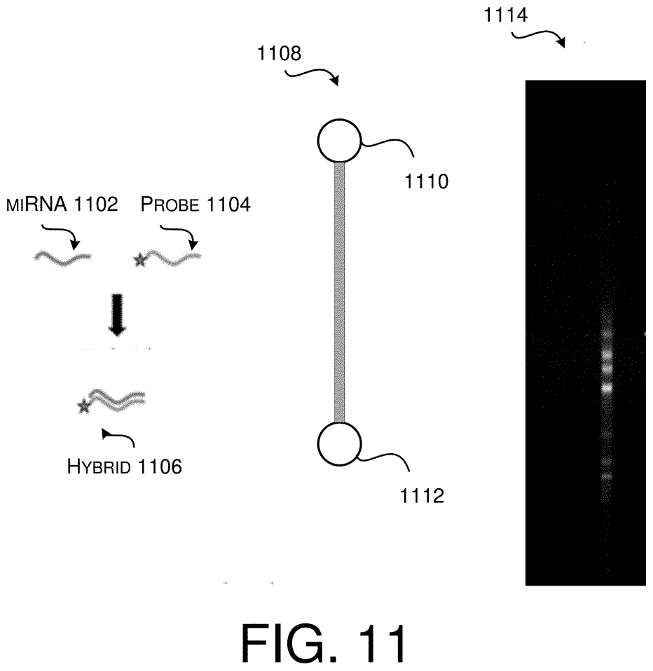

FIG. 11 illustrates a representative embodiment injectionless gel electrophoresis separation system and method according to implementations of the present disclosure. Conditions/parameters may include the following: sample channel- 30% w/v PF-127, 5 nM each miRNA (let-7a, miR-21, miR-145, miR-10b), 10 nM each of the corresponding probe, and 20 mM Tris HCl. A first reservoir 1110-containing a cathodic reservoir solution including 650 mM Gly and 5 mM Tris HCl (free buffer). A second reservoir 1112-containing an anionic reservoir solution including 200 mM NH₄OAc and 5 mM Tris HCl (free buffer). Voltage: −2 kV, Temperature: 25° C.

Referring to FIG. 11, a miRNA 1102 and a probe 1104 are hybridized to generate a miRNA-probe hybrid 1106. Additional details of the miRNA and the probe are described throughout the present disclosure. The mixed analyte sample (containing the miRNA-probe hybrid 1106) mixed with a gel solution is loaded into a channel of a microfluidic device 1108. No sample injection is needed to begin the analysis, unlike conventional analytical methods. The microfluidic device 1108 may correspond to the microfluidic devices described throughout the present disclosure, for example, the microfluidic device 100/100′ and the like. Applying voltage resulted in an inline preconcentration and separation of the miRNAs that did not require user intervention to switch between modes. A cathodic reservoir solution may be provided in the first reservoir (cathodic reservoir) 1110. In implementations, the cathodic reservoir solution may include multiple electrolyte species such as LE−, TE+, and TE−. An anionic reservoir solution may be provided in the second reservoir (anodic reservoir) 1112. In implementations, the anionic reservoir solution may include multiple electrolyte species such as LE−, TE+, and LE+. Additional details are described in FIG. 13.

Image 1114 shows the results of the injectionless gel electrophoresis analysis. The analytes were separated into bands as progressively migrating into regions of higher electric fields. Additional details of the explanation of the results are described throughout the present disclosure.

### Example 3: Two Anionic TEs Increase Resolution of miRNA Separations

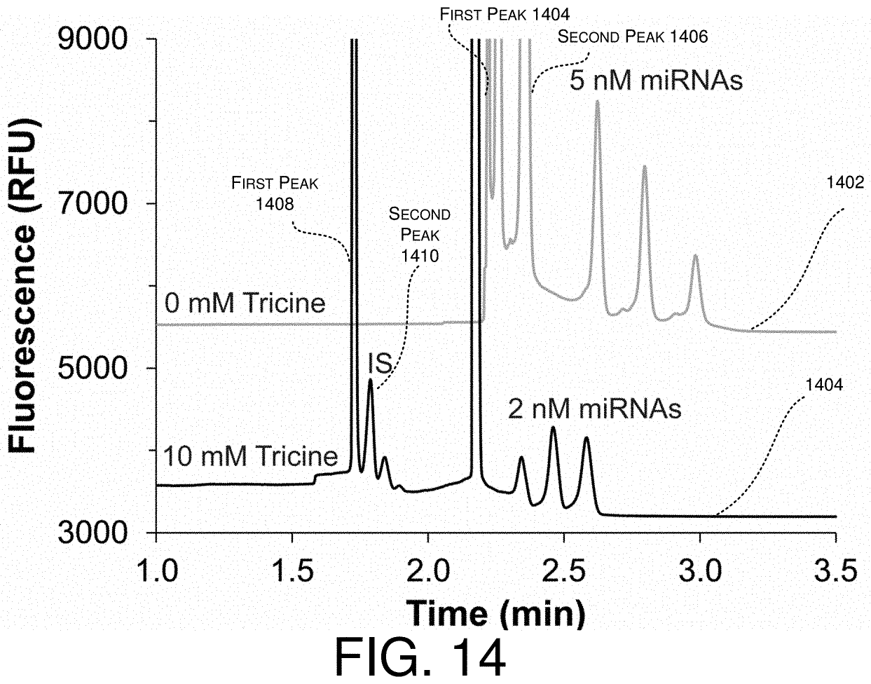

FIG. 14 illustrates results of two-anionic TE miRNA analyses according to Example 3. In this example, additional separation resolution is attained by employing two anionic TEs in the anodic reservoir. This example can be implemented using microfluidic devices described throughout this disclosure (e.g., the microfluidic device 100 in FIG. 1A, the microfluidic device 100′ in FIG. 1B, the microfluidic device 100″ in FIG. 1I, the microfluidic devices in FIG. 3A and FIG. 3B, the microfluidic devices in FIG. 12, or the like). TGE works under a wider set of conditions, which provides extra flexibility to customize conditions to improve resolution for given sets of analytes. The approach used in this Example is similar to the primary miRNA analysis in Example 1, except that this Example uses a second TE (e.g., tricine as used in this Example). The relationship of the respective electrophoretic mobilities of the analytes to be separated and TEs to be used can be governed by the following Formula 1.

Analyte₁>TE₋₁>Analyte₂>TE₋₂ Formula 1

High mobility analytes can comigrate in TGE at the front of the separation zone, i.e. immediately following the LE− front. In some instances, this has been inconsequential because the analytes of interest had lower mobility and migrated later in the separation zone, enabling them to be well separated. However, some applications require high resolution between higher mobility species. Therefore, an alternative approach was evaluated to increase resolution, broadening the utility of TGE analysis.

A sample was prepared to contain three miRNAs (let-7a, let-7b, and let-7c), three fluorescent probes (with 0, 5, and 15 nucleotide overhang lengths), and an internal standard dye (AlexaFluor® 594). The sample was spiked into thermal gel (e.g., the thermal gels described throughout this disclosure, such as in paragraph [0082], or the like) and then loaded throughout a microfluidic channel (e.g., the standard channel 102 in FIG. 1A, the tapered channel 102′ in FIG. 1B, the serpentine channel 102″ in FIG. 1I, or the like) of the microfluidic device. The analysis was initiated by applying an electric field at a voltage of 1 kV-2 kV (e.g., 1.5 kV) between reservoirs.

Using the standard scheme with glycine as the anionic TE (TE−), inline analyte preconcentration and separation were performed, characteristic of TGE. The resulting separation showed that peaks (e.g., first peak 1404, second peak 1406, first peak 1408, and second peak 1410) for the internal standard dye, dye hydrolyzed from the probes, and the probes all comigrated (see plot 1402 in FIG. 14). This lack of separation resolution renders the internal standard useless because it cannot be distinguished from the interfering species, and thus cannot be quantified.

To address this problem, a second anionic TE with higher electrophoretic mobility (i.e. tricine) was added to the anodic reservoir, in addition to glycine. This two-anionic TE system produced the same inline enrichment and separation as with the standard one-TE configuration. However, a new separation zone (Zone 2) formed using this second TE that resolved the internal standard dye from the dye hydrolyzed from the probes. This enabled the peak area (of Second peak 1410 in the sample containing 10 mM tricine) for the internal standard (IS) to be readily attained for subsequent data normalization. Following this higher mobility separation zone (Zone 1), a second separation zone (Zone 2; longer than 2.0 minutes transit time) followed where excess probes and miRNA-probe hybrids were resolved. The positions of the zones can be described by Formula 2 and Formula 3:

Zone 1: LE->IS+dyes>TE₁ Formula 2

Zone 2: TE₁>probes+miRNAs>TE₂ Formula 3

Moreover, adding additional electrolyte species (e.g., a third electrolyte, such as proline, borate, HEPES, or the like) to the reservoirs can create additional zones (third, fourth, and so on) in the channel of the microfluidic device. As a result, more species of analytes can be separated when TGE is conducted. Thus, the methods and systems provided herein are not limited to only one or two separation zones.

Plot 1404 in FIG. 14 illustrates multiple resolved peaks (e.g., first peak 1408 and second peak 1410) from the small molecule dyes and the larger nucleic acids that could only be achieved by using two TEs.

This example demonstrates that multiple electrolytes can be employed in TGE to create multiple migration zones that better resolve analytes in the sample. Adding multiple TEs did not interfere with analyte enrichment nor did it increase complexity of the analysis. Integrated sample enrichment and separation still occurred without requiring user intervention. These results show that separation zones can be customized based on the specific analytes in the sample. Zone widths can be tailored using electrolytes with different mobilities and adjusting their concentrations. This additional flexibility accentuates the utility of TGE to separate diverse analytes in complex sample mixtures.

### Example 4: Increasing Selectivity of miRNA Analyses Using High Temperatures

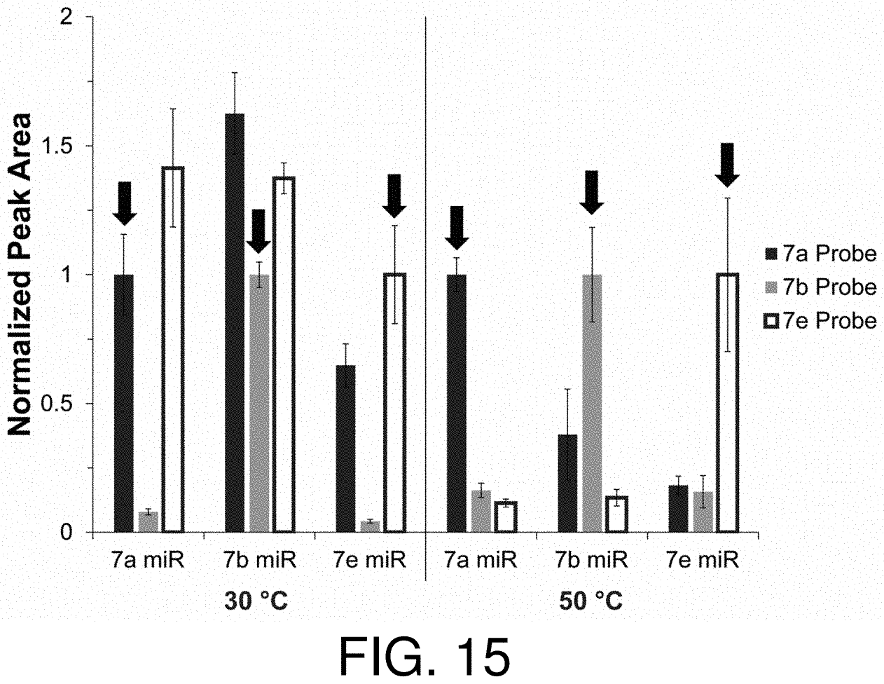

FIG. 15 illustrates a diagram showing results of miRNA selectivity analysis according to Example 4. This example can be implemented using the microfluidic devices described throughout this disclosure (e.g., the microfluidic device 100 in FIG. 1A, the microfluidic device 100′ in FIG. 1B, the microfluidic device 100″ in FIG. 1I, the microfluidic devices in FIG. 3A and FIG. 3B, the microfluidic devices in FIG. 12, or the like). The selectivity of miRNA analysis is improved by operating the analysis at a high temperature such as at or above 40° C. (e.g., 45° C., 50° C., or the like). Traditional gel electrophoresis is not tolerant to heat, and thus has been run at a relatively low temperature (such as at or around room temperature). As demonstrated in this Example, TGE has a unique ability to operate over a range of temperatures, including at higher relative temperatures, which can be customized to improve analytical performance for given sets of analytes. Higher temperature can enable higher fidelity analyses, for instance, of nucleic acids that are strongly influenced by the binding of a complementary strand. A higher temperature enables more stringent binding characteristics.

Families of miRNAs have high sequence homology, yet each species regulates different biological processes. To ensure valid biological conclusions are drawn from analysis, it is imperative that analytical methods provide adequate selectivity to distinguish different, yet structurally similar, miRNAs.

Probe-based miRNA detection struggles to obtain selectivity under normal operating conditions (room temperature). Prevalent off-target hybridization occurs between the probes and miRNA sequences similar to the target miRNA. Selectivity can be increased by operating the analysis at elevated temperatures, just below the melting points of the target miRNA-probe hybrids. This approach melts off-target hybrids lacking perfect complementarity to the probe and ensures only on-target species are measured. However, conventional gel electrophoresis cannot be operated above room temperature because of prevalent Joule heating and bubble formation. TGE, however, can operate over a wide range of temperatures, and has the potential to accommodate analyses at elevated temperatures without succumbing to standard heat-related problems faced by other techniques.

TABLE 3
Sequences of additional miRNAs and probes used in
this Example. Probes were conjugated with Alexa
Fluor ® 594 fluorescent dye (AF594).

| | | SEQ ID |
|---|---|---|
| Reagent | Sequence (5′-3′) | NO: |
| let-7b miRNA | UGAGGUAGUAGGUUGUGUGGUU | 9 |
| let-7e miRNA | UGAGGUAGGAGGUUGUAUAGUU | 10 |
| let-7b probe | AF594-AACCACACAACCTACTACCT | 11 |
| | CACAGTT | |
| let-7e probe | AF594-AACTATACAACCTCCTACCT | 12 |
| | CACAGTTCTCCAGTTCA | |

The miRNAs let-7a, let-7b, and let-7c and their respective fluorescent probes (with 0, 5, and 15 nucleotide overhang lengths) were added to thermal gel composed of 30% (w/v) Pluronic F127, 20 mM tris-HCl, and 0.1 mM MgCl₂. Sample-containing thermal gel was loaded throughout the entirety of a microfluidic channel (e.g., the standard channel 102 in FIG. 1A, the tapered channel 102′ in FIG. 1B, the serpentine channel 102″ in FIG. 1I, or the like) of the microfluidic device. The anodic reservoir was filled with 150 mM glycine (TE−), 2 mM tricine (TE−), 5 mM tris-HCl (TE+, LE−), and 0.1 mM MgCl₂ (LE+, LE−) (pH 7.6). The cathodic reservoir contained 150 mM ammonium acetate (LE+, LE−), 5 mM tris-HCl, and 0.1 mM MgCl₂ (pH 7.6). The analysis was initiated by applying an electric field at a voltage of 1 kV-2 kV (e.g., 1.5 kV) between reservoirs.

A selectivity analysis was performed where the three miRNAs and three probes were combined into a sample. Two of the miRNAs were present at 3 nM concentrations and the third miRNA was spiked in at 21 nM (indicated by the arrow in each set). TGE analyses were first conducted at 30° C., where significant off-target hybridization was observed (FIG. 15, 30° C.). For example, when let-7a was spiked in at a higher concentration, peaks for both let-7a and let-7e increased significantly. This indicates that let-7a miRNA readily hybridized with the probes for both let-7a and let-7e. This lack of selectivity precluded quantitation of the target miRNA (i.e., let-7a). At 50° C., however, results improved significantly. Only the peak for the spiked miRNA (indicated by the arrow in each set) increased in intensity at elevated temperature (FIG. 15, 50° C.). No increased off-target peaks were observed in samples containing spiked let-7a, let-7b, and let-7c, which highlights the benefits of operating at high temperatures.

This example demonstrates that TGE is amenable high-temperature analyses. The characteristic inline analyte preconcentration and separation of TGE was unaffected by high heat, which shows that thermal gels are less susceptible to the harmful effects of temperature, unlike conventional gel electrophoresis techniques. The innovative ability to conduct analyses at 50° C. enabled structurally similar miRNAs to be readily distinguished with high selectivity. Comparable performance could not be achieved at 30° C. because of prevalent off-target hybridization between the probes and structurally similar miRNAs. This example highlights the utility of TGE to customize operating conditions for high-selectivity miRNA analyses.

### Example 5: Assessing Protein Conformations with TGE

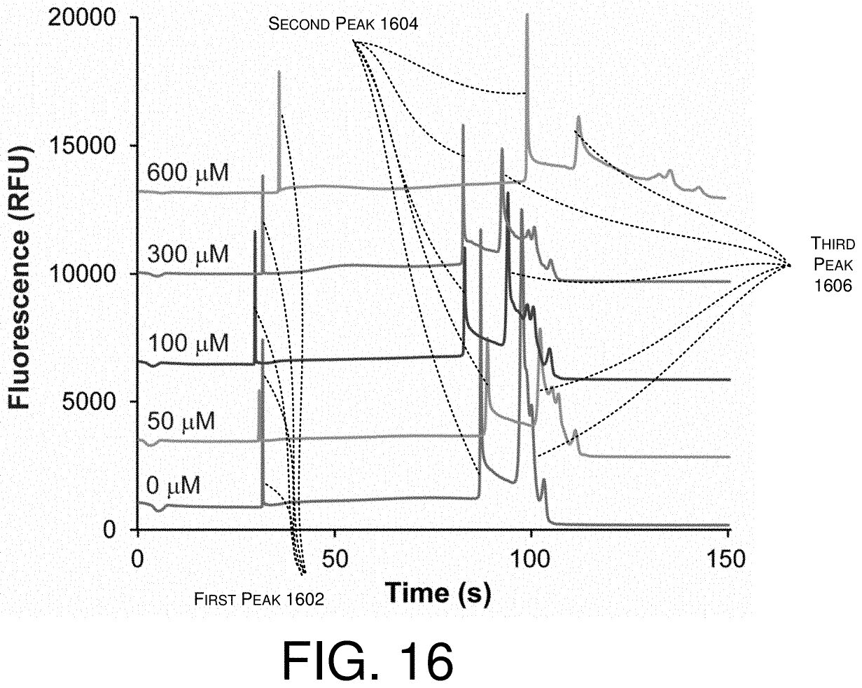

FIG. 16 illustrates a diagram showing results titrating Ca2+ into calmodulin samples according to Example 5. The analysis of protein analytes is conducted using the microfluidic devices described throughout this disclosure (e.g., the microfluidic device 100 in FIG. 1A, the microfluidic device 100′ in FIG. 1B, the microfluidic device 100″ in FIG. 1I, the microfluidic devices in FIG. 3A and FIG. 3B, the microfluidic devices in FIG. 12, or the like). This example demonstrates that TGE can analyze proteins, including different protein conformations.

The biological activities of proteins are governed by their tertiary and quaternary structures. Metal ions such as calcium or zinc can serve as cofactors that induce protein conformational changes. Cofactor binding is of critical concern in biological studies because it regulates whether a protein is in its active structure. However, assessing protein conformations is difficult because the mass and hydrophobicity of the protein changes negligibly upon cofactor binding. This renders most liquid chromatography methods incapable of identifying multiple conformations of the same protein. TGE, however, presents an attractive technique to conduct this measurement because it separates analytes based on cross-sectional area, which is affected by conformational changes. The results below demonstrate that TGE is suited to provide a rapid, low-cost analysis of proteins with sufficient separation efficiency to resolve distinct conformations.

Calmodulin (17 kDa) is a calcium-binding protein that changes from an inactive state to an active state upon binding calcium. This protein was fluorescently labeled with AlexaFluor® 594 and added into a thermal gel containing 28.5% (w/v) Pluronic F127, 1.5% (w/v) Pluronic F68, and 25 mM tris-HCl. This sample-containing thermal gel was loaded throughout a microfluidic channel (e.g., the standard channel 102 in FIG. 1A, the tapered channel 102′ in FIG. 1B, the serpentine channel 102″ in FIG. 1I, or the like) of the microfluidic device. The anodic reservoir was then filled with 100 mM glycine (TE−), 8 mM tricine (TE−), and 25 mM Tris-HCl (TE+, LE−). The cathodic reservoir was filled with 10 mM ammonium acetate (LE+, LE−) and 5 mM Tris-HCl in 30% (w/v) PF-127. The analysis was initiated by applying an electric field at a voltage of 1 kV-2 kV (e.g., 2 kV) between reservoirs.

A two-anionic TE system was applied to the anodic reservoir to better resolve residual dye from the calmodulin protein. Upon voltage application, analytes throughout the channel underwent an inline preconcentration and separation, as expected from TGE analysis. An early migrating Peak 1 (peaks numbered from left to right in FIG. 16) was observed in the labeled protein sample that had a similar migration time to a sample containing only AlexaFluor® 594. This result demonstrated that tricine formed a zone to effectively separate the small molecule dye from the protein variants of interest. A second separation zone then formed which featured two prominent peaks (Second peak 1602 and Third peak 1604) and two minor partially comigrating peaks, which arose from the protein conformers (FIG. 16, 0 mM).

To identify the active and inactive states of calmodulin, a Ca2+ titration series was analyzed. An increase in the relative amount of active calmodulin was expected at higher calcium concentrations. Results from this study revealed that the separation resolution between the two prominent protein peaks was unaffected by the Ca2+; however, the relative intensities of the two peaks changed. Second peak 1602 increased in intensity with increasing Ca2+ concentrations while Third peak 1606 decreased (FIG. 16). This demonstrates that Second peak 1604 is the active Ca2+-bound structure of calmodulin and Third peak 1606 is the inactive unbound structure. The intensity ratio between peaks is altered when Ca2+ is titrated into the system because of a shift in the equilibrium of protein conformations. The other peaks migrating later in the analysis are attributed to proteins that were labeled with two dye molecules. They migrate after the mono-labeled proteins because of their larger sizes.

This example demonstrates that TGE accommodates protein analyses. Inline preconcentration and separation of proteins were observed using similar electrolytes as with nucleic acids. This integrated analysis provides rapid, low-cost screenings of protein conformations and expands the application space of TGE in the analysis of biological analytes.

### Discussion of Examples 3 and 5: Increasing Separation Resolution with Electrolyte Zones

Examples 3 and 5 demonstrate that the separation resolution increases in miRNA and protein samples when a second anionic TE is added into the anodic reservoir. This second TE forms an additional zone in which analytes can separate after undergoing preconcentration. This two-TE approach increases flexibility of the analysis by enabling high separation resolution between both higher mobility analytes and lower mobility analytes in a single analysis. This approach can be extended further by incorporating more electrolytes (e.g., tricine, proline, or the like) into the analysis, which further increases the flexibility of TGE to analyze samples of even higher complexity.

Studies have shown that proline serves as a low-mobility anionic TE in the analysis of large proteins. Glycine can be coupled with proline to resolve proteins of moderate mobility from proteins of low mobility in separate zones. In principle, a third anionic TE of higher mobility (e.g. tricine) can be added into the anodic reservoir solution to form a third separation zone. Using three anionic TEs is expected to enhance resolution between analytes of high mobility, moderate mobility, and low mobility using the same TGE format as in previous examples. This approach can also extend to greater numbers of electrolytes and is not limited to one or two anionic TEs.

TGE enables analyses to be readily customized based on the analytes in a sample mixture. Multiple TEs can be combined to accentuate resolution between sets of analytes that differ in mobilities. The number of separation zones needed for analyzing a given sample is dependent on the number of analytes present and their relative mobility differences. In principle, similar customization can be attained by using additional cationic electrolytes in the cathodic reservoir. Distinct cationic electrolyte zones will migrate counter to the direction of the analytes, which influences the separation resolution and preconcentration efficiency. Having the flexibility to adjust the electrolyte composition in one or both reservoirs and obtain superior analytical performance further expands the utility of TGE for biomolecular analyses.

### (XIII) Closing Paragraphs

As will be understood by one of ordinary skill in the art, each embodiment disclosed herein can comprise, consist essentially of or consist of its particular stated element, step, ingredient or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment. A material effect would cause a statistically significant change in the separation of analytes using TGE.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles, other written text, and web site content throughout this specification (referenced materials herein). Each of the referenced materials are individually incorporated herein by reference in their entirety for their referenced teaching(s), as of the filing date of the first application in the priority chain in which the specific reference was included. For instance, with regard to chemical compounds, nucleic acid, and amino acids sequences referenced herein that are available in a public database, the information in the database entry is incorporated herein by reference as of the date of an application in the priority chain in which the database identifier for that compound or sequence was first included in the text.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the example(s) or when application of the meaning renders any construction meaningless or essentially meaningless. In cases where the construction of the term would render it meaningless or essentially meaningless, the definition should be taken from Webster's Dictionary, 11th Edition or a dictionary known to those of ordinary skill in the art, such as the Oxford Dictionary of Biochemistry and Molecular Biology, 2^{nd} Edition (Ed. Anthony Smith, Oxford University Press, Oxford, 2006), and/or A Dictionary of Chemistry, 8^{th} Edition (Ed. J. Law & R. Rennie, Oxford University Press, 2020).

1. A method of injectionless gel electrophoresis, comprising:
loading a mixed analyte sample mixed with a gel solution into a channel of a microfluidic device, the channel having a first end and a second end, the microfluidic device having a first reservoir coupled to the first end of the channel and a second reservoir coupled to the second end of the channel;
providing a first reservoir solution in the first reservoir;
providing a second reservoir solution in the second reservoir; and
applying an electric field across the microfluidic device.

2. The method of claim 1, wherein the first reservoir solution includes a first electrolyte and the second reservoir solution includes a second electrolyte

3. The method of claim 1, wherein the microfluidic device further comprises a first electrode arranged in the first reservoir and a second electrode arranged in the second reservoir.

4. The method of claim 3, wherein:
the method comprises anionic analytes migrating from the first reservoir to the second reservoir, and:
the first electrode is a cathodic electrode;
the first reservoir solution is a cathodic reservoir solution;
the first reservoir is a cathodic reservoir;
the second electrode is an anodic electrode;
the second reservoir solution is an anodic reservoir solution; and
the second reservoir is an anodic reservoir;
or
the method comprises cationic analytes migrating from the first reservoir to the second reservoir, and:
the first electrode is an anodic electrode;
the first reservoir solution is an anodic reservoir solution;
the first reservoir is an anodic reservoir;
the second electrode is a cathodic electrode;
the second reservoir solution is a cathodic reservoir solution; and
the second reservoir is a cathodic reservoir.

5. (canceled)

6. The method of claim 1, wherein one or more of:
the sample comprises biomolecules;
the sample comprises at least one of nucleic acids, carbohydrates, peptides, or proteins;
the sample comprises two or more miRNA species;
the mixed analyte sample comprises at least two different nucleic acid molecule analytes, the sample further comprising a set of two or more probes, each probe comprising a different ssDNA overhang length, formulated for use as integrated drag tags;
the gel is configured to suppress an electroosmotic flow (EOF) in the channel;
the gel is a sieving gel for resolving the sample;
the gel is configured to suppress a current runaway in the channel;
the gel is thermally responsive;
the channel has a tapered geometry; and/or
an opening is arranged at the first end of the channel;
applying the electric field across the microfluidic device occurs at a temperature of between 5° C. and 60° C.; and/or
the microfluidic device is maintained at a temperature of between 45° C. and 60° C.

7-9. (canceled)

10. The method of claim 1, further comprising solidifying the gel solution.

11-14. (canceled)

15. The method of claim 1, further comprising:
including buffer in the gel solution and/or the mixed analyte sample; and/or
detecting separation of analytes of the mixed analyte sample in the channel.

16. (canceled)

17. The method of claim 1, comprising applying the electric field across the microfluidic device as an asymmetric electric field.

18. The method of claim 17, wherein applying the asymmetric electric field across the microfluidic device comprises applying the asymmetric electric field with the first electrode and/or second electrode arranged at an offset position relative to the first reservoir and/or the second reservoir.

19-20. (canceled)

21. The method of claim 2, wherein at least the first electrolyte or at least the second electrolyte is glycine, tricine, proline, borate, HEPES, Tris-HCl, MgCl₂, ammonium acetate, ammonium chloride, sodium acetate, NaCN, NaCl, Bis-tris methane, or Bis-tris propane.

22. The method of claim 3, wherein:
the cathodic reservoir solution comprises at least one of glycine, ammonium acetate, Tris-HCl, MgCl₂, ammonium chloride, sodium acetate, NaCN, and/or NaCl. or
the anodic reservoir solution comprises at least one of tricine, proline, borate, ammonium acetate, Tris-HCl, MgCl₂, ammonium chloride, sodium acetate, NaCN, and/or NaCl.

23. (canceled)

24. The method of claim 2, wherein the first reservoir solution includes at least two different electrolyte species, the second reservoir solution includes at least two different electrolyte species, or both the first reservoir solution and the second reservoir solution include at least two different electrolyte species.

25. The method of claim 24, wherein the at least two different electrolyte species comprise glycine and tricine, glycine and borate, or glycine and proline.

26. The method of claim 1, wherein applying the electric field across the microfluidic device comprises applying the electric field across the microfluidic device at a voltage of:
−10 kV to +10 kV;
−8 kV to +8 kV;
−5 kV to +5 kV;
−3 kV to +3 kV;
−2 kV to +2 kV;
−1.5 kV to +1.5 kV;
−1.0 kV to +1.0 kV;
−0.5 kV to −0.5 kV;
−0.25 kV to −0.25 kV;
1 kV to 2 kV;
1.5 kV to 2 kV;
5 kV to 1.5 kV;
0.5 kV to 2 kV;
0.5 kV to 1 kV;
−1 kV to −2 kV;
−1.5 kV to −2 kV;
−0.5 kV to −1.5 kV;
−0.5 to −2 kV; or
−0.5 kV to −1 kV.

27-28. (canceled)

29. The method of claim 6, wherein the sample comprises at least one biomolecule that occurs in two or more different conformations each of which has a different electrophoretic mobility; and optionally the method separates two or more different conformational forms of a protein.

30. (canceled)

31. A microfluidic device, comprising:
a channel, configured to accommodate a mixed analyte sample mixed with a gel solution, the channel having a first end and a second end;
a first reservoir coupled to the first end of the channel, the first reservoir being configured to accommodate a first reservoir solution;
a second reservoir coupled to the second of the channel, the second reservoir being configured to accommodate a second reservoir solution;
a first electrode arranged in the first reservoir; and
a second electrode arranged in the second reservoir;
wherein the first electrode and the second electrode are configured to apply an electric field across the microfluidic device.

32. The device of claim 31, wherein:
the device is configured for anionic analytes to migrate from the first reservoir to the second reservoir, and:
the first electrode is a cathodic electrode;
the first reservoir solution is a cathodic reservoir solution;
the first reservoir is a cathodic reservoir;
the second electrode is an anodic electrode;
the second reservoir solution is an anodic reservoir solution; and
the second reservoir is an anodic reservoir;
or
the device is configured for cationic analytes to migrate from the first reservoir to the second reservoir, and:
the first electrode is an anodic electrode;
the first reservoir solution is an anodic reservoir solution;
the first reservoir is an anodic reservoir;
the second electrode is a cathodic electrode;
the second reservoir solution is a cathodic reservoir solution; and
the second reservoir is a cathodic reservoir.

33. (canceled)

34. The device of claim 31, wherein one or more of:
the sample comprises at least one of nucleic acids, carbohydrates, peptides, or proteins;
the sample comprises two or more miRNA species;
the mixed analyte sample comprises at least two different nucleic acid molecule analytes, the sample further comprising a set of two or more probes, each probe comprising a different ssDNA overhang length, formulated for use as integrated drag tags;
the first electrode is arranged at an offset position;
the gel is configured to suppress an electroosmotic flow (EOF) in the channel;
the gel is a sieving gel for resolving the sample;
the gel is configured to suppress a current runaway in the channel;
the gel is thermally responsive;
the channel has a tapered geometry;
an opening is arranged between the first reservoir and the channel;
the cathodic reservoir solution comprises glycine, tris-HCl, and/or MgCl₂; the anodic reservoir solution comprises ammonium acetate, tris-HCl, and/or MgCl₂; and/or
the electric field across the microfluidic device is an asymmetric electric field.

35-46. (canceled)

47. A computer-readable medium storing computer-readable instructions executable by one or more processors, that when executed by the one or more processors, causes the one or more processors to perform acts comprising:
loading a mixed analyte sample mixed with a gel solution into a channel of a microfluidic device, the channel having a first end and a second end, the microfluidic device having a first reservoir coupled to the first end of the channel and a second reservoir coupled to the second end of the channel;
providing a first reservoir solution in the first reservoir;
providing a second reservoir solution in the second reservoir; and
applying an electric field across the microfluidic device.

48. The computer-readable medium of claim 47, wherein:
the first electrode is a cathodic electrode;
the first reservoir solution is a cathodic reservoir solution;
the first reservoir is a cathodic reservoir;
the second electrode is an anodic electrode;
the second reservoir solution is an anodic reservoir solution; and
the second reservoir is an anodic reservoir;
or
the first electrode is an anodic electrode;
the first reservoir solution is an anodic reservoir solution;
the first reservoir is an anodic reservoir;
the second electrode is a cathodic electrode;
the second reservoir solution is a cathodic reservoir solution; and
the second reservoir is a cathodic reservoir.

49-58. (canceled)
